(19) United States
(12) Patent Application Publication
(10) Pub. No.: US 2021/0264848 A1
(43) Pub. Date: Aug. 26, 2021

(54) DISPLAY APPARATUS AND CONTROL METHOD THEREOF

(71) Applicant: SAMSUNG ELECTRONICS CO., LTD., Suwon-si (KR)

(72) Inventors: Junichi YAMASHITA, Yokohama-shi (JP); Daisuke KAWAE, Yokohama-shi (JP); Takashige FUJIMORI, Yokohama-shi (JP)

(73) Assignee: SAMSUNG ELECTRONICS CO., LTD., Suwon-si (KR)

(21) Appl. No.: 17/175,113

(22) Filed: Feb. 12, 2021

(30) Foreign Application Priority Data
Feb. 20, 2020 (JP) 2020-027075
Mar. 5, 2020 (JP) 2020-037429
Dec. 21, 2020 (KR) 10-2020-0179932

(51) Int. Cl. G09G 3/32

(52) U.S. Cl. CPC G09G 3/32; G09G 2320/0646; G09G 2330/028

(57) ABSTRACT

A display apparatus includes a light emitting element group including a plurality of light emitting elements, a pixel circuit configured to supply a reference voltage to the plurality of light emitting elements to allow a light emitting element, which emits light, in the light emitting element group, to be changed according to a plurality of sub-fields forming one field.

### CROSS-REFERENCE TO RELATED APPLICATIONS

This application is based on and claims priority under 35 U.S.C. 119 to Korean Patent Application No. 10-2020-0179932, filed on Dec. 21, 2020, in the Korean Intellectual Property Office, Japanese Patent Application No. 2020-027075 filed on Feb. 20, 2020, in the Japan Patent Office, and Japanese Patent Application No. 2020-037429 filed on Mar. 5, 2020, in the Japan Patent Office, the disclosures of which are herein incorporated by reference in their entireties.

### BACKGROUND

### 1. Field

The disclosure relates to a display apparatus capable of realizing an image using a plurality of light emitting elements and a control method thereof.

### 2. Description of Related Art

A display apparatus may be classified into a self-luminous display in which each pixel emits light and a non-self-luminous display that requires a separate light source for displaying an image.

A Liquid Crystal Display (LCD) is a typical non-self-luminous display, and utilizes a backlight unit configured to supply light from the rear of a display panel, a liquid crystal layer configured to serve as a switch to transmit and block light, and a color filter configured to control a color of the light. Therefore, the LCD possesses a complex structure and there is a difficulty in reducing a thickness of the LCD.

On the other hand, the self-luminous display, in which each pixel emits light, for example by including a light-emitting diode (LED) for each pixel, does not require the aforementioned components, such as a backlight unit and a liquid crystal layer, and further omits a color filter. Therefore, the self-luminous display has a simply structure and a high degree of freedom in the design. For example, reduced thickness, improved contrast, higher brightness and better viewing angles may be obtained utilizing the self-luminous display as compared to the conventional LCD.

A micro LED display is a flat-panel, self-luminous display and is composed of a plurality of light emitting diodes (LEDs) having a size of 100 micrometers or less. In comparison with liquid crystal display panels that require a backlight, the micro LED display panels offer better contrast, response time and energy efficiency.

The micro LED is an inorganic light emitting element having higher brightness, better light emission efficiency, and longer life in comparison with an organic light emitting diode (OLED), which requires a separate encapsulation layer for protecting organic materials.

### SUMMARY

An aspect of the disclosure provides a display apparatus capable of reducing a quantity of pixel circuits without increasing a scale of the pixel circuit, by sequentially supplying a reference voltage to each of a plurality of light emitting elements forming a light emitting element group by timing control.

Another aspect of the disclosure provides a display apparatus capable of improving image quality by utilizing a consistent light emission sequence for each light emitting element group and by dynamically or variably controlling a speed of light emission in a row direction or a column direction at least once within one field.

Additional aspects of the disclosure will be set forth in part in the description which follows and, in part, will be understood from the description, or may be learned by practice of the disclosure.

In accordance with an aspect of the disclosure, a display apparatus includes a light emitting element group among a plurality of light emitting element groups of a panel of the display apparatus, the light emitting element group comprising a plurality of light emitting elements, the plurality of light emitting elements comprising a first light emitting element and a second light emitting element, a pixel circuit among a plurality of pixel circuits of the display apparatus, the pixel circuit connected to the light emitting element group to supply an image signal to the plurality of light emitting elements, and a voltage control circuit configured to sequentially supply a reference voltage to the first light emitting element at a first timing corresponding to a first subfield of time of a plurality of subfields of time of a field of time, during which the plurality of pixel circuits receive the image signal for each of the plurality of subfields of time and the voltage control circuit supplies the reference voltage to the plurality of light emitting element groups during each of the plurality of subfields of time, and to the second light emitting element at a second timing corresponding to a second subfield of time of the field of time, wherein the first light emitting element is controlled to emit first light corresponding to the image signal at the first timing based on the reference voltage and the second light emitting element is controlled to emit second light corresponding to the image signal at the second timing based on the reference voltage.

The voltage control circuit may selectively transmit the reference voltage to the plurality of light emitting elements based on the image signal.

The light emitting element group may be provided as a plurality of light emitting element groups, and the voltage control circuit may simultaneously transmit the reference voltage to each light emitting element of the plurality of light emitting element groups.

The light emitting element group may include a first light emitting element group including a plurality of red light emitting elements, a second light emitting element group including a plurality of green light emitting elements, and a third light emitting element group including a plurality of blue light emitting elements.

The plurality of light emitting elements may be connected in parallel between the pixel circuit and the voltage control circuit.

Each of the plurality of light emitting elements may be a light emitting diode, in which an anode is connected to the pixel circuit, and a cathode is connected to the voltage control circuit, and the reference voltage may be a ground voltage.

Each of the plurality of light emitting elements may be a light emitting diode, in which a cathode is connected to the pixel circuit, and an anode is connected to the voltage control circuit, and the reference voltage may be a power supply voltage.

The light emitting element group may include at least one of each of a red light emitting element, a green light emitting element, and a blue light emitting element.

The display apparatus may further include a panel in which light emitting elements are arranged in a plurality of rows and a plurality of columns, and the light emitting element group may include a plurality of light emitting elements arranged in the same column among the plurality of columns.

The display apparatus may further include a panel in which light emitting elements are arranged in a plurality of rows and a plurality of columns, and the light emitting element group may include a plurality of light emitting elements arranged in the same row among the plurality of rows.

The display apparatus may further include a panel in which light emitting elements are arranged in a plurality of rows and a plurality of columns, and the light emitting element group may include a plurality of light emitting elements arranged in two or more rows among the plurality of rows and two or more columns among the plurality of columns.

The display apparatus may further include a panel in which a plurality of pixels is arranged in a plurality of rows and a plurality of columns, and each of the plurality of pixels may include at least one light emitting element, and the light emitting element group may include pixels arranged in two or more rows among the plurality of rows and two or more columns among the plurality of columns.

The light emitting element group may be provided as a plurality of light emitting element groups, and the voltage control circuit may simultaneously control pixels of the light emitting element group to sequentially emit light and pixels of another light emitting element group among the plurality of light emitting element groups to sequentially emit light.

The voltage control circuit is configured to supply the reference voltage to the plurality of light emitting element groups based on the image signal.

The predetermined light emission sequence may be determined to allow a speed of light emission of the plurality of pixels in a row direction of each column of the plurality of columns to be changed at least once within the field of time.

The predetermined light emission sequence may be determined to allow a speed of light emission of the plurality of pixels in a column direction of each row of the plurality of rows to be changed according to a subfield of time among the plurality of subfields of time.

The voltage control circuit may change the predetermined light emission sequence in units of one field.

The voltage control circuit may allow any one pixel provided in each light emitting element group among the plurality of light emitting element groups to emit light during a first light emission time of the field of time and another pixel in each light emitting element group among the plurality of light emitting element groups to emit light during a second light emission time of the field of time.

Each of the plurality of pixels may include a red light emitting element, a green light emitting element, or a blue light emitting element.

The voltage control circuit may allow some light emitting elements in the each of the plurality of pixels to emit light at a light emission timing of another pixel among the plurality of pixels.

### BRIEF DESCRIPTION OF THE DRAWINGS

These and other aspects of the disclosure will become apparent and more readily appreciated from the following description of embodiments, taken in conjunction with the accompanying drawings of which:

FIG. 1 is a diagram illustrating a display apparatus according to an embodiment of the disclosure;

FIG. 2 is a diagram illustrating a pixel circuit provided in the display apparatus shown in FIG. 1;

FIG. 3 is a diagram illustrating of the pixel circuit provided in the display apparatus shown in FIG. 1;

FIG. 4 is a timing chart illustrating an operation of the display apparatus shown in FIG. 1;

FIG. 5 is a diagram illustrating a modified example of the display apparatus shown in FIG. 1;

FIG. 6 is a timing chart illustrating an operation of the display apparatus shown in FIG. 5;

FIG. 7 is a diagram illustrating a modified example of the display apparatus shown in FIG. 1;

FIG. 8 is a timing chart illustrating an operation of the display apparatus shown in FIG. 7;

FIG. 9 is a diagram illustrating a display apparatus according to an embodiment of the disclosure;

FIG. 10 is a timing chart illustrating an operation of the display apparatus shown in FIG. 9;

FIG. 11 is a diagram illustrating a modified example of the display apparatus shown in FIG. 9;

FIG. 12 is a timing chart illustrating an operation of the display apparatus shown in FIG. 11;

FIG. 13 is a diagram illustrating a modified example of the display apparatus shown in FIG. 9;

FIG. 14 is a timing chart illustrating an operation of the display apparatus shown in FIG. 13;

FIG. 15 is a diagram illustrating a configuration example of a display apparatus according to an embodiment of the disclosure;

FIG. 16 is a timing chart illustrating an operation of the display apparatus shown in FIG. 15;

FIG. 17 is a diagram illustrating a display apparatus according to an embodiment of the disclosure;

FIG. 18 is a timing chart illustrating an operation of the display apparatus shown in FIG. 17;

FIG. 19 is a diagram illustrating a display apparatus according to an embodiment of the disclosure;

FIG. 20 is a timing chart illustrating an operation of the display apparatus shown in FIG. 19;

FIG. 21 is a diagram illustrating a display apparatus according to an embodiment of the disclosure;

FIG. 22 is a diagram illustrating a driving operation of the display apparatus shown in FIG. 21;

FIG. 23 is a diagram illustrating a driving operation of the display apparatus shown in FIG. 1;

FIG. 24 is a diagram illustrating the driving operation of the display apparatus shown in FIG. 23;

FIG. 25 is a diagram illustrating a display apparatus according to an embodiment of the disclosure;

FIG. 26 is a diagram illustrating a pixel unit provided in the display apparatus shown in FIG. 25;

FIG. 27 is a diagram illustrating a pixel unit provided in the display apparatus shown in FIG. 25;

FIG. 28 is a diagram illustrating a pixel unit provided in the display apparatus shown in FIG. 25;

FIG. 29 is a diagram particularly illustrating a pixel unit provided in the display apparatus shown in FIG. 25;

FIG. 30 is a diagram illustrating a driving operation of the display apparatus shown in FIG. 25;

FIG. 31 is a diagram illustrating a driving operation of the display apparatus shown in FIG. 25;

FIG. 32 is a diagram illustrating the driving operation of the display apparatus shown in FIG. 25;

FIG. 33 is a diagram illustrating a diving operation of the display apparatus shown in FIG. 25;

FIG. 34 is a diagram illustrating a modified example of the display apparatus shown in FIG. 25;

FIG. 35 is a diagram illustrating a driving operation of the display apparatus shown in FIG. 34;

FIG. 36 is a diagram illustrating a display apparatus according to an embodiment of the disclosure;

FIG. 37 is a diagram illustrating a driving operation of the display apparatus shown in FIG. 36;

FIG. 38 is a diagram illustrating a modified example of the display apparatus shown in FIG. 36;

FIG. 39 is a diagram illustrating a driving operation of the display apparatus shown in FIG. 38;

FIG. 40 is a diagram illustrating a light emitting sequence of a plurality of pixels, which forms each pixel unit provided in a display apparatus according to an embodiment of the disclosure, in a first field;

FIG. 41 is a diagram illustrating a light emitting sequence of the plurality of pixels, which forms each pixel unit provided in the display apparatus according to an embodiment of the disclosure, in a second field;

FIG. 42 is a diagram illustrating a driving operation of the display apparatus shown in FIGS. 40 and 41;

FIG. 43 is a diagram illustrating a driving operation of the display apparatus shown in FIGS. 40 and 41;

FIG. 44 is a diagram illustrating a driving operation of the display apparatus shown in FIGS. 40 and 41;

FIG. 45 is a diagram illustrating a driving operation of the display apparatus shown in FIGS. 40 and 41;

FIG. 46 is a diagram illustrating a driving operation example of a display apparatus according to an embodiment of the disclosure;

FIG. 47 is a diagram illustrating a driving operation of the display apparatus according to an embodiment of the disclosure;

FIG. 48 is a diagram illustrating a configuration of a pixel unit provided in a display apparatus according to an embodiment of the disclosure;

FIG. 49 is a waveform diagram of control voltages supplied to pixels forming a pixel unit shown in FIG. 48;

FIG. 50 is a conceptual diagram illustrating a state in which pixels forming a pixel unit shown in FIG. 48 emit light;

FIG. 51 is a diagram illustrating a modified example of the pixel unit shown in FIG. 48;

FIG. 52 is a conceptual diagram illustrating a state in which pixels forming a pixel unit shown in FIG. 51 emit light;

FIG. 53 is a diagram illustrating a modified example of the pixel unit shown in FIG. 48;

FIG. 54 is a conceptual diagram illustrating a state in which pixels forming a pixel unit shown in FIG. 53 emit light;

FIG. 55 is a diagram illustrating a modified example of the pixel unit shown in FIG. 48;

FIG. 56 is a conceptual diagram illustrating a state in which pixels forming a pixel unit shown in FIG. 55 emit light;

FIG. 57 is a diagram illustrating a configuration of a pixel unit provided in the display apparatus according to an embodiment of the disclosure;

FIG. 58 is a diagram illustrating a modified example of a pixel unit shown in FIG. 57;

FIG. 59 is a diagram illustrating a modified example of the pixel unit shown in FIG. 57; and

FIG. 60 is a diagram illustrating a modified example of the pixel unit shown in FIG. 57.

### DETAILED DESCRIPTION

Embodiments and configurations shown in the drawings are merely examples of the embodiments of the disclosure, and may be modified in various different ways at the time of filing of the present application.

It will be understood that when an element is referred to as being “connected” another element, the element can be directly or indirectly connected to the other element, and the indirect connection includes “connection via a wireless communication network” or “electrical connection through an electrical wiring.”

Also, the terms used herein are used to describe the embodiments and are not intended to limit or restrict the disclosure. The singular forms “a,” “an” and “the” are intended to include the plural forms as well, unless the context clearly indicates otherwise. In this disclosure, the terms “including,” “having,” and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following description, terms such as “unit,” “part,” “block,” “member,” and “module” indicate a unit for executing at least one function or operation. For example, those terms may refer to at least one process executed by at least one hardware such as Field Programmable Gate Array (FPGA), Application Specific Integrated Circuit (ASIC), at least one control of an apparatus based on execution of software stored in a memory by a processor.

An identification code is used for the convenience of the description but is not intended to illustrate the order of each step. Each step may be implemented in an order different from the order illustrated unless the context clearly indicates otherwise.

The disclosure will be described more fully hereinafter with reference to the accompanying drawings.

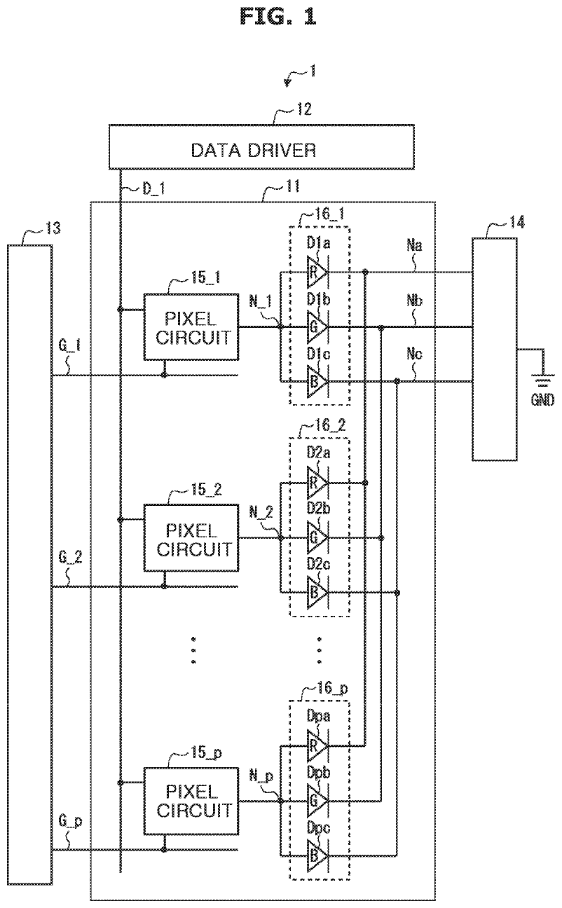

FIG. 1 is a diagram illustrating a display apparatus according to an embodiment of the disclosure. For example, the display apparatus 1 is a self-luminous display apparatus, such as an organic electroluminescent (EL) display or a light emitting diode (LED) display, and an active matrix type display apparatus.

That is, the display apparatus 1 is a self-luminous display apparatus in which a light emitting element is disposed for each pixel to allow each pixel to emit light by itself. Therefore, because a component, such as a backlight unit and a liquid crystal layer, is not required unlike a liquid crystal display (LCD) apparatus, a small thickness may be realized and a structure thereof is more easily manufactured. Therefore, a design of the display apparatus 1 may be optimized in a variety of ways.

In addition, the display apparatus 1 may employ an inorganic light emitting element, such as a light emitting diode (LED), as a light emitting element in each pixel. The inorganic light emitting element may have a fast reaction speed and realize high luminance with low power in comparison with an organic light emitting element, such as an organic light emitting diode (OLED). In addition, in comparison with an OLED that requires an encapsulation process because the OLED is vulnerable to exposure to water and oxygen and has poor durability, the inorganic LED may not require the encapsulation structure and may exhibit better durability.

The inorganic light emitting element employed in the display apparatus 1 may be a micro LED having a short side length of about 100 μm. As described above, by employing the micro-unit LED, the pixel size may be reduced and higher resolution may be realized with the same size screen.

In addition, if an LED chip is manufactured in the size of a micro unit, there may be fewer occurrences in which the LED chip is cracked due to characteristics of inorganic materials upon being bent. That is, in a state in which the micro LED chip is transferred to a flexible substrate, the LED chip is not damaged even if the substrate is bent. Accordingly, a flexible display apparatus may also be implemented utilizing the micro LED. As a result, a display apparatus employing a micro LED may be applied to various fields due to a small pixel size and a thin thickness.

The display apparatus 1 includes a panel 11, a data driver 12, a gate driver 13, and a voltage control circuit 14.

Light emitting element groups 16 are regularly arranged on the panel 11. Further, a pixel circuit 15 configured to drive each of the plurality of light emitting element groups 16 is disposed on the panel 11. Light emitting element groups 16_1 to 16_p (p is an integer of 1 or more) are illustrated in FIG. 1. Further, in an example of FIG. 1, as a part of a plurality of pixel circuits 15, pixel circuits 15_1 to 15_p configured to respectively drive the light emitting element groups 16_1 to 16_p, are illustrated.

Each light emitting group 16 of light emitting element groups 16_1 to 16_p includes a plurality of light emitting elements D. Each light emitting element D is a self-luminous element that emits light by applying a voltage, and for example, the light emitting element D is an organic electroluminescent (EL) or a light emitting diode. In the embodiment, a state in which each light emitting element D is a light emitting diode will be described as an example.

In the example of FIG. 1, the light emitting element group 16_1 includes a light emitting element D1a emitting a red color R light, a light emitting element D1b emitting a green color G light, and a light emitting element D1c emitting a blue color B light as the plurality of light emitting elements D (a plurality of first light emitting elements). Further, in the example of FIG. 1, the light emitting element group 16_2 includes a light emitting element D2a emitting a red color R light, a light emitting element D2b emitting a green color G light, and a light emitting element D2c emitting a blue color B light as the plurality of light emitting elements D (a plurality of second light emitting elements). Similarly, in the example of FIG. 1, the light emitting element group 16_p includes a light emitting element Dpa emitting a red color R light, a light emitting element Dpb emitting a green color G light, and a light emitting element Dpc emitting a blue color B light as the plurality of light emitting elements D.

The voltage control circuit 14 is provided for controlling the light emitting element groups 16_1 to 16_p and a power supply (a ground voltage source (GND)) is configured to supply reference power. In the embodiment, a configuration in which the voltage control circuit 14 is commonly provided for the light emitting element groups 16_1 to 16_p will be described as an example.

More particularly, in the light emitting elements D1a, D1b, and D1c forming the light emitting element group 16_1, each anode is connected to the pixel circuit 15_1 through a node N_1, and each cathode is connected to the voltage control circuit 14 through nodes Na, Nb, and Nc. In the light emitting elements D2a, D2b, and D2c forming the light emitting element group 16_2, each anode is connected to the pixel circuit 15_2 through a node N_2, and each cathode is connected to the voltage control circuit 14 through the nodes Na, Nb, and Nc. Similarly, in the light emitting elements Dpa, Dpb, and Dpc forming the light emitting element group 16_p, each anode is connected to the pixel circuit 15_p through a node N_p, and each cathode is connected to the voltage control circuit 14 through the nodes Na, Nb, and Nc. Accordingly, the plurality of light emitting elements Da, Db and Dc included in one light emitting element group 16 may be provided in parallel between the pixel circuit 15 and the voltage control circuit 14.

For example, the gate driver 13 outputs a pulse signal to a row scanning line, which is provided to correspond to the pixel circuit 15, based on an instruction from a control circuit. The data driver 12 outputs an image signal with respect to the pixel circuit 15 to a data line provided to correspond to the pixel circuit 15 that is an input target of the image signal.

In the example of FIG. 1, the gate driver 13 sequentially outputs a pulse signal (hereinafter referred to as gate control signals G_1 to G_p) to each row scanning lines G_1 to G_p provided to correspond to the pixel circuit 15_1 to 15_p. Further, the data driver 12 sequentially outputs an image signal (hereinafter referred to as an image signal D_1) with respect to the pixel circuit 15_1 to 15_p to a data line D_1 provided to correspond to a column of the pixel circuit 15_1 to 15_p.

The pixel circuit 15_1 converts an image signal D_1 with respect to the light emitting element group 16_1 into a current signal having a current value according to the corresponding image signal D_1, and the pixel circuit 15_1 outputs the current signal to the node N_1 at a timing in which the gate control signal G_1 is activated. Further, the pixel circuit 15_2 converts an image signal D_1 with respect to the light emitting element group 16_2 into a current signal having a current value according to the corresponding image signal D_1, and the pixel circuit 15_2 outputs the current signal to the node N_2 at a timing in which the gate control signal G_2 is activated. Similarly, the pixel circuit 15_p converts an image signal D_1 with respect to the light emitting element group 16_p into a current signal having a current value according to the corresponding image signal D_1, and the pixel circuit 15_p outputs the current signal to the node N_p at a timing in which the gate control signal G_p is activated.

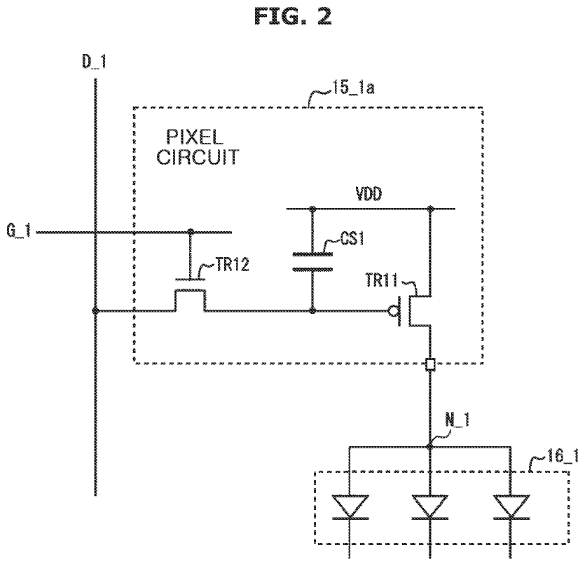

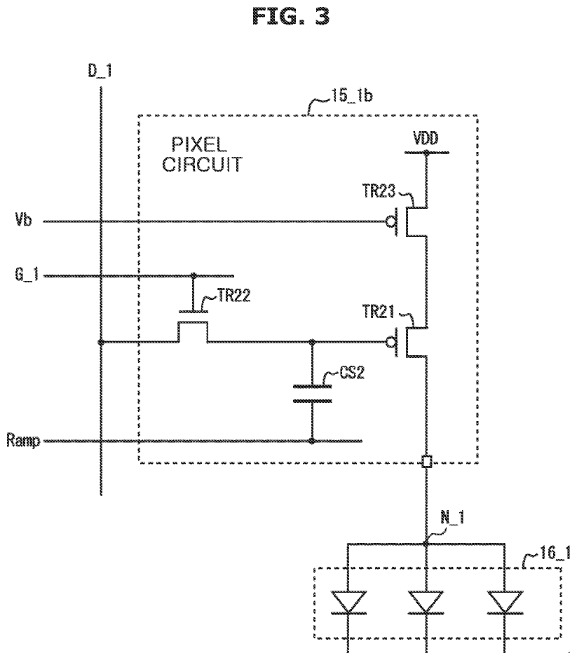

For example, each of the pixel circuits 15_1 to 15_p is provided with a thin film transistor (TFT). Hereinafter configuration examples of the pixel circuit 15_1 provided with the TFT will be described with reference to FIGS. 2 and 3. A specific configuration example of pixel circuit other than the pixel circuit 15_1 is the same as the circuit configuration of the pixel circuit 15_1 and thus a redundant description thereof will be omitted.

FIG. 2 is a diagram illustrating a pixel circuit provided in the display apparatus shown in FIG. 1. In FIG. 2, a configuration example of the pixel circuit 15_1 is illustrated as a pixel circuit 15_1a. The pixel circuit 15_1a is a pixel circuit of a Pulse Amplitude Modulation (PAM) method and includes a drive transistor TR11, a switch transistor TR12 and a capacitor CS1.

In the embodiment, a configuration in which the drive transistor TR11 is a P-channel MOS transistor, and the switch transistor TR12 is an N-channel MOS transistor, is described as an example, but the configuration is not limited thereto. For example, the drive transistor TR11 may be an N-channel MOS transistor, and the switch transistor TR12 may be a P-channel MOS transistor. However, in this configuration, a voltage applied to a gate of each transistor is reversed.

The drive transistor TR11 is provided between a power supply voltage source VDD and the node N_1 on the anode side of the light emitting element group 16_1.

The switch transistor TR12 is provided between the data line D_1 and a gate of the drive transistor TR11, and the switch transistor TR12 switches on-off states based on a pulse signal (that is, the gate control signal G_1) applied through the row scanning line G_1. Further, the capacitor CS1 is provided between the gate and a source of the drive transistor TR11.

For example, in response to the switch transistor TR12 that is temporarily turned on by a high level H of a pulse wave of the gate control signal G_1, the image signal (that is, the image signal D_1) transmitted through the data line D_1 is applied to the gate of the drive transistor TR11 through the switch transistor TR12. That is, a voltage level of the image signal D_1 applied to the gate of the drive transistor TR11 is maintained by the capacitor CS1 until the gate control signal G_1 is increased. That is, the voltage level of the image signal D_1 applied to the gate of the drive transistor TR11 is maintained for a sub-field period that is divided by the pulse wave of the gate control signal G_1. During the sub-field period, a current signal having a current value according to the image signal D_1 is continuously supplied to the node N_1. Therefore, the node N_1 is maintained at the voltage value according to the current signal.

FIG. 3 is a diagram illustrating of the pixel circuit provided in the display apparatus shown in FIG. 1. In FIG. 3, the pixel circuit 15_1 is illustrated as a pixel circuit 15_1b. The pixel circuit 15_1b is a pixel circuit of a Pulse Width Modulation (PWM) method and includes transistors TR21, TR22, and TR23 and a capacitor CS2.

In the embodiment, a configuration in which the transistors TR21, and TR23 are a P-channel MOS transistor, and the transistor TR22 is an N-channel MOS transistor is described as an example, but the configuration is not limited thereto. For example, the transistors TR21, and TR23 may be an N-channel MOS transistor, and the transistor TR22 may be a P-channel MOS transistor. However, in this configuration, a voltage applied to a gate of each transistor is reversed.

The transistors TR21 and TR23 are provided in series between a power supply voltage source VDD and the node N_1 on the anode side of the light emitting element group 16_1. A bias voltage Vb is applied to a gate of the transistor TR23. Therefore, the transistor TR23 is operated as a constant current source.

The transistor TR22 is provided between the data line D_1 and the gate of the transistor TR21, and the transistor TR22 switches on-off states based on a pulse signal (that is, the gate control signal G_1) transmitted through the row scanning line G_1. Further, one lead of the capacitor CS2 is connected to the gate of the transistor TR21, and a ramp signal is applied to the other lead of the capacitor CS2. The ramp signal is a signal in which a voltage is increased at a predetermined slew rate.

For example, in response to the transistor TR22 that is temporarily turned on by a high H level of a pulse wave of the gate control signal G_1, an image signal (that is, an image signal D_1) transmitted through the data line D_1 is applied to the gate of the transistor TR21. At this time, the transistor TR21 is turned off because a gate-source voltage of the transistor TR21 is pre-set to be less than or equal to a threshold voltage of the corresponding transistor TR21. Therefore, a constant current is not supplied to the node N_1 from the pixel circuit 15_1b.

In response to the transistor TR22 of all pixel circuit that is turned off as a high H level of a pulse wave of gate control signals G_1 to G_n is sequentially lowered (switched to a L level), a voltage of the ramp signal is initialized as a lowest voltage 0V (zero V), and then slowly increased. Accordingly, a gate voltage of the transistor TR21 is lowered and then starts to slowly increase.

In response to the gate voltage of the transistor TR21 being lowered as the ramp signal is initialized, the gate-source voltage of the transistor TR21 becomes greater than the threshold voltage. Therefore, the transistor TR21 is turned on. At this time, a constant current generated by the transistor TR23 is supplied to the node N_1.

In response to the gate-source voltage of the transistor TR21 being less than or equal to the threshold vale of the corresponding transistor TR21 as the gate voltage of the transistor TR21 is slowly increased, the transistor TR21 is turned off. The node N_1 is maintained at a predetermined voltage during an on-period of the transistor TR21. The on-period of the transistor TR21 depends on the image signal D_1. Therefore, a constant current is supplied to the node N_1 according to the image signal D_1 during a time-division period. Accordingly, in the pixel circuit 15_1b, a gradation of the image signal D_1 is represented according to time-division driving.

Because the constant current source is used in the pixel circuit 15_1b in the PWM method shown in FIG. 3, luminance efficiency or chromaticity may be stabilized for a diode element that is easily changed by a current density.

Further, the configuration of the pixel circuit 15_1 is not limited to the configuration of the pixel circuit 15_1a shown in FIG. 2, and the configuration of the pixel circuit 15_1b shown in FIG. 3. Alternatively, the configuration of the pixel circuit 15_1 may be appropriately modified to implement equivalent functions. Further, the pixel circuit 15_1 may include a deviation correction function. This is applied to a pixel circuit other than the pixel circuit 15_1.

Hereinafter a configuration in which each of the pixel circuits 15_1 to 15_p is the PWM type pixel circuit shown in FIG. 3 is described as an example.

The voltage control circuit 14 is configured to selectively supply a ground voltage GND to one of the nodes Na, Nb, and Nc. In a state in which the ground voltage GND is selectively supplied to one of the nodes Na, Nb, and Nc, the pixel circuits 15_1 to 15_p selectively allows one of the plurality of light emitting elements (three light emitting elements in the embodiment), which are provided in the light emitting element groups 16_1 to 16_p, to emit light by supplying a constant current signal of the time-division period to the nodes N_1 to N_p according to the image signal D_1.

That is, in order to allow a light emitting element, which emits light, in the light emitting element group 16 to be changed according to the plurality of sub-fields forming a single field, the voltage control circuit 14 may sequentially transmit a reference voltage to the plurality of light emitting elements Da, Db, and Dc included in the light emitting element group 16.

For example, the voltage control circuit 14 allows the light emitting elements D1a to Dpa, which are provided in each of the light emitting element groups 16_1 to 16_p, to emit light by supplying the ground voltage GND to the node Na during a first sub-field period among three sub-fields forming a single field. Further, the voltage control circuit 14 allows the light emitting elements D1b to Dpb, which are provided in each of the light emitting element groups 16_1 to 16_p, to emit light by supplying the ground voltage GND to the node Nb during a second sub-field period. In addition, the voltage control circuit 14 allows the light emitting elements D1c to Dpc, which are provided in each of the light emitting element groups 16_1 to 16_p, to emit light by supplying the ground voltage GND to the node Nc during a third sub-field period. Accordingly, the voltage control circuit 14 may simultaneously supply the reference voltage to each light emitting element of the light emitting element groups 16_1 to 16_p. That is, the reference voltage transmitted by the voltage control circuit 14 may be the ground voltage GND.

The voltage control circuit 14 does not simultaneously supply the reference voltage to two or more of the nodes Na, Nb, and Nc. In other words, the voltage control circuit 14 does not overlap the supply of the reference voltage for each of the nodes Na, Nb, and Nc. Accordingly, an unintended mixture of light emission by the plurality of light emitting elements may be prevented. In other words, the voltage control circuit 14 may selectively transmit the reference voltage to any one of the plurality of light emitting elements Da, Db, and Dc during one sub-field among the plurality of sub-fields.

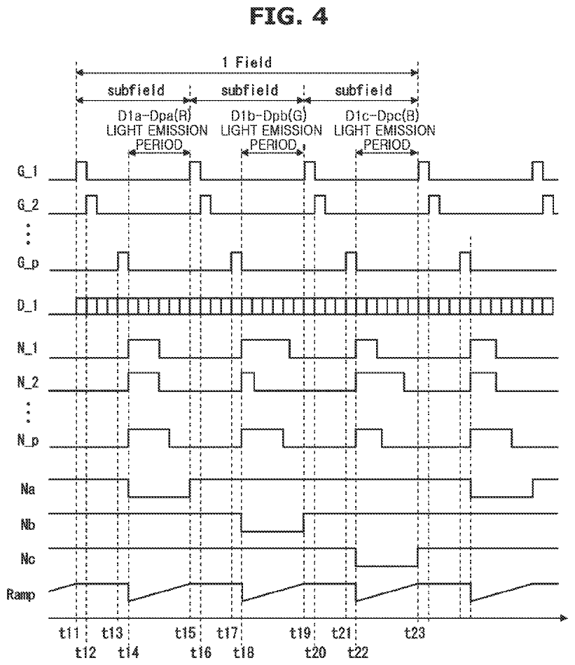

FIG. 4 is a timing chart illustrating an operation of the display apparatus 1. In an example of FIG. 4, one field is composed of three sub-fields equal to a quantity of light emitting elements provided in each of the light emitting element groups 16_1 to 16_p. For example, time t11 to t23 in one field is composed of time t11 to t15 in a first sub-field, time t15 to t19 in a second sub-field, and time t19 to t23 in a third sub-field.

As the plurality of image signals D_1 with respect to the light-emitting elements D1a to Dpa is sequentially output, the gate control signals G_1 to G_p are temporarily increased in sequence (time t11 to t13). Accordingly, the image signal D_1 is supplied to the pixel circuits 15_1 to 15_p (for example, a gate of the transistor TR21 of each pixel circuit).

In response to the completion of the supply of the image signal D_1 to the pixel circuits 15_1 to 15_p (that is, all the gate control signals G_1 to G_p are lowered), the voltage control circuit 14 supplies the ground voltage GND to the node Na among the nodes Na to Nc (time t14 to t15).

In response to the start of the supply of the ground voltage GND to the node Na from the voltage control circuit 14, the constant current signal starts to be supplied to the nodes N_1 to N_p from the pixel circuit 15_1 to 15_p (time t14). The constant current signal is continuously supplied to the nodes N_1 to N_p during the time-division period according the image signal D_1 (any range in time t14 to t15). At this time, the nodes N_1 to N_p are maintained at a level of a LED operation voltage during a period in which the constant current signal is supplied (the time-division period).

Accordingly, the light emitting elements D1a to Dpa corresponding to the red LED emit light during the assigned time-division period (any range in time t14 to t15).

As the plurality of image signals D_1 with respect to the light-emitting elements D1b to Dpb is sequentially output, the gate control signals G_1 to G_p are temporarily increased in sequence (time t15 to t17). Accordingly, the image signal D_1 is supplied to the pixel circuits 15_1 to 15_p (for example, a gate of the transistor TR21 of each pixel circuit).

In response to the completion of the supply of the image signal D_1 to the pixel circuits 15_1 to 15_p (that is, all the gate control signals G_1 to G_p are lowered), the voltage control circuit 14 supplies the ground voltage GND to the node Nb among the nodes Na to Nc (time t18 to t19).

In response to the start of the supply of the ground voltage GND to the node Nb from the voltage control circuit 14, the constant current signal starts to be supplied from the pixel circuit 15_1 to 15_p to the nodes N_1 to N_p (time t18). The constant current signal is continuously supplied to the nodes N_1 to N_p according to the image signal D_1 during the time-division period (any range in time t18 to t19). At this time, the nodes N_1 to N_p are maintained at the level of the LED operation voltage during the period in which the constant current signal is supplied (the time-division period).

Accordingly, the light emitting elements D1b to Dpb corresponding to the green LED emit light during the assigned time-division period (any range in time t18 to t19).

As the plurality of image signals D_1 about the light-emitting elements D1c to Dpc is sequentially output, the gate control signals G_1 to G_p are temporarily increased in sequence (time t19 to t21). Accordingly, the image signal D_1 is supplied to the pixel circuits 15_1 to 15_p (for example, a gate of the transistor TR21 of each pixel circuit).

In response to the completion of the supply of the image signal D_1 to the pixel circuits 15_1 to 15_p (that is, all the gate control signals G_1 to G_p are lowered), the voltage control circuit 14 supplies the ground voltage GND to the node Nc among the nodes Na to Nc (time t22 to t23).

In response to the start of the supply of the ground voltage GND to the node Nc from the voltage control circuit 14, the constant current signal starts to be supplied to the nodes N_1 to N_p from the pixel circuit 15_1 to 15_p (time t22). The constant current signal is continuously supplied to the nodes N_1 to N_p during the time-division period according the image signal D_1 (any range in time t22 to t23). At this time, the nodes N_1 to N_p are maintained at the level of the LED operation voltage during the period in which the constant current signal is supplied (the time-division period).

Accordingly, the light emitting elements D1c to Dpc corresponding to the blue LED emit light during the assigned time-division period (any range in time t22 to t23).

That is, in an example of FIG. 4, during the first to third sub fields forming the single field, the voltage control circuit 14 allows the red light emitting elements D1a to Dpa to emit light during the first sub-field period, allows the green light emitting elements D1b to Dpb to emit light during the second sub-field period, and allows the blue light emitting elements D1c to Dpc to emit light during the third sub-field period.

In the embodiment, instead of the pixel circuit (for example, the pixel circuit 15_1), which is commonly provided for the plurality of light emitting elements (for example, light emitting elements D1a, D1b, and D1c), being provided with a switch configured to switch a light emitting element, which emits light, the voltage control circuit 14, which is provided on the outside of the panel 11, selectively supplies the reference voltage (ground voltage GND) to one of the plurality of light emitting elements, thereby switching a light emitting element which emits light. Accordingly, the display apparatus 1 may reduce a quantity of pixel circuits without increasing the scale of each pixel circuit because the switch configured to switch a light emitting element, which emits light, is not required in each pixel circuit.

In addition, any one of the light emitting elements D1a to Dpa, D1b to Dpb, and D1c to Dpc connected in common to the voltage control circuit 14 is controlled to emit light at least once during one field period. Accordingly, omission of display data may be prevented.

As described above, according to the embodiment, the display apparatus 1 includes the plurality of light emitting elements (for example, the light emitting elements D1a, D1b, and D1c), the pixel circuit (for example, the pixel circuit 15_1), which is commonly provided for the plurality of light emitting elements, and the voltage control circuit 14 provided between the plurality of light emitting elements and the reference voltage (the ground voltage GND) and configured to selectively supply the reference voltage to one of the plurality of light emitting elements, thereby selectively allowing the corresponding light emitting element, which is among the plurality of light emitting elements, to emit light. Accordingly, the display apparatus 1 according to the embodiment may reduce a quantity of pixel circuits without increasing the scale of each pixel circuit because the switch configured to switch a light emitting element, which emits light, is not required in each pixel circuit. As a result, even if the light emitting element is highly integrated, a more flexible configuration of the layout of the pixel circuit may be facilitated.

In the embodiment, a configuration in which each pixel circuit 15_1 to 15_p is provided with a TFT has been described, but the configuration is not limited thereto. For example, each pixel circuit 15_1 to 15_p may be a microcontroller (μC) integrated circuit. In the configuration in which the pixel circuit is composed of TFTs, a quantity of pixel circuits may be reduced, and thus a yield may be increased. Further, in the configuration in which the pixel circuit is a microcontroller (μC) integrated circuit, a quantity of pixel circuits may be reduced, and thus a size of the microcontroller (μC) integrated circuit may also be reduced, thereby realizing a manufacturing cost reduction.

Further, in the embodiment, the configuration in which the voltage control circuit 14 is commonly provided for the light emitting element groups 16_1 to 16_p, has been described as an example, but the configuration is not limited thereto. For example, a separate voltage control circuit 14 may be provided for each of the light emitting element groups 16_1 to 16_p. In this configuration, a plurality of voltage control circuits 14 may control emission of each of the light emitting element groups 16_1 to 16_p independently of each other.

Next, several modified examples of the display apparatus 1 will be described.

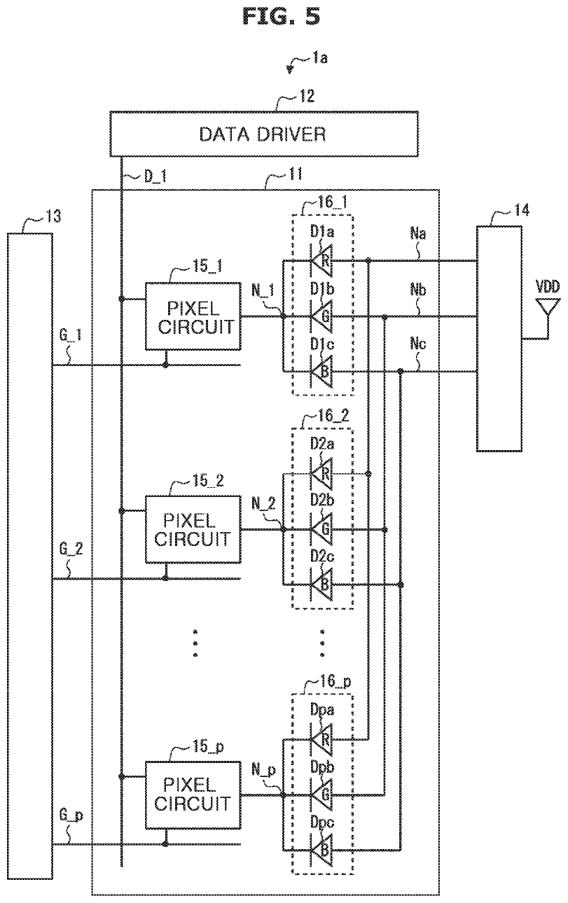

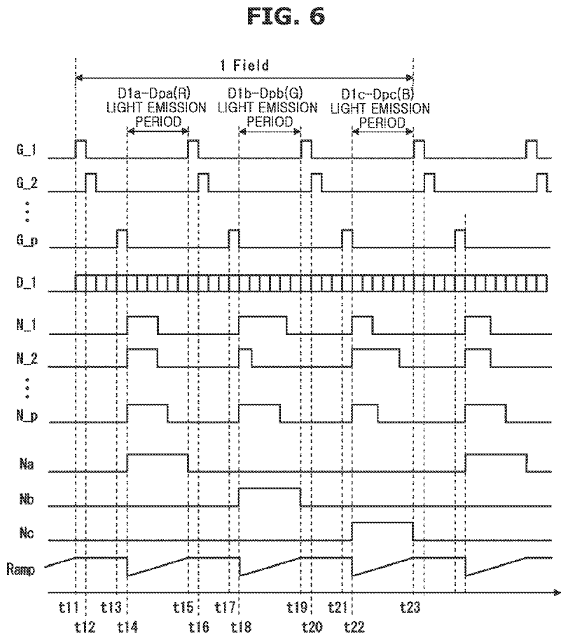

FIG. 5 is a diagram illustrating a modified example of the display apparatus 1 as a display apparatus 1a. FIG. 6 is a timing chart illustrating an operation of the display apparatus 1a. In the display apparatus 1a, a direction of each of the light emitting elements (connection relationship) is opposite to that of the display apparatus 1.

Particularly, in the light emitting elements D1a, D1b, and D1c forming the light emitting element group 16_1, each cathode is connected to the pixel circuit 15_1 through the node N_1, and each anode is connected to the voltage control circuit 14 through nodes Na, Nb and Nc. Further, in the light emitting elements D2a, D2b, and D2c forming the light emitting element group 16_2, each cathode is connected to the pixel circuit 15_2 through the node N_2, and each anode is connected to the voltage control circuit 14 through the nodes Na, Nb and Nc. Similarly, in the light emitting elements Dpa, Dpb, and Dpc forming the light-emitting element group 16_p, each cathode is connected to the pixel circuit 15_p through the node N_p, and each anode is connected to the voltage control circuit 14 through the nodes Na, Nb and Nc. Accordingly, the plurality of light emitting elements Da, Db and Dc included in one light emitting element group 16 may be provided in parallel between the pixel circuit 15 and the voltage control circuit 14.

The voltage control circuit 14 is provided between the light emitting element group 16_1 to 16_p and the power supply voltage source VDD corresponding a power supply, and the voltage control circuit 14 is configured to selectively supply the power supply voltage VDD to one of the nodes Na, Nb, and Nc. In a state in which the power supply voltage VDD is selectively supplied to one of the nodes Na, Nb, and Nc, the pixel circuits 15_1 to 15_p selectively allow one of the plurality of light emitting elements (three light emitting elements in the embodiment), which are provided in the light emitting element groups 16_1 to 16_p, to emit light by supplying a constant current signal of the time-division period to the nodes N_1 to N_p according to the image signal D_1 (that is, applying a LED operation voltage of the time-division period to the nodes N_1 to N_p according to the image signal D_1). That is, the reference voltage transmitted by the voltage control circuit 14 may be a power supply voltage.

Other configurations and operations of the display apparatus 1a are the same as the display apparatus 1 and thus a redundant description thereof is omitted.

The display apparatus 1a may obtain the same effect as that of the display apparatus 1.

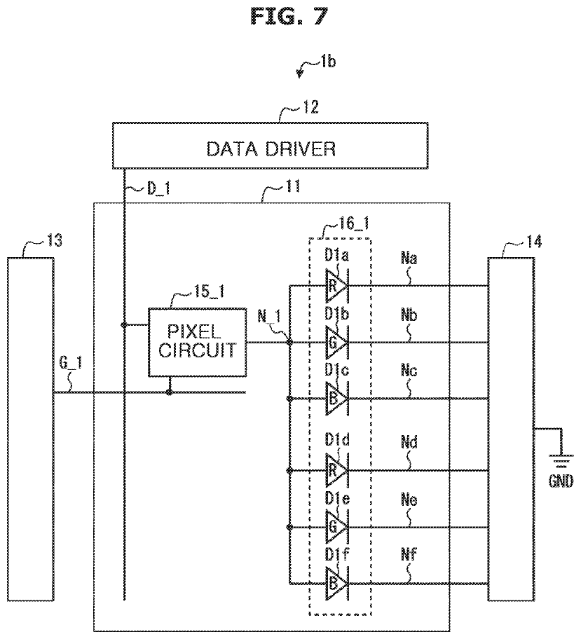

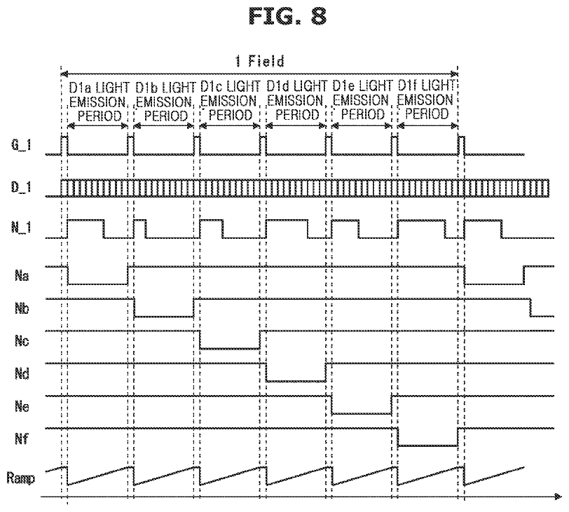

FIG. 7 is a diagram illustrating a modified example of the display apparatus 1 as a display apparatus 1b. FIG. 8 is a timing chart illustrating an operation of the display apparatus 1b. In the display apparatus 1b, a quantity of light emitting elements forming each of light emitting element groups 16_1 to 16_p is two times greater than the display apparatus 1 (six light emitting elements in the embodiment). That is, a quantity of light emitting elements driven by each pixel circuit 15_1 to 15_p doubles (six light emitting elements in the embodiment). For clarity and understanding, in an example of FIG. 7, only the pixel circuit 15_1 and the light emitting element group 16_1 are illustrated on the panel 11.

As mentioned above, the light emitting element group 16 may include at least one or more of each of a red light emitting element, a green light emitting element and a blue light emitting element.

Particularly, the light emitting element group 16_1 includes a light emitting element D1a that emits a red R light, a light emitting element D1b that emits a green G light, a light emitting element D1c that emits a blue B light, a light emitting element D1d that emits a red R light, a light emitting element D1e that emits a green G light, a light emitting element D1f that emits a blue B light, which correspond to the plurality of light emitting elements D.

In the light emitting elements D1a, D1b, D1c, D1d, D1e, and D1f forming the light emitting element group 16_1, each anode is connected to the pixel circuit 15_1 through the node N_1, and each cathode is connected to the voltage control circuit 14 through connections Na, Nb, Nc, Nd, Ne, and Nf.

The voltage control circuit 14 is configured to selectively supply the ground voltage GND to one of the nodes Na, Nb, Nc, Nd, Ne, and Nf. In a state in which the ground voltage GND is selectively supplied to one of the nodes Na, Nb, Nc, Nd, Ne, and Nf, the pixel circuits 15_1 to 15_p selectively allows one of the plurality of light emitting elements (six light emitting elements in the embodiment), which are provided in the light emitting element group 16_1, to emit light by supplying a constant current signal of the time-division period to the node N_1 according to the image signal D_1 (that is, supplying an LED operation voltage of the time-division period to the node N_1 according to the image signal D_1).

For example, during six sub-fields forming a single field, the voltage control circuit 14 controls the light emitting element D1a to emit light by supplying the ground voltage GND to the node Na during the first sub-field period. The voltage control circuit 14 controls the light emitting element D1b to emit light by supplying the ground voltage GND to the node Nb during the second sub-field period. The voltage control circuit 14 controls the light emitting element D1c to emit light by supplying the ground voltage GND to the node Nc during the third sub-field period. The voltage control circuit 14 controls the light emitting element D1d to emit light by supplying the ground voltage GND to the node Nd during the fourth sub-field period. The voltage control circuit 14 controls the light emitting element D1e to emit light by supplying the ground voltage GND to the node Ne during the fifth sub-field period. The voltage control circuit 14 controls the light emitting element D1f to emit light by supplying the ground voltage GND to the node Nf during the sixth sub-field period.

Other configurations and operations of the display apparatus 1b are the same as the display apparatus 1 and thus a redundant description thereof is omitted.

A quantity of light emitting elements driven by each of the pixel circuits 15_1 to 15_p is not limited to three or six, and may be any quantity. However, it may be preferable that a quantity of light emitting elements driven by the respective pixel circuits 15_1 to 15_p is a multiple of three because a quantity of light emitting elements may be increased or decreased in units of three RGB light-emitting elements. However, other configurations of light emitting elements of various colors may be possible, and various quantities of light emitting elements are possible.

As described above, in a condition of securing a sufficient driving time for allowing each light emitting element to emit light, the display apparatus 1b may increase a quantity of light emitting elements driven by the respective pixel circuits 15_1 to 15_p, thereby reducing a quantity of pixel circuits. In this configuration, each light emitting element may be configured in a reverse direction as in the configuration of FIG. 5.

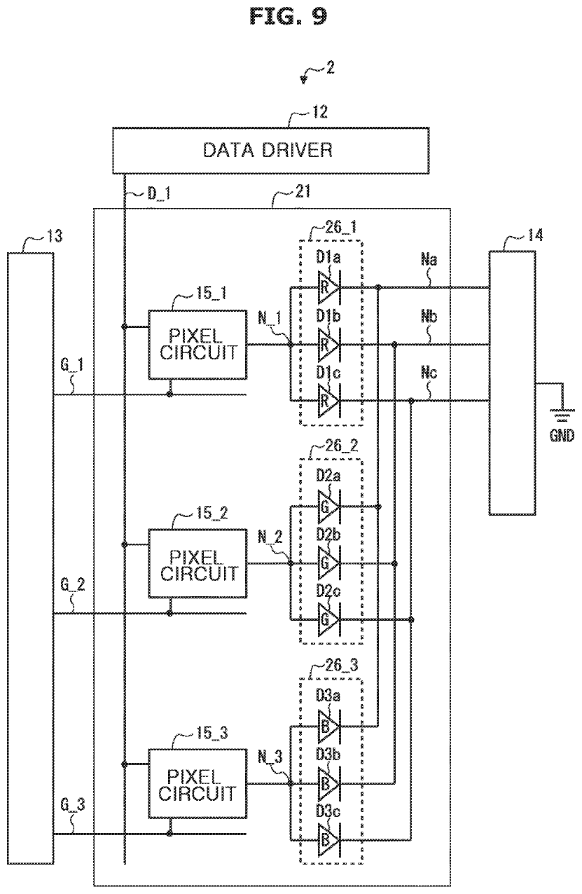

FIG. 9 is a diagram illustrating a display apparatus according to an embodiment of the disclosure. In comparison with the display apparatus 1, the display apparatus 2 is provided with a panel 21 instead of the panel 11. In comparison with the panel 11, the panel 21 is provided with light emitting element groups 26_1 to 26_p instated of the light emitting element groups 16_1 to 16_p. For clarity and understanding, in an example of FIG. 9, only pixel circuit 15_1 and light emitting element groups 26_1 to 26_3 are illustrated on the panel 21.

Particularly, the light emitting element group 26_1 includes all red R light emitting elements D1a, D1b, and D1c as the plurality of light emitting elements D. The light emitting element group 26_2 includes all green G light emitting elements D2a, D2b, and D2c as the plurality of light emitting elements D. The light emitting element group 26_3 includes all blue B light emitting elements D3a, D3b, and D3c as the plurality of light emitting elements D. That is, the light emitting element group 26 may include the first light emitting element group 26_1 including the plurality of red R light emitting elements D1a, D1b, and D1c, the second light emitting element group 26_2 including the plurality of green G light emitting elements D2a, D2b, and D2c, and the third light emitting element group 26_3 including the plurality of blue B light emitting elements D3a, D3b, and D3c.

As described above, the light emitting element group 26 may include the plurality of light emitting elements D of the same color.

In the light emitting elements D1a, D1b, and D1c forming the light emitting element group 26_1, each anode is connected to the pixel circuit 15_1 through the node N_1, and each cathode is connected to the voltage control circuit 14 through nodes Na, Nb and Nc. Further, in the light emitting elements D2a, D2b, and D2c forming the light-emitting element group 26_2, each anode is connected to the pixel circuit 15_2 through the node N_2, and each cathode is connected to the voltage control circuit 14 through the nodes Na, Nb and Nc. Similarly, in the light emitting elements D3a, D3b, and D3c forming the light-emitting element group 26_3, each anode is connected to the pixel circuit 15_3 through the node N_3, and each cathode is connected to the voltage control circuit 14 through the nodes Na, Nb and Nc. Accordingly, the plurality of light emitting elements Da, Db and Dc included in one light emitting element group 26 may be provided in parallel between the pixel circuit 15 and the voltage control circuit 14.

However, an arrangement relationship of the light emitting elements D shown in FIG. 9 is only for describing the light emitting element group 26 connected to the pixel circuit 15, and does not illustrate a physical arrangement relationship in the panel 21. Therefore, there is no limitation on the physical arrangement relationship of the light emitting element D in the panel 21, and thus the red light emitting element D1, the green light emitting element D2, and the blue light emitting element D3 may be adjacent to each other, thereby forming a single pixel circuit. That is, the light emitting element D1a of the first light emitting element group 26_1 may be adjacent to the light emitting element D2a of the second light emitting element group 26_2, and the light emitting element D3a of the third light emitting element group 26_3 which share the node Na. Therefore, the light emitting element D1a simultaneously emits light together with the light emitting element D2a and the light emitting element D3a. Similarly, the light emitting element D1b of the first light emitting element group 26_1 may be adjacent to the light emitting element D2b of the second light emitting element group 26_2, and the light emitting element D3b of the third light emitting element group 26_3 which share the node Nb. As a result, the light emitting element D1b simultaneously emits light together with the light emitting element D2b and the light emitting element D3b. Similarly, the light emitting element D1c of the first light emitting element group 26_1 may be adjacent to the light emitting element D2c of the second light emitting element group 26_2, and the light emitting element D3c of the third light emitting element group 26_3 which share the node Nc. Therefore, the light emitting element D1c simultaneously emits light together with the light emitting element D2c and the light emitting element D3c.

Other configurations and operations of the display apparatus 2 are the same as the display apparatus 1 and thus a redundant description thereof is omitted.

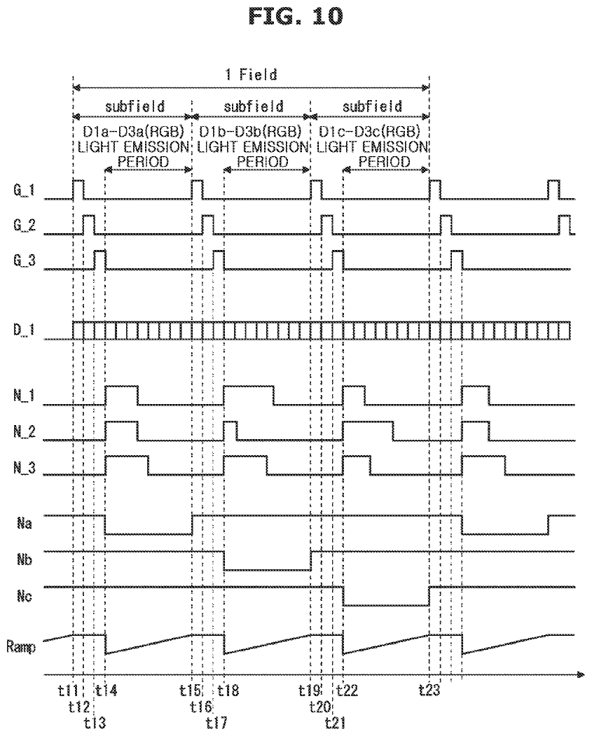

FIG. 10 is a timing chart illustrating an operation of the display apparatus 2. In an example of FIG. 10, one field is composed of three sub-fields equal to a quantity of light emitting elements provided in each light emitting element group 16_1 to 16_3. For example, time t11 to t23 in one field is composed of time t11 to t15 in a first sub-field, time t15 to t19 in a second sub-field, and time t19 to t23 in a third sub-field.

As the plurality of image signals D_1 with respect to the light-emitting elements D1a to D3a is sequentially output, the gate control signals G_1 to G_3 are temporarily increased in sequence (time t11 to t13). Accordingly, the image signal D_1 is supplied to the pixel circuits 15_1 to 15_3 (for example, a gate of the transistor TR21 of each pixel circuit).

In response to the completion of the supply of the image signal D_1 to the pixel circuits 15_1 to 15_3 (that is, all the gate control signals G_1 to G_3 are lowered), the voltage control circuit 14 supplies the ground voltage GND to the node Na among the nodes Na to Nc (time t14 to t15).

In response to the start of the supply of the ground voltage GND to the node Na from the voltage control circuit 14, the constant current signal starts to be supplied to the nodes N_1 to N_3 from the pixel circuit 15_1 to 15_3 (time t14). The constant current signal is continuously supplied to the nodes N_1 to N_3 during the time-division period according the image signal D_1 (any range in time t14 to t15). At this time, the nodes N_1 to N_3 are maintained at a level of a LED operation voltage during a period in which the constant current signal is supplied (the time-division period).

Accordingly, the RGB three color light emitting elements D1a, D2a, and D3a emit light during the assigned time-division period (any range in time t14-t15).

As the plurality of image signals D_1 with respect to the light emitting elements D1b to D3b is sequentially output, the gate control signals G_1 to G_3 are temporarily increased in sequence (time t15 to t17). Accordingly, the image signal D_1 is supplied to the pixel circuits 15_1 to 15_3 (for example, a gate of the transistor TR21 of each pixel circuit).

In response to the completion of the supply of the image signal D_1 to the pixel circuits 15_1 to 15_3 (that is, all the gate control signals G_1 to G_3 are lowered), the voltage control circuit 14 supplies the ground voltage GND to the node Nb among the nodes Na to Nc (time t18 to t19).

In response to the start of the supply of the ground voltage GND to the node Nb from the voltage control circuit 14, the constant current signal starts to be supplied to the nodes N_1 to N_3 from the pixel circuit 15_1 to 15_3 (time t18). The constant current signal is continuously supplied to the nodes N_1 to N_3 during the time-division period according the image signal D_1 (any range in time t18 to t19). At this time, the nodes N_1 to N_3 are maintained at a level of a LED operation voltage during a period in which the constant current signal is supplied (the time-division period).

Accordingly, the RGB three color light emitting elements D1b, D2b, and D3b emit light during the assigned time-division period (any range in time t18 to t19).

As the plurality of image signals D_1 with respect to the light emitting elements D1c to D3c is sequentially supplied, the gate control signals G_1 to G_3 are temporarily increased in sequence (time t19 to t21). Accordingly, the image signal D_1 is supplied to the pixel circuits 15_1 to 15_3 (for example, a gate of the transistor TR21 of each pixel circuit).

In response to the completion of the supply of the image signal D_1 to the pixel circuits 15_1 to 15_3 (that is, all the gate control signals G_1 to G_3 are lowered), the voltage control circuit 14 supplies the ground voltage GND to the node Nc among the nodes Na to Nc (time t22 to t23).

In response to the start of the supply of the ground voltage GND to the node Nc from the voltage control circuit 14, the constant current signal starts to be supplied to the nodes N_1 to N_3 from the pixel circuit 15_1 to 15_3 (time t22). The constant current signal is continuously supplied to the nodes N_1 to N_3 during the time-division period, according the image signal D_1 (any range in time t22 to t23). At this time, the nodes N_1 to N_3 are maintained at a level of a LED operation voltage during a period in which the constant current signal is supplied (the time-division period).

Accordingly, the RGB three color light emitting elements D1c, D2c, and D3c emit light during the assigned time-division period (any range in time t22 to t23).

That is, in an example of FIG. 10, during the first to third sub-fields forming the single field, the voltage control circuit 14 controls the RGB three color light emitting elements to emit light.

According to the embodiment, instead of the pixel circuit (for example, the pixel circuit 15_1), which is commonly provided for the plurality of light emitting elements D1a, D1b, and D1c, being provided with a switch configured to switch a light emitting element, which emits light, the voltage control circuit 14, which is provided on the outside of the panel 21, selectively supplies the reference voltage (ground voltage GND) to one of the plurality of light emitting elements, thereby switching a light emitting element which emits light. Accordingly, the display apparatus 2 may reduce a quantity of pixel circuits without increasing the scale of each pixel circuit because the switch configured to switch a light emitting element, which emits light, is not required in each pixel circuit.

In addition, any of the light emitting elements D1a to D3a, D1b to D3b, and D1c to D3c connected in common to the voltage control circuit 14 may be controlled to emit at least once during a single field. Accordingly, omission of display data may be prevented.

As mentioned above, the display apparatus 2 according to the embodiment may obtain an effect similar to the display apparatus 1. Further, the display apparatus 2 according to the embodiment may prevent color brake noise because the display apparatus 2 allows the RGB three color light emitting elements to simultaneously emit light. In the display apparatus 2 according to the embodiment, in the configuration in which each pixel circuit is the PWM type pixel circuit, it the plurality of light emitting elements are controlled to be driven by each pixel unit to have the same color, thereby suppressing the constant current of each pixel unit to, for example, once per one field.

Further, according to the embodiment, the configuration in which the voltage control circuit 14 is commonly provided for the light emitting element groups 26_1 to 26_3 has been described as an example, but the configuration is not limited thereto. For example, a separate voltage control circuit 14 may be provided for each of the light emitting element groups 26_1 to 26_3. In this configuration, a plurality of voltage control circuits 14 may individually control emission of each of the light emitting element groups 26_1 to 26_3 independently of each other.

Next, several modified examples of the display apparatus 2 will be described.

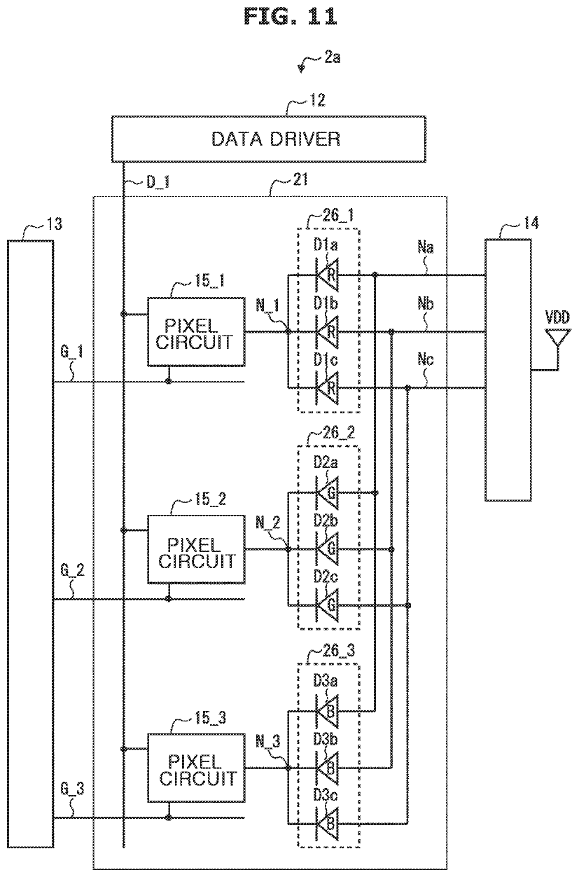

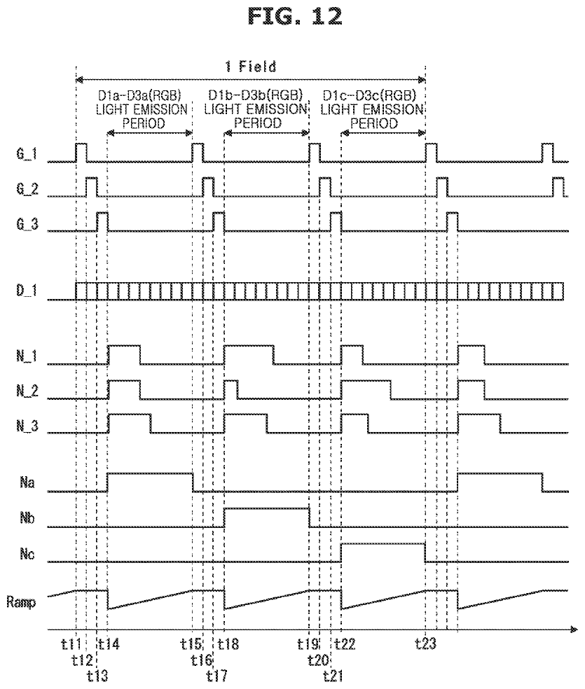

FIG. 11 is a diagram illustrating a modified example of the display apparatus 2 as a display apparatus 2a. FIG. 12 is a timing chart illustrating an operation of the display apparatus 2a. In the display apparatus 2a, a direction of each of the light emitting elements (connection relationship) is opposite to that of the display apparatus 2.

Particularly, in the light emitting elements D1a, D1b, and D1c forming the light emitting element group 26_1, each cathode is connected to the pixel circuit 15_1 through the node N_1, and each anode is connected to the voltage control circuit 14 through nodes Na, Nb and Nc. Further, in the light emitting elements D2a, D2b, and D2c forming the light-emitting element group 26_2, each cathode is connected to the pixel circuit 15_2 through the node N_2, and each anode is connected to the voltage control circuit 14 through the nodes Na, Nb and Nc. Similarly, in the light emitting elements D3a, D3b, and D3c forming the light emitting element group 26_3, each cathode is connected to the pixel circuit 15_3 through the node N_3, and each anode is connected to the voltage control circuit 14 through the nodes Na, Nb and Nc.

The voltage control circuit 14 is provided between the light emitting element group 26_1 to 26_3 and the power supply voltage source VDD corresponding a reference power supply, and the voltage control circuit 14 is configured to selectively supply the power supply voltage VDD to one of the nodes Na, Nb, and Nc. In a state in which the power supply voltage VDD is selectively supplied to one of the nodes Na, Nb, and Nc, the pixel circuits 15_1 to 15_p selectively controls one of the plurality of light emitting elements (three light emitting elements in the embodiment), which are provided in the light emitting element groups 26_1 to 26_3, to emit light by supplying a constant current signal of the time-division period to the nodes N_1 to N_3 according to the image signal D_1 (that is, applying a LED operation voltage of the time-division period to the nodes N_1 to N_3 according to the image signal D_1).

Other configurations and operations of the display apparatus 2a are the same as the display apparatus 2 and thus a redundant description thereof is omitted.

The display apparatus 2a may obtain an effect equivalent to that of the display apparatus 2.

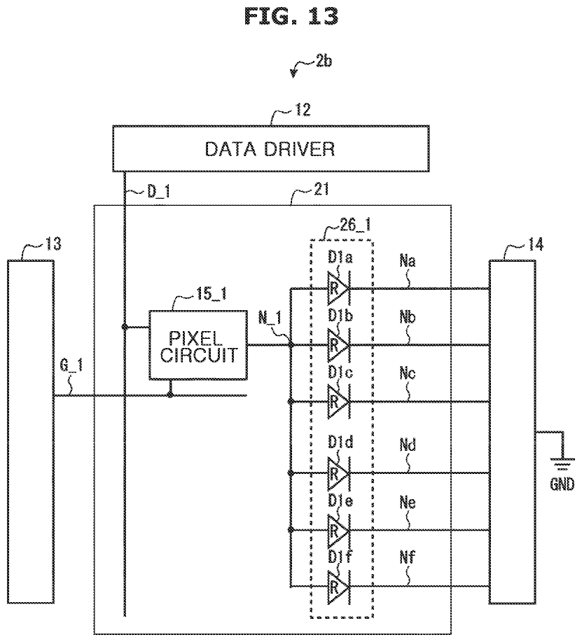

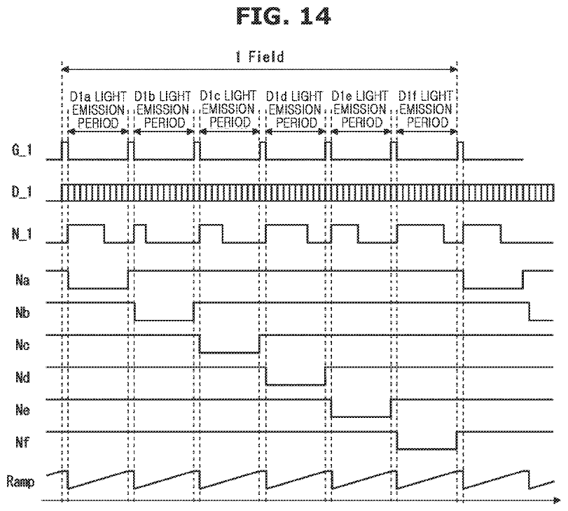

FIG. 13 is a diagram illustrating a modified example of the display apparatus 2 as a display apparatus 2b. FIG. 14 is a timing chart illustrating an operation of the display apparatus 2b. In the display apparatus 2b, a quantity of light emitting elements forming each of light emitting element groups 26_1 to 26_p is two times greater than the display apparatus 2 (six light emitting elements in the embodiment). That is, a quantity of light emitting elements driven by each pixel circuit 15_1 to 15_3 doubles (six light emitting elements in the embodiment). For clarity and understanding, in an example of FIG. 13, only the pixel circuit 15_1 and the light emitting element group 26_1 are illustrated on the panel 21.

Particularly, the light emitting element group 26_1 includes all red R light emitting element D1a, D1b, D1c, D1d, D1e, and D1f as the plurality of emitting elements D. Further, the light emitting element group 26_2 includes all green G light emitting element D2a, D2b, D2c, D2d, D2e, and D2f as the plurality of emitting elements D. Further, the light emitting element group 26_3 includes all blue B light emitting element D3a, D3b, D3c, D3d, D3e, and D3f as the plurality of emitting elements D.

In the light emitting elements D1a, D1b, D1c, D1d, D1e, and D1f forming the light emitting element group 26_1, each anode is connected to the pixel circuit 15_1 through the node N_1, and each cathode is connected to the voltage control circuit 14 through nodes Na, Nb, Nc, Nd, Ne, and Nf. In the light emitting elements D2a, D2b, D2c, D2d, D2e, and D2f forming the light emitting element group 26_2, each anode is connected to the pixel circuit 15_2 through the node N_2, and each cathode is connected to the voltage control circuit 14 through the nodes Na, Nb, Nc, Nd, Ne, and Nf. In the light emitting elements D3a, D3b, D3c, D3d, D3e, and D3f forming the light emitting element group 26_3, each anode is connected to the pixel circuit 15_3 through the node N_3, and each cathode is connected to the voltage control circuit 14 through the nodes Na, Nb, Nc, Nd, Ne, and Nf.

The voltage control circuit 14 is configured to selectively supply the ground voltage GND to one of the nodes Na, Nb, Nc, Nd, Ne, and Nf. In a state in which the ground voltage GND is selectively supplied to one of the nodes Na, Nb, Nc, Nd, Ne, and Nf, the pixel circuits 15_1 to 15_3 selectively allows one of the plurality of light emitting elements (six light emitting elements in the embodiment), which are provided in each light emitting element group 26_1 to 26_3, to emit light by supplying a constant current signal of the time-division period to the nodes N_1 to N_3 according to the image signal D_1 (that is, applying a LED operation voltage of the time-division period to the nodes N_1˜N_3 according to the image signal D_1).

For example, during six sub-fields forming a single field, the voltage control circuit 14 controls the light emitting elements D1a to D3a to emit light by supplying the ground voltage GND to the node Na during the first sub-field period. The voltage control circuit 14 controls the light emitting elements D1b to D3b to emit light by supplying the ground voltage GND to the node Nb during the second sub-field period. The voltage control circuit 14 controls the light emitting elements D1c to D3c to emit light by supplying the ground voltage GND to the node Nc during the third sub-field period. The voltage control circuit 14 controls the light emitting elements D1d to D3d to emit light by supplying the ground voltage GND to the node Nd during the fourth sub-field period. The voltage control circuit 14 controls the light emitting elements D1e to D3e to emit light by supplying the ground voltage GND to the node Ne during the fifth sub-field period. The voltage control circuit 14 controls the light emitting elements D1f to D3f to emit light by supplying the ground voltage GND to the node Nf during the sixth sub-field period.

Other configurations and operations of the display apparatus 2b are the same as the display apparatus 2 and thus a redundant description thereof is omitted.

A quantity of light emitting elements driven by each of the pixel circuits 15_1 to 15_p is not limited to three or six, and may be any number. However, a quantity of light emitting elements driven by the respective pixel circuits 15_1 to 15_p is not required to be a multiple of three because it is not required that a quantity of light emitting elements is increased or decreased in units of three RGB light emitting elements.

As mentioned above, in a condition of securing a sufficient driving time for allowing each light emitting element to emit light, the display apparatus 2b may increase a quantity of light emitting elements driven by the respective pixel circuits 15_1 to 15_p, thereby reducing a quantity of pixel circuits. In this configuration, each light emitting element may be configured in a reverse direction as in the configuration of FIG. 11.

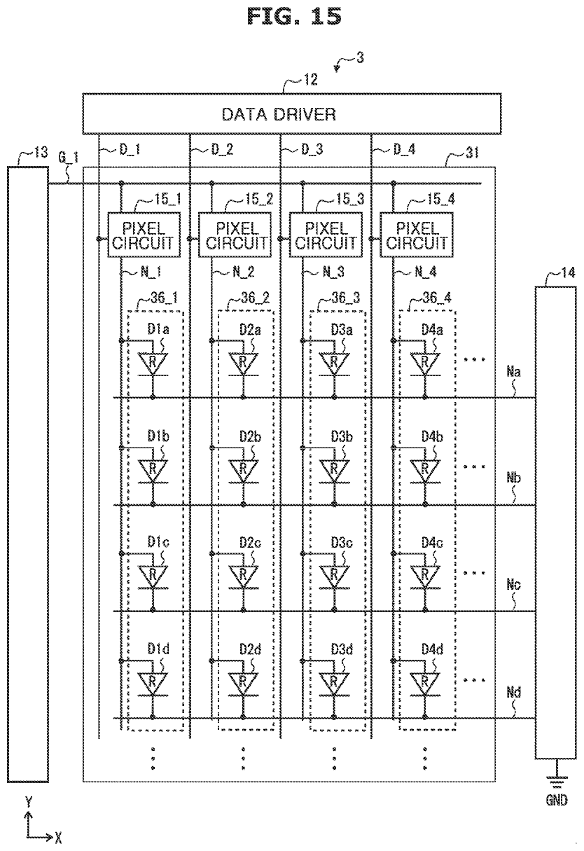

FIG. 15 is a diagram illustrating a configuration example of a display apparatus according to an embodiment of the disclosure.

In comparison with the display apparatus 1, the display apparatus 3 is provided with a panel 31 instead of the panel 11. On the panel 31, a plurality of red R light emitting elements D in m rows (m is an integer of 2 or more) and n columns (n is an integer of 2 or more) is provided. In addition, although not shown for clarity and understanding, the panel 31 is also provided with a plurality of green G light emitting elements D and a plurality of blue B light emitting elements D corresponding to the plurality of red R light emitting elements D. That is, on the panel 31, the light emitting elements D may be arranged in a plurality of rows and a plurality of columns. Hereinafter the plurality of red R light emitting elements D will be described unless the context clearly indicates otherwise, and a configuration the same as a configuration employed for the plurality of red R light emitting elements D may be employed for the plurality of green G light emitting elements D and the plurality of blue B light emitting elements D.

According to the embodiment, at each column of the plurality of light emitting elements D in m rows×n columns matrix, a light emitting element group 36 composed of light emitting elements D (that is, r light emitting elements D) divided into r rows (r is an integer of from 2 to m) is provided. In an example of FIG. 15, at each column, the light emitting element group 36 composed of the light emitting elements divided into four rows is provided. FIG. 15 illustrates light emitting element groups 36_1 to 36_4 divided into four columns, as a part of the plurality of light emitting element group 36. That is, the light emitting element group 36 may include a plurality of light emitting elements D arranged in the same column.

Particularly, the light emitting element group 36_1 is composed of four light emitting elements D1a to D1d from the first row to the fourth row of the first column. The light emitting element group 36_2 is composed of four light emitting elements D2a to D2d from the first row to the fourth row of the second column. The light emitting element group 36_3 is composed of four light emitting elements D3a to D3d from the first row to the fourth row of the third column. The light emitting element group 36_4 is composed of four light emitting elements D4a to D4d from the first row to the fourth row of the fourth column.

Further, FIG. 15 illustrates pixel circuits 15_1 to 15_4 configured to drive the light emitting element groups 36_1 to 36_4, respectively, as a part of a plurality of pixel circuits 15.

The voltage control circuit 14 is provided between the light emitting element groups 36_1 to 36_4 and a ground voltage source GND corresponding to a reference power supply. In the embodiment, a state in which the voltage control circuit 14 is commonly provided for the light emitting element groups 36_1 to 36_4 will be described as an example.

In the light emitting elements D1a to D1d forming the light emitting element group 36_1, each anode is connected to the pixel circuit 15_1 through a node N_1, and each cathode is connected to the voltage control circuit 14 through nodes Na to Nd. In the light emitting elements D2a to D2d forming the light emitting element group 36_2, each anode is connected to the pixel circuit 15_2 through a node N_2, and each cathode is connected to the voltage control circuit 14 through the nodes Na to Nd. Further, in the light emitting elements D3a to D3d forming the light emitting element group 36_3, each anode is connected to the pixel circuit 15_3 through a node N_3, and each cathode is connected to the voltage control circuit 14 through the nodes Na to Nd. In the light emitting elements D4a to D4d forming the light emitting element group 36_4, each anode is connected to the pixel circuit 15_4 through a node N_4, and each cathode is connected to the voltage control circuit 14 through the nodes Na to Nd.

The voltage control circuit 14 is configured to selectively supply the ground voltage GND to one of the nodes Na to Nd. In a state in which the ground voltage GND is selectively supplied to one of the nodes Na to Nd, the pixel circuits 15_1 to 15_4 selectively controls one of the plurality of light emitting elements (four light emitting elements in the embodiment), which are provided in the light emitting element groups 36_1 to 36_4, to emit light by supplying a constant current signal of a time-division period to the nodes N_1 to N_4 according to the image signal D_1 (an image signal supplied from the data driver 12 to the data lines D_1 to D_4) (that is, applying a LED operation voltage of a time-division period to the nodes N_1 to N_4 according to image signals D_1 to D_4).

For example, the voltage control circuit 14 controls the light emitting elements D1a to D4a at the first row, which are provided in each of the light emitting element groups 36_1 to 36_4, to emit light by supplying the ground voltage GND to the node Na during a first sub-field period among four sub-fields forming a single field. Further, the voltage control circuit 14 controls the light emitting elements D1b to D4b at the second row, which are provided in each of the light emitting element groups 36_1 to 36_4, to emit light by supplying the ground voltage GND to the node Nb during a second sub-field period. In addition, the voltage control circuit 14 controls the light emitting elements D1c to D4c at the third row, which are provided in each of the light emitting element groups 36_1 to 36_4, to emit light by supplying the ground voltage GND to the node Nc during a third sub-field period. In addition, the voltage control circuit 14 controls the light emitting elements D1d to D4d at the fourth row, which are provided in each of the light emitting element groups 36_1 to 36_4, to emit light by supplying the ground voltage GND to the node Nd during a fourth sub-field period.

Other configurations and operations of the display apparatus 3 are the same as the display apparatus 1 and thus a redundant description thereof is omitted.

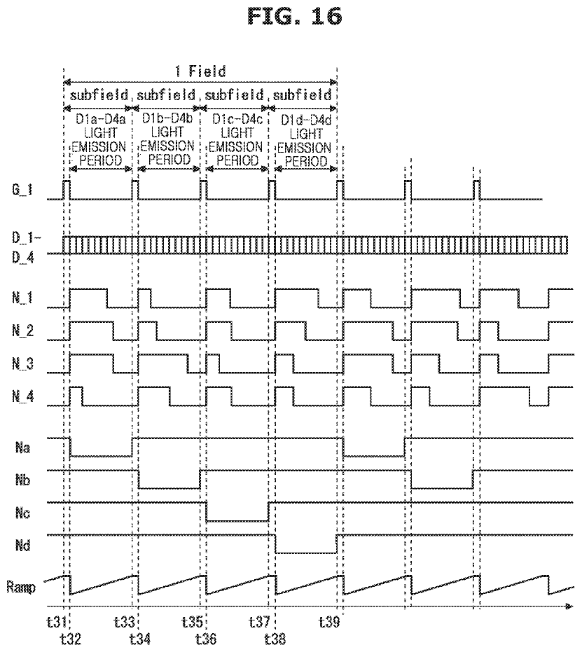

FIG. 16 is a timing chart illustrating an operation of the display apparatus 3. In an example of FIG. 16, one field is composed of four sub-fields equal to a quantity of light emitting elements provided in each light emitting element group 36_1 to 36_4. For example, time t31 to t39 in one field is composed of time t31 to t33 in a first sub-field, time t33 to t35 in a second sub-field, time t35 to t37 in a third sub-field, and time t37 to t39 in a fourth sub-field.

As the image signals D_1 to D_4 with respect to the light emitting elements D1a to D4a at the first row are output, a gate control signal G_1 is temporarily increased (time t31). Accordingly, the image signals D_1 to D_4 are supplied to the pixel circuits 15_1 to 15_4 (for example, a gate of the transistor TR21 of each pixel circuit).

In response to the completion of the supply of the image signals D_1 to D_4 to the pixel circuits 15_1 to 15_4 (that is, the gate control signal G_1 is lowered), the voltage control circuit 14 supplies the ground voltage GND to the node Na among the nodes Na to Nd (time t32 to t33).

In response to the start of the supply of the ground voltage GND to the node Na from the voltage control circuit 14, the constant current signal starts to be supplied from the pixel circuit 15_1 to 15_4 to the nodes N_1 to N_4 (time t32). The constant current signal is continuously supplied to the nodes N_1 to N_4 during the time-division period according the image signal image signals D_1 to D_4 (any range in time t32 to t33). At this time, the nodes N_1 to N_4 are maintained at a level of a LED operation voltage during a period in which the constant current signal is supplied (i.e., the time-division period).

Accordingly, the light emitting elements D1a to D4a at the first row emit light during the assigned time-division period (any range in time t32 to t33).

As the image signals D_1 to D_4 about the light-emitting elements D1b to D4b at the second row are output, the gate control signal G_1 is temporarily increased (time t33). Accordingly, the image signals D_1 to D_4 are supplied to the pixel circuits 15_1 to 15_4 (for example, a gate of the transistor TR21 of each pixel circuit).

In response to the completion of the supply of the image signals D_1 to D_4 to the pixel circuits 15_1 to 15_4 (that is, the gate control signal G_1 is lowered), the voltage control circuit 14 supplies the ground voltage GND to the node Nb among the nodes Na to Nd (time t34 to t35).

In response to the start of the supply of the ground voltage GND to the node Nb from the voltage control circuit 14, the constant current signal starts to be supplied from the pixel circuit 15_1 to 15_4 to the nodes N_1 to N_4 (time t34). The constant current signal is continuously supplied to the nodes N_1 to N_4 during the time-division period according the image signal image signals D_1 to D_4 (any range in time t34 to t35). At this time, the nodes N_1 to N_4 are maintained at the level of the LED operation voltage during the period in which the constant current signal is supplied (i.e., the time-division period).

Accordingly, the light emitting elements D1b to D4b at the second row emit light during the assigned time-division period (any range in time t34 to t35).

As the image signals D_1 to D_4 about the light emitting elements D1c to D4c at the third row are output, the gate control signal G_1 is temporarily increased (time t35). Accordingly, the image signals D_1 to D_4 are supplied to the pixel circuits 15_1 to 15_4 (for example, a gate of the transistor TR21 of each pixel circuit).

In response to the completion of the supply of the image signals D_1 to D_4 to the pixel circuits 15_1 to 15_4 (that is, the gate control signal G_1 is lowered), the voltage control circuit 14 supplies the ground voltage GND to the node Nc among the nodes Na to Nd (time t36 to t37).

In response to the start of the supply of the ground voltage GND to the node Nc from the voltage control circuit 14, the constant current signal starts to be supplied from the pixel circuit 15_1 to 15_4 to the nodes N_1 to N_4 (time t36). The constant current signal is continuously supplied to the nodes N_1 to N_4 during the time-division period according the image signal image signals D_1 to D_4 (any range in time t36 to t37). At this time, the nodes N_1 to N_4 are maintained at the level of the LED operation voltage during the period in which the constant current signal is supplied (i.e., the time-division period).

Accordingly, the light emitting elements D1c to D4c at the third row emit light during the assigned time-division period (any range in time t36 to t37).

As the image signals D_1 to D_4 about the light-emitting elements D1d to D4d at the fourth row are output, the gate control signal G_1 is temporarily increased (time t37). Accordingly, the image signals D_1 to D_4 are supplied to the pixel circuits 15_1 to 15_4 (for example, a gate of the transistor TR21 of each pixel circuit).

In response to the completion of the supply of the image signals D_1 to D_4 to the pixel circuits 15_1 to 15_4 (that is, the gate control signal G_1 is lowered), the voltage control circuit 14 supplies the ground voltage GND to the node Nd among the nodes Na to Nd (time t38 to t39).

In response to the start of the supply of the ground voltage GND to the node Nd from the voltage control circuit 14, the constant current signal starts to be supplied from the pixel circuit 15_1 to 15_4 to the nodes N_1 to N_4 (time t38). The constant current signal is continuously supplied to the nodes N_1 to N_4 during the time-division period according the image signal image signals D_1 to D_4 (any range in time t38 to t39). At this time, the nodes N_1 to N_4 are maintained at the level of the LED operation voltage during the period in which the constant current signal is supplied (i.e., the time-division period).

Accordingly, the light emitting elements D1c to D4c at the fourth row emit light during the assigned time-division period (any range in time t38 to t39).

That is, in an example of FIG. 16, during the first to fourth sub fields forming the single field, the voltage control circuit 14 controls the light emitting elements D1a to D4a at the first row to emit light during the first sub-field period, controls the light emitting elements D1b to D4b at the second row to emit light during the second sub-field period, controls the light emitting elements D1c to D4c at the third row to emit light during the third sub-field period, and controls the light emitting elements D1d to D4d at the fourth row to emit light during the fourth sub-field period.

According to the embodiment, instead of the pixel circuit (for example, the pixel circuit 15_1), which is commonly provided for the plurality of light emitting elements D1a to D1d, being provided with a switch configured to switch a light emitting element, which emits light, the voltage control circuit 14, which is provided on an outside of the panel 31, selectively supplies the reference voltage (ground voltage GND) to one of the plurality of light emitting elements, thereby switching a light emitting element which emits light. Accordingly, the display apparatus 3 may reduce a quantity of pixel circuits without increasing the scale of each pixel circuit because the switch configured to switch a light emitting element, which emits light, is not required in each pixel circuit. Particularly, in the embodiment, a quantity of pixel circuits may be reduced to about one rth (one fourth in this embodiment) in comparison with the configuration in which a pixel circuit is individually provided for each of the plurality of light emitting elements. Accordingly, the scale of the gate driver 13 and a quantity of row scan lines may be reduced to about one r^{th}.

Any of the light emitting elements D1a to D4a, D1b to D4b, D1c to D4c, and D1d to D4d connected in common to the voltage control circuit 14 may be controlled to emit light at least once during a single field. Accordingly, omission of display data may be prevented.

As described above, the display apparatus 3 may obtain the same effect as that of the display apparatus 1. In the embodiment, a quantity of pixel circuits may be reduced to about one r^{th} (one fourth in this embodiment) in comparison with the configuration in which a pixel circuit is individually provided for each of the plurality of light emitting elements. Accordingly, the scale of the gate driver 13 and a quantity of row scan lines may be reduced to about one r^{th}. Further, in the display apparatus 3 according to the embodiment, the plurality of light emitting elements, which is arranged at the same row among the plurality of light emitting elements provided in the matrix, and the voltage control circuit are connected through the common power supply line. Accordingly, the wiring of the power supply line becomes linear, for example, a transverse direction (the X-axis direction), and thus the wiring of the power supply line is simplified. In addition, each light emitting element may be configured in the reverse direction as in the configuration of previously described embodiments.

In the embodiment, the configuration in which the common voltage control circuit 14 is provided for the light emitting element groups 36_1 to 36_4 divided into four columns has been described, but the configuration is not limited thereto. Therefore, the common voltage control circuit 14 may be provided for the light emitting element group 36 divided into an integer of 1 or more and n or less columns.

Further, in the embodiment, the configuration in which a quantity of light emitting elements driven by each pixel circuit 15_1 to 15_4 is four has been described as an example, but the configuration is not limited thereto. Therefore, a quantity of light emitting elements driven by each pixel circuit 15_1 to 15_4 may be an integer of 2 or more and m or less.

Further, the light emitting element group 36 composed of the light emitting elements D divided into r rows may be provided in multiples at each columns of the plurality of light emitting elements D provided in m (rows)×n (columns) matrix. Particularly, in a configuration in which m is eight and r is four, four light emitting elements D at from the first row to the fourth row of each column may form one light emitting element group 36, and four light emitting elements D at from the fifth row to the eighth row of each column may form another light emitting element group 36. In this configuration, the plurality of light emitting element group 36 provided in each column is driven by different pixel circuits 15.

Further, in the embodiment, the configuration in which the plurality of light emitting elements D is all red R light emitting elements has been described, but the configuration is not limited thereto. Therefore, the plurality of light emitting elements D may be all green G light emitting elements or all blue B light emitting elements or any color light emitting elements among three colors RGB.

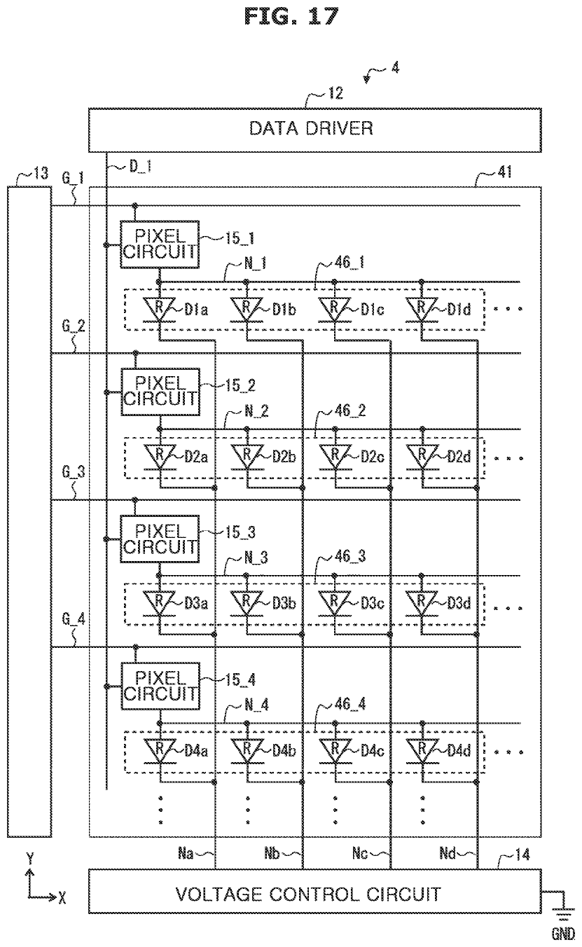

FIG. 17 is a diagram illustrating a configuration example of a display apparatus according to an embodiment of the disclosure.

In comparison with the display apparatus 1, the display apparatus 4 is provided with a panel 41 instead of the panel 11. On the panel 41, a plurality of red R light emitting elements D in m rows and n columns is provided. In addition, although not shown for clarity and understanding, the panel 41 is also provided with a plurality of green G light emitting elements D and a plurality of blue B light emitting elements D corresponding to the plurality of red R light emitting elements D. That is, on the panel 41, the light emitting elements D may be arranged in a plurality of rows and a plurality of columns. Hereinafter the plurality of red R light emitting elements D will be described unless the context clearly indicates otherwise, and a configuration, which is the same as a configuration employed for the plurality of red R light emitting elements D, may be employed for the plurality of green G light emitting elements D and the plurality of blue B light emitting elements D.

According to the embodiment, at each row of the plurality of light emitting elements D in m rows×n columns matrix, a light emitting element group 46 composed of light emitting elements D (that is, s light emitting elements D) divided into s columns (s is an integer of 2 or more and m or less) is provided. In an example of FIG. 17, at each row, the light emitting element group 46 composed of the light emitting elements D divided into four columns is provided. FIG. 17 illustrates light emitting element groups 46_1 to 46_4 divided into four rows, as a part of the plurality of light emitting element groups 46.

That is, the light emitting element group 46 may include a plurality of light emitting elements D arranged in the same row.

Particularly, the light emitting element group 46_1 is composed of four light emitting elements D1a to D1d from the first column to the fourth column of the first row. The light emitting element group 46_2 is composed of four light emitting elements D2a to D2d from the first column to the fourth column of the second row. The light emitting element group 46_3 is composed of four light emitting elements D3a to D3d from the first column to the fourth column of the third row. The light emitting element group 46_4 is composed of four light emitting elements D4a to D4d from the first column to the fourth column of the fourth row.

Further, FIG. 17 illustrates pixel circuits 15_1 to 15_4 configured to drive the light emitting element groups 46_1 to 46_4, respectively, as a part of a plurality of pixel circuits 15.

The voltage control circuit 14 is provided between the light emitting element groups 46_1 to 46_4 and a ground voltage source GND corresponding to a reference power supply. In the embodiment, a state in which the voltage control circuit 14 is commonly provided for the light emitting element groups 46_1 to 46_4 will be described as an example.

More particularly, in the light emitting elements D1a to D1d forming the light emitting element group 46_1, each anode is connected to the pixel circuit 15_1 through a node N_1, and each cathode is connected to the voltage control circuit 14 through nodes Na to Nd. In the light emitting elements D2a to D2d forming the light emitting element group 46_2, each anode is connected to the pixel circuit 15_2 through a node N_2, and each cathode is connected to the voltage control circuit 14 through the nodes Na to Nd. Further, in the light emitting elements D3a to D3d forming the light emitting element group 46_3, each anode is connected to the pixel circuit 15_3 through a node N_3, and each cathode is connected to the voltage control circuit 14 through the nodes Na to Nd. In the light emitting elements D4a to D4d forming the light emitting element group 46_4, each anode is connected to the pixel circuit 15_4 through a node N_4, and each cathode is connected to the voltage control circuit 14 through the nodes Na to Nd.

The voltage control circuit 14 is configured to selectively supply ground voltage GND to one of the nodes Na to Nd. In a state in which the ground voltage GND is selectively supplied to one of the nodes Na to Nd, the pixel circuits 15_1 to 15_4 selectively control one of the plurality of light emitting elements (four light emitting elements in the embodiment), which are provided in the light emitting element groups 46_1 to 46_4, to emit light by supplying a constant current signal of a time-division period to the nodes N_1 to N_4 according to the image signal D_1 (that is, applying a LED operation voltage of a time-division period to the nodes N_1 to N_4 according to image signals D_1 to D_4).

For example, the voltage control circuit 14 controls the light emitting elements D1a to D4a at the first column, which are provided in each of the light emitting element groups 46_1 to 46_4, to emit light by supplying the ground voltage GND to the node Na during a first sub-field period among four sub-fields forming a single field. Further, the voltage control circuit 14 controls the light emitting elements D1b to D4b at the second column, which are provided in each of the light emitting element groups 46_1 to 46_4, to emit light by supplying the ground voltage GND to the node Nb during a second sub-field period. In addition, the voltage control circuit 14 controls the light emitting elements D1c to D4c at the third column, which are provided in each of the light emitting element groups 46_1 to 46_4, to emit light by supplying the ground voltage GND to the node Nc during a third sub-field period. In addition, the voltage control circuit 14 controls the light emitting elements D1d to D4d at the fourth column, which are provided in each of the light emitting element groups 46_1 to 46_4, to emit light by supplying the ground voltage GND to the node Nd during a fourth sub-field period.

Other configurations and operations of the display apparatus 4 are the same as the display apparatus 1 and thus a redundant description thereof is omitted.

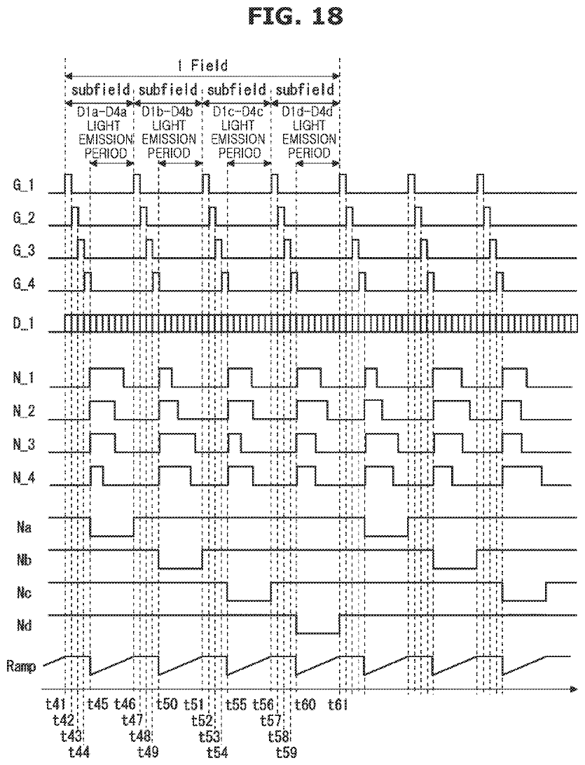

FIG. 18 is a timing chart illustrating an operation of the display apparatus 4. In an example of FIG. 18, one field is composed of four sub-fields equal to a quantity of light emitting elements provided in each light emitting element group 46_1 to 46_4. For example, time t41 to t61 in one field is composed of time t41 to t45 in a first sub-field, time t46 to t50 in a second sub-field, time t51 to t55 in a third sub-field, and time t56 to t60 in a fourth sub-field.

As the image signals D_1 to D_4 with respect to the light emitting elements D1a to D4a at the first column are sequentially output, gate control signals G_1 to G_4 are temporarily increased in sequence (time t41 to t44). Accordingly, the image signal D_1 is supplied to the pixel circuits 15_1 to 15_4 (for example, a gate of the transistor TR21 of each pixel circuit).

In response to the completion of the supply of the image signal D_1 to the pixel circuits 15_1 to 15_4 (that is, all the gate control signals G_1 to G_4 are lowered), the voltage control circuit 14 supplies the ground voltage GND to the node Na among the nodes Na to Nd (time t45 to t46).

In response to the start of the supply of the ground voltage GND to the node Na from the voltage control circuit 14, the constant current signal starts to be supplied to the nodes N_1 to N_4 from the pixel circuit 15_1 to 15_4 (time t45). The constant current signal is continuously supplied to the nodes N_1 to N_4 during the time-division period according the image signal image signal D_1 (any range in time t45 to t46). At this time, the nodes N_1 to N_4 are maintained at a level of a LED operation voltage during a period in which the constant current signal is supplied (i.e., the time-division period).

Accordingly, the light emitting elements D1a to D4a at the first column emit light during the assigned time-division period (any range in time t45 to t46).

As the image signal D_1 about the light-emitting elements D1b to D4b at the second column is sequentially output, the gate control signals G_1 to G_4 are temporarily increased in sequence (time t46 to t49). Accordingly, the image signal D_1 is supplied to the pixel circuits 15_1 to 15_4 (for example, a gate of the transistor TR21 of each pixel circuit).

In response to the completion of the supply of the image signal D_1 to the pixel circuits 15_1 to 15_4 (that is, all the gate control signals G_1 to G_4 are lowered), the voltage control circuit 14 supplies the ground voltage GND to the node Nb among the nodes Na to Nd (time t50 to t51).

In response to the start of the supply of the ground voltage GND to the node Nb from the voltage control circuit 14, the constant current signal starts to be supplied to the nodes N_1 to N_4 from the pixel circuit 15_1 to 15_4 (time t50). The constant current signal is continuously supplied to the nodes N_1 to N_4 during the time-division period according the image signal image signal D_1 (any range in time t50 to t51). At this time, the nodes N_1 to N_4 are maintained at the level of the LED operation voltage during the period in which the constant current signal is supplied (i.e., the time-division period).

Accordingly, the light emitting elements D1b to D4b at the second column emit light during the assigned time-division period (any range in time t50 to t51).

As the image signal D_1 with respect to the light emitting elements D1c to D4c at the third column is sequentially output, the gate control signals G_1 to G_4 are temporarily increased in sequence (time t51 to t54). Accordingly, the image signal D_1 is supplied to the pixel circuits 15_1 to 15_4 (for example, a gate of the transistor TR21 of each pixel circuit).

In response to the completion of the supply of the image signal D_1 to the pixel circuits 15_1 to 15_4 (that is, all the gate control signals G_1 to G_4 are lowered), the voltage control circuit 14 supplies the ground voltage GND to the node Nc among the nodes Na to Nd (time t55 to t56).

In response to the start of the supply of the ground voltage GND to the node Nc from the voltage control circuit 14, the constant current signal starts to be supplied to the nodes N_1 to N_4 from the pixel circuit 15_1 to 15_4 (time t55). The constant current signal is continuously supplied to the nodes N_1 to N_4 during the time-division period according the image signal image signal D_1 (any range in time t55 to t56). At this time, the nodes N_1 to N_4 are maintained at the level of the LED operation voltage during the period in which the constant current signal is supplied (i.e., the time-division period).

Accordingly, the light emitting elements D1c to D4c at the third column emit light during the assigned time-division period (any range in time t55 to t56).

As the image signal D_1 about the light-emitting elements D1d to D4d at the fourth column is sequentially output, the gate control signals G_1 to G_4 are temporarily increased in sequence (time t56 to t59). Accordingly, the image signal D_1 is supplied to the pixel circuits 15_1 to 15_4 (for example, a gate of the transistor TR21 of each pixel circuit).

In response to the completion of the supply of the image signal D_1 to the pixel circuits 15_1 to 15_4 (that is, all the gate control signals G_1 to G_4 are lowered), the voltage control circuit 14 supplies the ground voltage GND to the node Nd among the nodes Na to Nd (time t60 to t61).

In response to the start of the supply of the ground voltage GND to the node Nd from the voltage control circuit 14, the constant current signal starts to be supplied to the nodes N_1 to N_4 from the pixel circuit 15_1 to 15_4 (time t60). The constant current signal is continuously supplied to the nodes N_1 to N_4 during the time-division period according the image signal image signal D_1 (any range in time t60 to t61). At this time, the nodes N_1 to N_4 are maintained at the level of the LED operation voltage during the period in which the constant current signal is supplied (i.e., the time-division period).

Accordingly, the light emitting elements D1d to D4d at the fourth column emit light during the assigned time-division period (any range in time t60 to t61).

That is, in an example of FIG. 18, during the first to fourth sub fields forming the single field, the voltage control circuit 14 controls the light emitting elements D1a to D4a at the first column to emit light during the first sub-field period, controls the light emitting elements D1b to D4b at the second column to emit light during the second sub-field period, controls the light emitting elements D1c to D4c at the third column to emit light during the third sub-field period, and controls the light emitting elements D1d to D4d at the fourth column to emit light during the fourth sub-field period.

According to the embodiment, instead of the pixel circuit (for example, the pixel circuit 15_1), which is commonly provided for the plurality of light emitting elements D1a to Did, being provided with a switch configured to switch a light emitting element, which emits light, the voltage control circuit 14, which is provided on an outside of the panel 41, selectively supplies the reference voltage (ground voltage GND) to one of the plurality of light emitting elements, thereby switching a light emitting element which emits light. Accordingly, the display apparatus 4 may reduce a quantity of pixel circuits without increasing the scale of each pixel circuit because the switch configured to switch a light emitting element, which emits light, is not required in each pixel circuit. Particularly, in the embodiment, a quantity of pixel circuits may be reduced to about one s^{th} (one fourth in this embodiment) in comparison with the configuration in which a pixel circuit is individually provided for each of the plurality of light emitting elements. Accordingly, the scale of the gate driver 12 and a quantity of data lines may be reduced to about one s^{th}.

Any of the light emitting elements D1a to D4a, D1b to D4b, D1c to D4c, and D1d to D4d connected in common to the voltage control circuit 14 may be controlled to emit light at least once during a single field. Accordingly, omission of display data may be prevented.

As mentioned above, the display apparatus 4 may obtain an effect equivalent to that of the display apparatus 1. In the embodiment, a quantity of pixel circuits may be reduced to about one s^{th} (one fourth in this embodiment) in comparison with the configuration in which a pixel circuit is individually provided for each of the plurality of light emitting elements. Accordingly, the scale of the gate driver 12 and a quantity of data lines may be reduced to about one s^{th}. Further, in the display apparatus 4 according to the embodiment, the plurality of light emitting elements, which is arranged at the same column among the plurality of light emitting elements provided in the matrix, and the voltage control circuit are connected through the common power supply line. Accordingly, the wiring of the power supply line becomes linear, for example, a longitudinal direction (the Y-axis direction), and thus the wiring of the power supply line may be simplified. In addition, each light emitting element may be configured in the reverse direction as in the configuration of other aforementioned embodiments.

In the embodiment, the configuration in which the common voltage control circuit 14 is provided for the light emitting element groups 46_1 to 46_4 divided into four rows has been described, but the configuration is not limited thereto. Therefore, the common voltage control circuit 14 may be provided for the light emitting element group 46 divided into an integer 1 or more and m or less rows.

Further, in the embodiment, the configuration in which a quantity of light emitting elements driven by each pixel circuit 15_1 to 15_4 is four has been described as an example, but the configuration is not limited thereto. Therefore, a quantity of light emitting elements driven by each pixel circuit 15_1 to 15_4 may be an integer of 2 or more and n or less.

Further, the light emitting element group 46 composed of the light emitting elements D divided into s columns may be provided in plural at each rows of the plurality of light emitting elements D provided in m rows×n columns matrix. Particularly, in a configuration in which n is eight and s is four, four light emitting elements D from the first column to the fourth column of each row may form one light emitting element group 46, and four light emitting elements D from the fifth column to the eighth column of each row may form another light emitting element group 46. In this configuration, the plurality of light emitting element groups 46 provided in each rows are driven by different pixel circuits 15.

Further, in the embodiment, the configuration in which the plurality of light emitting elements D is all red R light emitting elements has been described, but the configuration is not limited thereto. Therefore, the plurality of light emitting elements D may be all green G light emitting elements or all blue B light emitting elements or any color light emitting elements among three colors RGB.

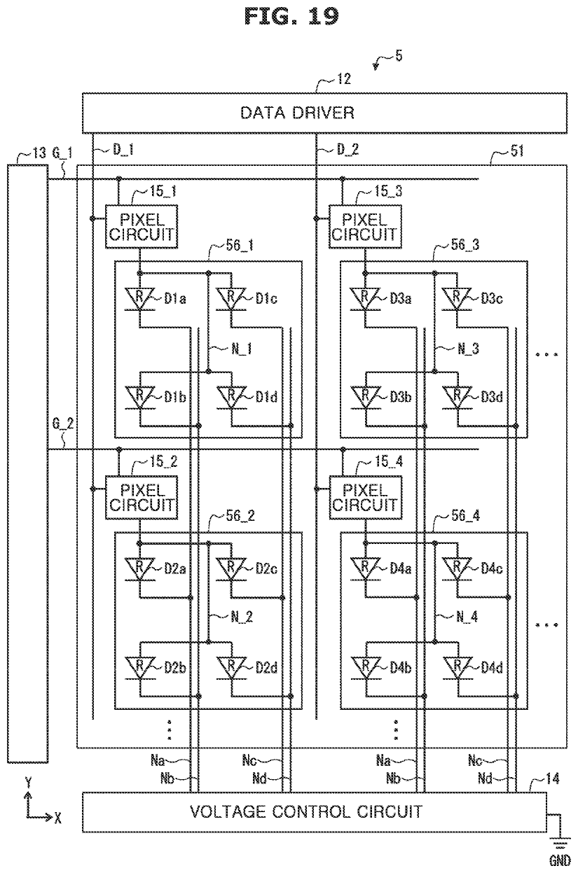

FIG. 19 is a diagram illustrating a display apparatus according to an embodiment of the disclosure.

In comparison with the display apparatus 1, the display apparatus 5 is provided with a panel 51 instead of the panel 11. On the panel 51, a plurality of red R light emitting elements D in m rows and n columns is provided. In addition, although not shown for clarity and understanding, the panel 51 is also provided with a plurality of green G light emitting elements D and a plurality of blue B light emitting elements D corresponding to the plurality of red R light emitting elements D. That is, on the panel 51, the light emitting elements D may be arranged in a plurality of rows and a plurality of columns. Hereinafter the plurality of red R light emitting elements D will be described unless the context clearly indicates otherwise, and a configuration, which is the same as a configuration employed for the plurality of red R light emitting elements D, may be employed for the plurality of green G light emitting elements D and the plurality of blue B light emitting elements D.

As for the display apparatus 5, a light emitting element group 56 composed of light emitting elements D divided into r rows by s columns of light emitting elements D (that is, r×s light emitting elements D) is provided in multiple by a plurality of light emitting elements D in m rows by n columns matrix. In an example of FIG. 19, the light emitting element group 56 composed of four light emitting elements divided into 2 rows by 2 columns is provided in multiple. FIG. 19 illustrates four light emitting element groups 56_1 to 56_4, as a part of the plurality of light emitting element groups 56.

That is, the light emitting element group 56 may include a plurality of light emitting elements D arranged in 2 or more rows and 2 or more columns.

Particularly, the light emitting element group 56_1 is composed of four light emitting elements D1a to D1d from the first column of the first and second row to the second column of the first and second row. The light emitting element group 56_2 is composed of four light emitting elements D2a to D2d from the first column of the third and fourth row to the second column of the third and fourth row. Further, the light emitting element group 56_3 is composed of four light emitting elements D3a to D3d from the third column of the first and second row to the fourth column of the first and second row. In addition, the light emitting element group 56_4 is composed of four light emitting elements D4a to D4d from the third column of the third and fourth row to the fourth column of the third and fourth row.

Further, FIG. 19 illustrates pixel circuits 15_1 to 15_4 configured to drive the light emitting element groups 56_1 to 56_4, respectively, as a part of a plurality of pixel circuits 15.

The voltage control circuit 14 is provided between the light emitting element groups 56_1 to 56_4 and a ground voltage source GND corresponding to a reference power supply. In the embodiment, a state in which the voltage control circuit 14 is commonly provided for the light emitting element groups 56_1 to 56_4 will be described as an example.

In the light emitting elements D1a to D1d forming the light emitting element group 56_1, each anode is connected to the pixel circuit 15_1 through a node N_1, and each cathode is connected to the voltage control circuit 14 through nodes Na to Nd. In the light emitting elements D2a to D2d forming the light emitting element group 56_2, each anode is connected to the pixel circuit 15_2 through a node N_2, and each cathode is connected to the voltage control circuit 14 through the nodes Na to Nd. Further, in the light emitting elements D3a to D3d forming the light emitting element group 56_3, each anode is connected to the pixel circuit 15_3 through a node N_3, and each cathode is connected to the voltage control circuit 14 through the nodes Na to Nd. In the light emitting elements D4a to D4d forming the light emitting element group 56_4, each anode is connected to the pixel circuit 15_4 through a node N_4, and each cathode is connected to the voltage control circuit 14 through the nodes Na to Nd.

The voltage control circuit 14 is configured to selectively supply ground voltage GND to one of the nodes Na to Nd. In a state in which the ground voltage GND is selectively supplied to one of the nodes Na to Nd, the pixel circuits 15_1 to 15_4 selectively allows one of the plurality of light emitting elements (four light emitting elements in the embodiment), which are provided in the light emitting element groups 56_1 to 56_4, to emit light by supplying a constant current signal of a time-division period to the nodes N_1 and N_2 according to the image signal D_1 and supplying a constant current signal of a time-division period to the nodes N_3 and N_4 according to the image signal D_2.

For example, the voltage control circuit 14 controls the light emitting elements D1a to D4a at the first row and first column of each of the light emitting element groups 56_1 to 56_4 (that is, an upper left light emitting element in each light emitting element group) to emit light by supplying the ground voltage GND to the node Na during a first sub-field period among four sub-field periods forming a single field. The voltage control circuit 14 controls the light emitting elements D1b to D4b at the second row and first column of each of the light emitting element groups 56_1 to 56_4 (that is, a lower left light emitting element in each light emitting element group) to emit light by supplying the ground voltage GND to the node Nb during a second sub-field period. The voltage control circuit 14 controls the light emitting elements D1c to D4c at the first row and second column of each of the light emitting element groups 56_1 to 56_4 (that is, an upper right light emitting element in each light emitting element group) to emit light by supplying the ground voltage GND to the node Nc during a third sub-field period. The voltage control circuit 14 controls the light emitting elements D1d to D4d at the second row and second column of each of the light emitting element groups 56_1 to 56_4 (that is, a lower right light emitting element in each light emitting element group) to emit light by supplying the ground voltage GND to the node Nd during a fourth sub-field period.

Other configurations and operations of the display apparatus 5 are the same as the display apparatus 1 and thus a redundant description thereof is omitted.

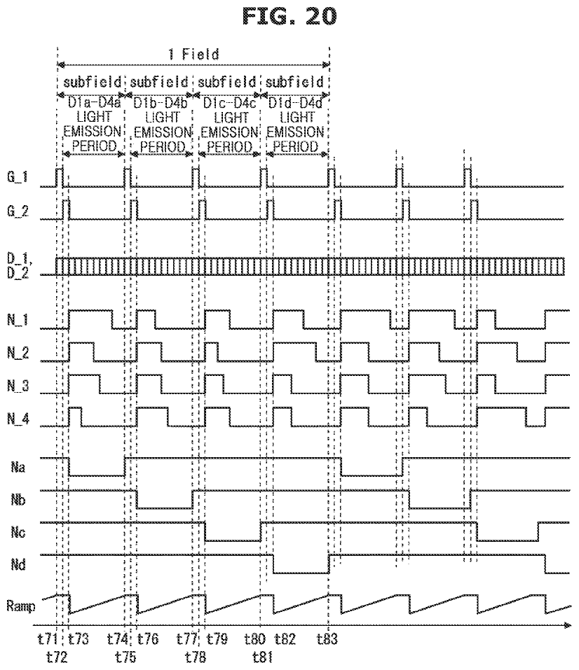

FIG. 20 is a timing chart illustrating an operation of the display apparatus 5. In an example of FIG. 20, one field is composed of four sub-fields equal to a quantity of light emitting elements provided in each light emitting element group 56_1 to 56_4. For example, time t71˜t83 in one field is composed of time t71 to t74 in a first sub-field, time t74 to t77 in a second sub-field, time t77 to t80 in a third sub-field, and time t80 to t83 in a fourth sub-field.

As the image signals D_1 and D_2 with respect to the light emitting elements D1a and D3a are output, a gate control signal G_1 temporarily increased (time t71) and as the image signals D_1 and D_2 with respect to the light emitting elements D2a and D4a are output, a gate control signal G_2 temporarily increased (time t72). Accordingly, each image signal is supplied to the pixel circuits 15_1 to 15_4 (for example, a gate of the transistor TR21 of each pixel circuit).

In response to the completion of the supply of each image signal to the pixel circuits 15_1 to 15_4 (that is, all the gate control signals G_1 to G_4 are lowered), the voltage control circuit 14 supplies the ground voltage GND to the node Na among the nodes Na to Nd (time t73 to t74).

In response to the start of the supply of the ground voltage GND to the node Na from the voltage control circuit 14, the constant current signal starts to be supplied to the nodes N_1 to N_4 from the pixel circuit 15_1 to 15_4 (time t73). The constant current signal is continuously supplied to the nodes N_1 to N_4 during the time-division period according each image signal (any range in time t73 to t74). At this time, the nodes N_1 to N_4 are maintained at a level of a LED operation voltage during a period in which the constant current signal is supplied (the time-division period).

Accordingly, the light emitting elements D1a to D4a emit light during the assigned time-division period (any range in time t73 to t74).

As the image signals D_1 and D_2 with respect to the light emitting elements D1b and D3b are output, a gate control signal G_1 temporarily increased (time t74) and as the image signals D_1 and D_2 with respect to the light emitting elements D2b and D4b are output, a gate control signal G_2 temporarily increased (time t75). Accordingly, each image signal is supplied to the pixel circuits 15_1 to 15_4 (more particularly, a gate of the transistor TR21 of each pixel circuit).

In response to the completion of the supply of each image signal to the pixel circuits 15_1 to 15_4 (that is, all the gate control signals G_1 to G_4 are lowered), the voltage control circuit 14 supplies the ground voltage GND to the node Nb among the nodes Na to Nd (time t76 to t77).

In response to the start of the supply of the ground voltage GND to the node Nb from the voltage control circuit 14, the constant current signal starts to be supplied to the nodes N_1 to N_4 from the pixel circuit 15_1 to 15_4 (time t76). The constant current signal is continuously supplied to the nodes N_1 to N_4 during the time-division period according each image signal (any range in time t76 to t77). At this time, the nodes N_1 to N_4 are maintained at the level of the LED operation voltage during the period in which the constant current signal is supplied (the time-division period).

Accordingly, the light emitting elements D1b to D4b emit light during the assigned time-division period (any range in time t76 to t77).

As the image signals D_1 and D_2 with respect to the light emitting elements D1c and D3c are output, a gate control signal G_1 temporarily increased (time t77) and as the image signals D_1 and D_2 with respect to the light emitting elements D2c and D4c are output, a gate control signal G_2 temporarily increased (time t78). Accordingly, each image signal is supplied to the pixel circuits 15_1 to 15_4 (more particularly, a gate of the transistor TR21 of each pixel circuit).

In response to the completion of the supply of each image signal to the pixel circuits 15_1 to 15_4 (that is, all the gate control signals G_1 to G_4 are lowered), the voltage control circuit 14 supplies the ground voltage GND to the node Nc among the nodes Na to Nd (time t79 to t80).

In response to the start of the supply of the ground voltage GND to the node Nc from the voltage control circuit 14, the constant current signal starts to be supplied to the nodes N_1 to N_4 from the pixel circuit 15_1 to 15_4 (time t79). The constant current signal is continuously supplied to the nodes N_1 to N_4 during the time-division period according each image signal (any range in times t79 to t80). At this time, the nodes N_1 to N_4 are maintained at the level of the LED operation voltage during the period in which the constant current signal is supplied (the time-division period).

Accordingly, the light emitting elements D1c to D4c emit light during the assigned time-division period (any range in time t79 to t80).

As the image signals D_1 and D_2 with respect to the light emitting elements D1d and D3d are output, a gate control signal G_1 temporarily increased (time t80) and as the image signals D_1 and D_2 with respect to the light emitting elements D2d and D4d are output, a gate control signal G_2 temporarily increased (time t81). Accordingly, each image signal is supplied to the pixel circuits 15_1 to 15_4 (more particularly, a gate of the transistor TR21 of each pixel circuit).

In response to the completion of the supply of each image signal to the pixel circuits 15_1 to 15_4 (that is, all the gate control signals G_1 to G_4 are lowered), the voltage control circuit 14 supplies the ground voltage GND to the node Nd among the nodes Na to Nd (time t82 to t83).

In response to the start of the supply of the ground voltage GND to the node Nd from the voltage control circuit 14, the constant current signal starts to be supplied to the nodes N_1 to N_4 from the pixel circuit 15_1 to 15_4 (time t82). The constant current signal is continuously supplied to the nodes N_1 to N_4 during the time-division period according each image signal (any range in time t82 to t83). At this time, the nodes N_1 to N_4 are maintained at the level of the LED operation voltage during the period in which the constant current signal is supplied (the time-division period).

Accordingly, the light emitting elements D1d to D4d emit light during the assigned time-division period (any range in time t82 to t83).

That is, in an example of FIG. 20, during the first to fourth sub fields forming the single field, the voltage control circuit 14 controls the light emitting elements D1a to D4a at the first row and first column (that is, an upper left side) of each of the light emitting element groups to emit light during the first sub-field period, controls the light emitting elements D1b to D4b at the second row and first column (that is, a lower left side) of each of the light emitting element groups to emit light during the second sub-field period, controls the light emitting elements D1c to D4c at the first row and second column (that is, an upper right side) of each of the light emitting element groups to emit light during the third sub-field period, and controls the light emitting elements D1d to D4d at the second row and second column (that is, a lower right side) of each of the light emitting element groups to emit light during the fourth sub-field period.

According to the embodiment, instead of the pixel circuit (for example, the pixel circuit 15_1), which is commonly provided for the plurality of light emitting elements D1a to Did, being provided with a switch configured to switch a light emitting element, which emits light, the voltage control circuit 14, which is provided on an outside of the panel 51, selectively supplies the reference voltage (ground voltage GND) to one of the plurality of light emitting elements, thereby switching a light emitting element which emits light. Accordingly, the display apparatus 5 may reduce a quantity of pixel circuits without increasing the scale of each pixel circuit because the switch configured to switch a light emitting element, which emits light, is not required in each pixel circuit.

Any of the light emitting elements D1a to D4a, D1b to D4b, D1c to D4c, and D1d to D4d connected in common to the voltage control circuit 14 may be controlled to emit light at least once during a single field. Accordingly, omission of display data may be prevented.

As described above, the display apparatus 5 may obtain an effect equivalent to that of the display apparatuses 3 and 4. In addition, each light emitting element may be configured in the reverse direction as in the configuration of other aforementioned embodiments.

In the embodiment, the configuration in which the common voltage control circuit 14 is provided for the four light emitting element groups 56_1 to 56_4 has been described, but the configuration is not limited thereto. Therefore, the common voltage control circuit 14 may be provided for any number of light emitting element group 56.

Further, in the embodiment, the configuration in which a quantity of light emitting elements driven by each pixel circuit 15_1 to 15_4 is four has been described as an example, but the configuration is not limited thereto. Therefore, a quantity of light emitting elements driven by each pixel circuit 15_1 to 15_4 may be any number.

Further, in the embodiment, the configuration in which the plurality of light emitting elements D is all red R light emitting elements has been described, but the configuration is not limited thereto. Therefore, the plurality of light emitting elements D may be all green G light emitting elements or all blue B light emitting elements or any color light emitting elements among three colors RGB.

As mentioned above, according to the first to fifth embodiments, the display apparatus includes the plurality of light emitting elements D, the pixel circuit 15 commonly provided for the plurality of light emitting elements, and the voltage control circuit 14 provided between the plurality of light emitting elements D and the reference voltage (the ground voltage GND) and configured to selectively supply the reference voltage to one of the plurality of light emitting elements D, thereby selectively allowing the corresponding one of the light emitting elements D to emit light. Accordingly, the display apparatus according to the first to fifth embodiments may reduce a quantity of pixel circuits without increasing the scale of each pixel circuit because the switch configured to switch a light emitting element, which emits light, is not required in each pixel circuit. As a result, even if the light emitting element is highly integrated, flexibility of the layout of the pixel circuit may be facilitated.

In the first to fifth embodiments, the configuration in which the voltage control circuit 14 is commonly provided for all pixel circuit in the panel 11, 21, 31, 41 or 51 has been described as an example, but the configuration is not limited thereto. For example, the voltage control circuit 14 may be provided for each one of the pixel circuits in the panel or the voltage control circuit 14 may be provided for each of the plurality of pixel circuits connected to the common data line.

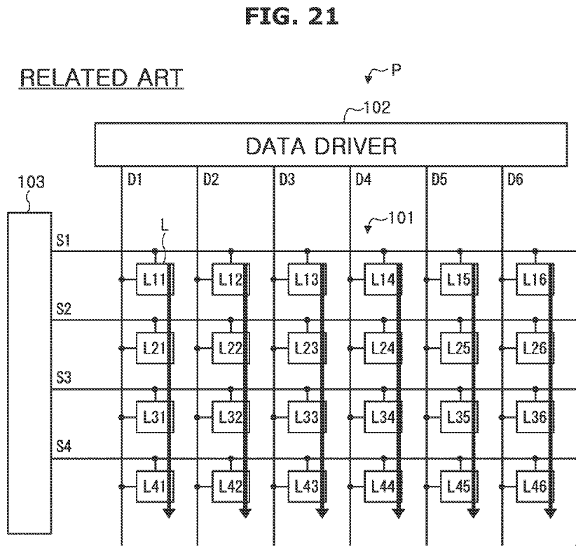

FIG. 21 is a diagram illustrating a display apparatus according to an embodiment of the disclosure. For example, the display apparatus P is a self-luminous type, such as an organic electroluminescent (EL) display or an LED display, and active matrix type display apparatus. In addition, the display apparatus P is a multi-drive type display apparatus configured to allow the plurality of pixels to sequentially emit light by sequentially supplying data to a plurality of pixels from a common data line. In addition, a configuration in which a single field is composed of four sub-fields will be described as an example.

Particularly, at least, the display apparatus P includes a panel 101, a data driver 102, and a scan driver 103.

On the panel 101, a plurality of pixels L is arranged in a matrix form. The plurality of pixels L may be arranged in a plurality of rows and a plurality of columns on the panel 101. In an example of FIG. 21, a matrix divided into four rows and six columns is illustrated. At each pixel L, one or more light emitting elements and a pixel circuit configured to drive the light emitting element are provided. That is, each of the plurality of pixels L may include at least one light emitting element. In the following description, a pixel L disposed at the i^{th} row (i is an integer of 1 or more) and j^{th} column (j is an integer of 1 or more) is referred to as Lij for convenience. For example, for convenience, a pixel L at the first row and first column is referred to as a pixel L11, and a pixel L at the first row and second column is referred to as a pixel L12.

A plurality of pixels L at each column is connected to a common data line D1 to D6. Particularly, pixels L11, L21, L31, and L41 at the first column are connected to a common data line D1. Pixels L12, L22, L32, and L42 at the second column are connected to a common data line D2. Pixels L13, L23, L33, and L43 at the third column are connected to a common data line D3. Pixels L14, L24, L34, and L44 at the fourth column are connected to a common data line D4. Pixels L15, L25, L35, and L45 at the fifth column are connected to a common data line D5. Pixels L16, L26, L36, and L46 at the sixth column are connected to a common data line D6.

Based on an instruction from a control circuit, the data driver 102 sequentially outputs an image signal with respect to a plurality of pixels L at each column in units of sub-fields.

For example, the data driver 102 sequentially outputs a plurality of image signals with respect to the four pixels L11, L21, L31, and L41 at the first column to the data line D1 during a plurality of sub-field periods (four sub-field periods in the embodiment) forming a single field. The data driver 102 sequentially outputs a plurality of image signals with respect to the four pixels L12, L22, L32, and L42 at the second column to the data line D2 during four sub-field periods forming the single field. The data driver 102 sequentially outputs a plurality of image signals with respect to the four pixels L13, L23, L33, and L43 at the third column to the data line D3 during four sub-field periods forming the single field. The data driver 102 sequentially outputs a plurality of image signals with respect to the four pixels L14, L24, L34, and L44 at the fourth column to the data line D4 during four sub-field periods forming the single field. The data driver 102 sequentially outputs a plurality of image signals with respect to the four pixels L15, L25, L35, and L45 at the fifth column to the data line D5 during four sub-field periods forming the single field. The data driver 102 sequentially outputs a plurality of image signals with respect to the four pixels L16, L26, L36, and L46 at the sixth column to the data line D6 during four sub-field periods forming the single field. Hereinafter an image signal supplied to a data line Dj may be referred to as an image signal Dj.

Based on an instruction from the control circuit, the scan driver 103 provides a control voltage (reference voltage, such as a ground voltage) to a control power line (reference power line) provided in accordance with a plurality of pixels L at each row. A pixel L, which is supplied with the control voltage through the control power line, emits light with luminance according to the image signal supplied through the data line.

For example, the scan driver 103 sequentially supplies the control voltage to a first control power line S1 connected to six pixels L11 to L16 at the first row, a second control power line S2 connected to six pixels L21 to L26 at the second row, a third control power line S3 connected to six pixels L31 to L36 at the third row, a fourth control power line S4 connected to six pixels L41 to L46 at the fourth row, a fifth control power line S5 connected to six pixels L51 to L56 at the fifth row, and a sixth control power line S6 connected to six pixels L61 to L66 at the sixth row, in the sub-field unit. Accordingly, the plurality of pixels L sequentially emits light from the first row to the fourth row during one field period. A method in which the plurality of pixels L in the matrix form is sequentially driven by row is referred to as line-sequential driving.

A configuration in which an emission frequency of the pixel (that is, a movement speed of light emission) is less than a visible speed (a speed that can be recognized by a viewer), there is a risk that an emission and non-emission boundary, which is between the plurality of pixels L at a row that emit light and the plurality of pixels L at a row that does not emit light, is recognized as non-uniform display for a viewer. In this configuration, the display quality perceived by the viewer deteriorates, as described below.

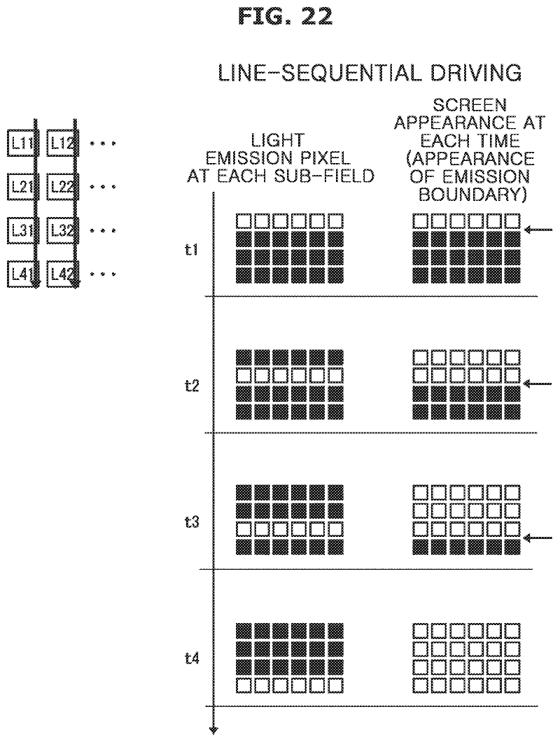

FIG. 22 is a view illustrating a driving operation of the display apparatus in FIG. 21. FIG. 22 illustrates, in a plurality of pixels L at from the first row to the fourth row and from the first column to the sixth column, a light emission pixel for each sub-field and a screen (a light emission boundary).

In the example of FIG. 22, a plurality of pixels L (pixels L11 to L16) at the first row emit light at time t1, a plurality of pixels L (pixels L21 to L26) at the second row emit light at time t2, a plurality of pixels L (pixels L31 to L36) at the third row emit light at time t3, and a plurality of pixels L (pixels L41 to L46) at the fourth row emit light at time t4. It is assumed that light emission persistence at a pixel region is visible for a viewer after light emission for at least a period of time t1 to t4 (that is, a single field period).

In a configuration in which the emission frequency of the pixel is less than a visible speed, a viewer may recognize an emission and non-emission boundary between the plurality of pixels L at the first row and the plurality of pixels L at the second row at the time t1, an emission and non-emission boundary between the plurality of pixels L at the second row and the plurality of pixels L at the third row at the time t2, and an emission and non-emission boundary between the plurality of pixels L at the third row and the plurality of pixels L at the fourth row at the time t3, as the non-uniform display. In this configuration, the display quality deteriorates.

In addition, if a movement direction and speed of the light emission coincides with a movement direction and speed of viewer gaze in the line-sequential driving method, such as the display apparatus P, pixel light emission at the sub-field which is visually recognized, and pixel light emission persistence at the successive and previous sub-field of the sub-field that is visible are overlapped. Therefore, the light emission luminance of the emission pixels visually recognized by a viewer may be increased up to several times more than the typical number of sequential emission (that is, a quantity of sub-field forming a single field) and accordingly, the display quality deteriorates, as described below.

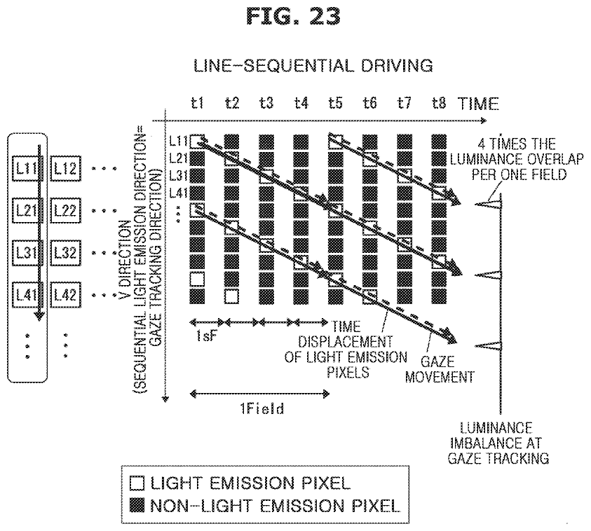

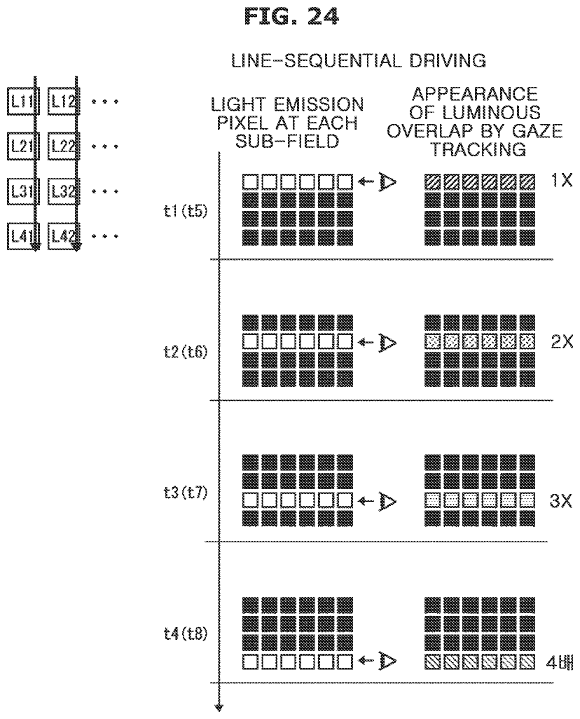

FIGS. 23 and 24 are views illustrating a second operation of the display apparatus P. FIGS. 23 and 24 illustrate an example in which a movement direction of viewer gaze is a vertical direction (V direction and a vertical direction of the paper). Further, as described above, it is assumed that a single field is composed of four subfields.

FIG. 23 representatively illustrates, in a plurality of pixels L (pixels L11, L21, L31, . . . ) at the first column, a light-emitting pixel for each sub-field and emission luminance of the light-emitting pixel visually recognized by a viewer. FIG. 24 illustrates, in a plurality of pixels L at from the first row to the fourth row and from the first column to the sixth column, a light-emitting pixel for each sub-field and emission luminance (luminance overlap) of the light-emitting pixel visually recognized by a viewer.

As shown in FIG. 23, as for the plurality of pixels L at the first column, the pixels L11, L21, L31, and L41 sequentially emit light at time t1 to t4. Thereafter, at time t5 to t8, the pixels L51, L61, L71, and L81 sequentially emit light while the pixels L11, L21, L31, and L41 sequentially emit light again.

That is, when the plurality of pixels L at each column are viewed in a horizontal direction (H direction, and a horizontal direction of the paper), the movement speed of light emission is always constant during one field period.

Further, as shown in FIG. 24, as for the plurality of pixels L at from the first row to the fourth row and from the first column to the sixth column, at time t1 to t4, the pixels L11 to L16 at the first row, the pixels L21 to L26 at the second row, the pixels L31 to L36 at the third row and the pixels L41 to L46 at the fourth row sequentially emit light in row units. Similarly, at time t5 to t8, the pixels L11 to L16 at the first row, the pixels L21 to L26 at the second row, the pixels L31 to L36 at the third row and the pixels L41 to L46 at the fourth row sequentially emit light in row units.

For example, at time t1 to t4, when the viewer's gaze is sequentially moved from the plurality of pixels L at the first row to the plurality of pixels L at the fourth row, the movement direction and speed of the light emission and the movement direction and speed of viewer gaze coincide with each other. Accordingly, the light emission of the plurality of pixels L at the fourth row at the time t4 and the light emission persistence of plurality of pixels L at from the first row to the third row at the previous time t1 to t3 are overlapped. Therefore, the light emission luminance of the light-emitting pixels (the plurality of pixels L at the fourth row) visually recognized by a viewer may be increased up to four times more than the typical configuration.

Further, at time t5 to t8, when the viewer's gaze is sequentially moved from the plurality of pixels L at the first row to the plurality of pixels L at the fourth row, the movement direction and speed of the light emission and the movement direction and speed of viewer gaze coincide with each other. Accordingly, the light emission of the plurality of pixels L at the first row at the time t8 and the light emission persistence of plurality of pixels L at from the first row to the third row at the previous time t5 to t8 are overlapped. Therefore, the light emission luminance of the light-emitting pixels (the plurality of pixels L at the fourth row) visually recognized by a viewer may be increased up to four times more than the typical configuration.

Similarly, at time t5 to t8, when the viewer's gaze is sequentially moved from the plurality of pixels L at the fifth row to the plurality of pixels L at the eighth row, the movement direction and speed of the light emission and the movement direction and speed of viewer gaze coincide with each other. Accordingly, the light emission of the plurality of pixels L at the eighth row at the time t8 and the light emission persistence of plurality of pixels L at from the fifth row to the seventh row at the previous time t5 to t7 are overlapped. Therefore, the light emission luminance of the light-emitting pixels (the plurality of pixels L at the eighth row) visually recognized by a viewer may be increased up to four times more than the typical configuration.

For example, when an image display object, such as a ball, moves on the screen, there is a possibility that the viewer's gaze unconsciously follows the object. In this configuration, if a movement direction and speed of the image display object and a movement direction and speed of light emission coincide with each other, the movement direction and speed of the light emission the movement direction and speed of viewer gaze coincide with each other, and thus the above-described luminance overlap occurs. Such luminance overlap may be recognized as the non-uniform display (luminance imbalance: mura) by a viewer, and thus the display quality deteriorates.

Therefore, the display apparatus 6 according to the embodiment capable of improving display quality while suppressing wiring congestion would be desirable, as described below.

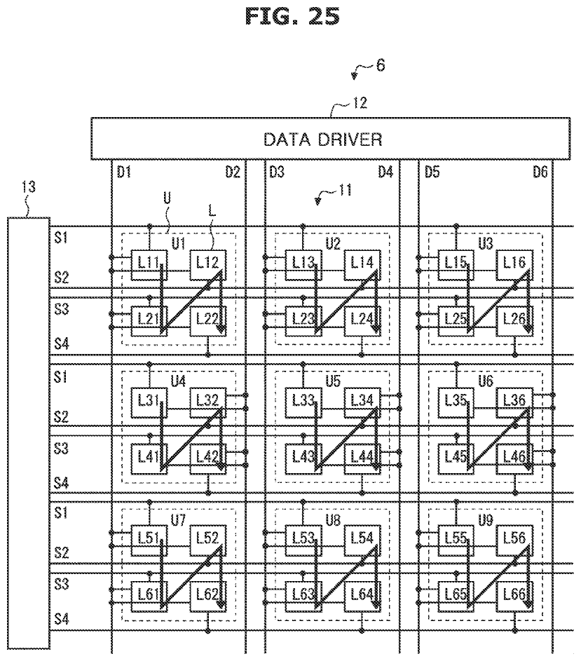

FIG. 25 is a diagram illustrating a display apparatus according to an embodiment of the disclosure. For example, the display apparatus 6 is a self-luminous display apparatus, such as an organic electroluminescent (EL) display or a light emitting diode (LED) display, and an active matrix type display apparatus.

In addition, the display apparatus 6 may employ an inorganic light emitting element, such as a light emitting diode (LED), as a light emitting element disposed in each pixel. The inorganic light emitting element may have a fast reaction speed and realize high luminance with low power in comparison with an organic light emitting element, such as an organic light emitting diode (OLED). The inorganic light emitting element employed in the display apparatus 1 may be a micro LED having a short side length of about 100 μm.

In addition, the display apparatus 6 is a multi-drive type display apparatus configured to allow the plurality of pixels to sequentially emit light by sequentially supplying data to a plurality of pixels from a common data line. A configuration in which a single field is composed of four sub-fields will be described as an example

Particularly, at least, the display apparatus 6 includes a panel 11, a data driver 12, and a scan driver 13. The data driver 12 and the scan driver 13 may also be referred to as a control circuit.

On the panel 11, a plurality of pixels L is arranged in a matrix form. That is, the plurality of pixels L may be arranged in a plurality of rows and a plurality of columns on the panel 11. In an example of FIG. 25, a matrix divided into six rows and six columns is illustrated. In the following description, a pixel L disposed at the j^{th} row (j is an integer of 1 or more) and i^{th} column (i is an integer of 1 or more) is referred to as Lij for convenience. For example, for convenience, a pixel L at the first row and first column is referred to as a pixel L11, and a pixel L at the first row and second column is referred to as a pixel L12. In this configuration, each of the plurality of pixels L may include at least one light emitting element.

The plurality of pixels L provided on the panel 11 is composed of a plurality of pixel units U composed of pixels L in M rows (M is an integer of 2 or more) by N columns (N is an integer of 2 or more). That is, each of the plurality of pixel units U may include pixels L to be arranged in two or more rows and two or more columns. In this configuration, the pixel unit U may correspond to the light emitting element group described with respect to FIGS. 1 and 19, for example. That is, the light emitting element groups may correspond to the pixel unit U described below and the light emitting element groups may include pixels L arranged in two or more rows and two or more columns. In other words, the light emitting element group may include a plurality of light emitting elements forming pixels L arranged in two or more rows and two or more columns.

In an example of FIG. 25, M is set to 2 and N is set to 2. That is, in the example of FIG. 25, one pixel unit U is formed by a total of four pixels L in a matrix of two rows by two columns. That is, the light emitting element group may be composed of pixels L arranged in two rows and two columns.

More particularly, one pixel unit U (hereinafter U1) is composed of four pixels L11, L12, L21, and L22. One pixel unit U (hereinafter U2) is composed of the four pixels L13, L14, L23, and L24. One pixel unit U (hereinafter U3) is composed of four pixels L15, L16, L25, and L26. One pixel unit U (hereinafter U4) is composed of four pixels L31, L32, L41, and L42. One pixel unit U (hereinafter U5) is composed of four pixels L33, L34, L43, and L44. One pixel unit U (hereinafter U6) is composed of four pixels L35, L36, L45, and L46. One pixel unit U (hereinafter U7) is composed of four pixels L51, L52, L61, and L62. One pixel unit U (hereinafter U8) is composed of four pixels L53, L54, L63, and L64. One pixel unit U (hereinafter U9) is composed of four pixels L55, L56, L65, and L66.

A plurality of pixels (four pixels in the embodiment) forming each pixel unit U is connected to a common data line D1 to D6. Particularly, the four pixels L11, L12, L21, and L22 forming the pixel unit U1 are connected to the common data line D1. The four pixels L13, L14, L23, and L24 forming the pixel unit U2 are connected to a common data line D3. The four pixels L15, L16, L25, and L26 forming the pixel unit U3 are connected to a common data line D5. The four pixels L31, L32, L41, and L42 forming the pixel unit U4 are connected to a common data line D2. The four pixels L33, L34, L43, and L44 forming the pixel unit U5 are connected to a common data line D4. The four pixels L35, L36, L45, and L46 forming the pixel unit U6 are connected to a common data line D6. The four pixels L51, L52, L61, and L62 forming the pixel unit U7 are connected to the common data line D1. The four pixels L53, L54, L63, and L64 forming the pixel unit U8 are connected to the common data line D3. The four pixels L55, L56, L65, and L66 forming the pixel unit U9 are connected to the common data line D5.

Based on an instruction from a control circuit, the data driver 12 sequentially outputs image signals with respect to the plurality of pixels L forming each pixel unit U in units of sub-fields

For example, the data driver 12 sequentially outputs a plurality of image signals with respect to the four pixels L11, L12, L21, and L22 forming the pixel unit U1 to the data line D1 during a plurality of sub-field periods (four sub-field periods in the embodiment) forming a single field. The data driver 12 sequentially outputs a plurality of image signals with respect to the four pixels L13, L14, L23, and L24 forming the pixel unit U2 to the data line D3 during four sub-field periods forming the single field. The data driver 12 sequentially outputs a plurality of image signals with respect to the four pixels L15, L16, L25, and L26 forming the pixel unit U3 to the data line D5 during four sub-field periods forming the single field. The data driver 12 sequentially outputs a plurality of image signals with respect to the four pixels L31, L32, L41, and L42 forming the pixel unit U4 to the data line D2 during four sub-field periods forming the single field. The data driver 12 sequentially outputs a plurality of image signals with respect to the four pixels L33, L34, L43, and L44 forming the pixel unit U5 to the data line D4 during four sub-field periods forming the single field. The data driver 12 sequentially outputs a plurality of image signals with respect to the four pixels L35, L36, L45, and L46 forming the pixel unit U6 to the data line D6 during four sub-field periods forming the single field. The data driver 12 sequentially outputs a plurality of image signals with respect to the four pixels L51, L52, L61, and L62 forming the pixel unit U7 to the data line D1 during four sub-field periods forming the single field. The data driver 12 sequentially outputs a plurality of image signals with respect to the four pixels L53, L54, L63, and L64 forming the pixel unit U8 to the data line D3 during four sub-field periods forming the single field. The data driver 12 sequentially outputs a plurality of image signals with respect to the four pixels L55, L56, L65, and L66 forming the pixel unit U9 to the data line D5 during four sub-field periods forming the single field. Hereinafter an image signal supplied to a data line Dj may be referred to as an image signal Dj.

Based on an instruction from the control circuit, the scan driver 13 supplies a control voltage (reference voltage, such as a ground voltage) to a control power line (reference power line) provided in accordance with each of the plurality of pixels L forming each pixel unit U. A pixel L, which is supplied with the control voltage through the control power line, emits light with luminance according to the image signal supplied through the data line.

Particularly, a control power line S1 is wired to a pixel at the first row and first column (an upper left pixel L; particularly, the pixels L11, L13, L15, L31, L33, L35, L51, L53, and L55) among four pixels L forming each pixel unit U. A control power line S2 is wired to a pixel at the first row and second column (an upper right pixel L; particularly, the pixels L12, L14, L16, L32, L34, L36, L52, L54, and L56) among four pixels L forming each pixel unit U. A control power line S3 is wired to a pixel at the second row and first column (a lower left pixel L; particularly, the pixels L21, L23, L25, L41, L43, L45, L61, L63, and L65) among four pixels L forming each pixel unit U. A control power line S4 is wired to a pixel at the second row and second column (a lower right pixel L; particularly, the pixels L22, L24, L26, L42, L44, L46, L62, L64, and L66) among four pixels L forming each pixel unit U.

Through the control power lines S1, S3, S2, and S4, the scan driver 13 sequentially supplies the control voltage in units of subfields. Accordingly, the four pixels L forming each pixel unit U emit light in the same light emission sequence as the other pixel units U during one field period. In the example of FIG. 25, the four pixels L forming each pixel unit U emit light such that an upper left pixel, a lower left pixel, an upper right pixel and a lower right pixel sequentially emits light.

In contrast, the scan driver 13 may transmit a gate control signal to a pixel circuit corresponding to each pixel unit U, and a voltage control circuit 14, which is described in the aforementioned embodiments, may be provided between the plurality of light emitting elements included in each pixel unit U and a power supply.

Particularly, the voltage control circuit 14 described in the aforementioned embodiments may be provided between each of the plurality of light emitting elements forming the pixel unit (light emitting element group) U and the power supply. The voltage control circuit 14 may sequentially transmit a reference voltage to each of the plurality of light emitting elements. For example, the voltage control circuit 14 sequentially transmits a reference voltage to each of the plurality of light emitting elements in units of subfields, and thus the light emitting elements sequentially emit light with luminance according to each image signal D1. That is, the voltage control circuit 14 may allow the pixel L, which emits light in the pixel unit (light emitting element group) U, to be changed according to the plurality of sub-fields.

In this configuration, the voltage control circuit 14 may control the pixels L of the first light emitting element group among the plurality of light emitting element groups to emit light in a predetermined sequence (an upper left pixel, a lower left pixel, an upper right pixel and a lower right pixel in order), and at the same time, the voltage control circuit 14 may control each pixel L of other light emitting element group other than the first light emitting element group among the plurality of light emitting element groups to emit light in the same sequence as the predetermined sequence (an upper left pixel, a lower left pixel, an upper right pixel and a lower right pixel in order). Accordingly, the four pixels L forming each pixel unit U emit light in the same light emission sequence (an upper left pixel, a lower left pixel, an upper right pixel and a lower right pixel in order) as the other pixel units U during one field period.

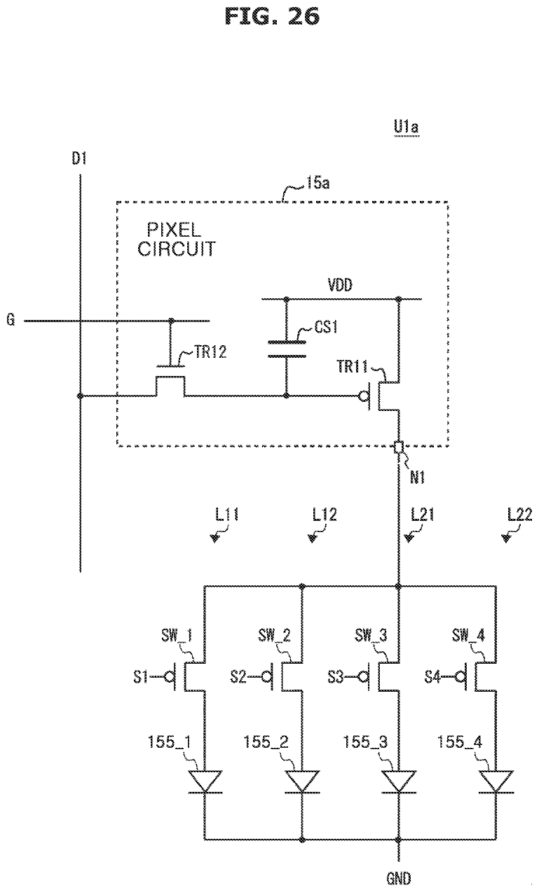

Hereinafter specific configuration examples of each pixel unit U will be described with reference to FIGS. 26, 27, 28, and 29. Hereinafter as a representative example, a specific configuration example of the pixel unit U1 is described, but the other pixel units U also include the same configuration as in the configuration of the pixel unit U1.

FIG. 26 is a diagram illustrating a pixel unit U1 as a pixel unit U1a. The pixel unit U1a employs Pulse Amplitude Modulation (PAM) and a pixel driving method, such as a switch control method.

The pixel unit U1a includes four pixels L11, L12, L21, and L22. In addition, the pixel unit U1a includes switch elements SW_1 to SW_4. For example, each of the switch elements SW_1 to SW_4 is a P-channel MOS transistor.

In FIG. 26, the pixel L11 is composed of one light emitting diode (hereinafter referred to as a light emitting element 155_1) and a pixel circuit 15a configured to drive the light emitting element 155_1. The pixel L12 is composed of one light emitting diode (hereinafter referred to as a light emitting element 155_2) and the pixel circuit 15a configured to drive the light emitting element 155_2. The pixel L21 is composed of one light emitting diode (hereinafter referred to as a light emitting element 155_3) and the pixel circuit 15a configured to drive the light emitting element 155_3. The pixel L22 is composed of one light emitting diode (hereinafter referred to as a light emitting element 155_4) and the pixel circuit 15a configured to drive the light emitting element 155_4. In the example of FIG. 26, the pixel circuit 15a is shared by the four pixels L11, L12, L21, and L22.

An anode of the light emitting element 155_1 is connected to a node N1, which is an output node of the pixel circuit 15a, through the switch element SW_1. An anode of the light emitting element 155_2 is connected to the node N1 through the switch element SW_2. An anode of the light emitting element 155_3 is connected to the node N1 through the switch element SW_3. An anode of the light emitting element 155_4 is connected to the node N1 through the switch element SW_4. Each cathode of the light emitting elements 155_1 to 155_4 is connected to a ground voltage GND.

The switch elements SW_1 to SW_4 are provided between the light emitting elements 155_1 to 155_4 and the node N1, which is an output node of the pixel circuit 15a, respectively, and the switch elements SW_1 to SW_4 control on-off states according to the control voltage of the control power lines S1 to S4 (hereinafter referred to as control voltages S1 to S4).

The pixel circuit 15a includes a drive transistor TR11, a switch transistor TR12, and a capacitor CS1.

In the embodiment, a configuration in which the drive transistor TR11 is a P-channel MOS transistor and the switch transistor TR12 is an N-channel MOS transistor is described as an example, but the configuration is not limited thereto. Alternatively, the drive transistor TR11 may be an N-channel MOS transistor, and the switch transistor TR12 may be a P-channel MOS transistor. However, in this configuration, a voltage applied to a gate of each transistor is reversed.

The drive transistor TR11 is provided between a power supply voltage source VDD and the node N_1 that is an output node of the pixel circuit 15a.

The switch transistor TR12 is provided between the data line D1 and a gate of the drive transistor TR11, and the switch transistor TR12 switches on-off states based on a gate control signal G of a gate driver. Further, the capacitor CS1 is provided between the gate and a source of the drive transistor TR11.

For example, in response to the switch transistor TR12 that is temporarily turned on by a high H level of a pulse wave of the gate control signal G, the image signal (that is, the image signal D1) applied through the data line D1 is applied to the gate of the drive transistor TR11 through the switch transistor TR12. That is, a voltage level of the image signal D1 applied to the gate of the drive transistor TR11 is maintained by the capacitor CS1 until the gate control signal G is increased. That is, the voltage level of the image signal D1 applied to the gate of the drive transistor TR11 is maintained for a sub-field period that is divided by the pulse wave of the gate control signal G1. During the sub-field period, a current signal having a current value according to the image signal D1 is continuously supplied to the node N1. Therefore, the node N1 is maintained at the voltage value according to the current signal.

For example, by sequentially turning on the switch elements SW_1, SW_3, SW_2, and SW_4 in units of subfields, the light emitting elements 155_1, 155_3, 155_2, and 155_4 sequentially emit light with luminance according to each image signal D1.

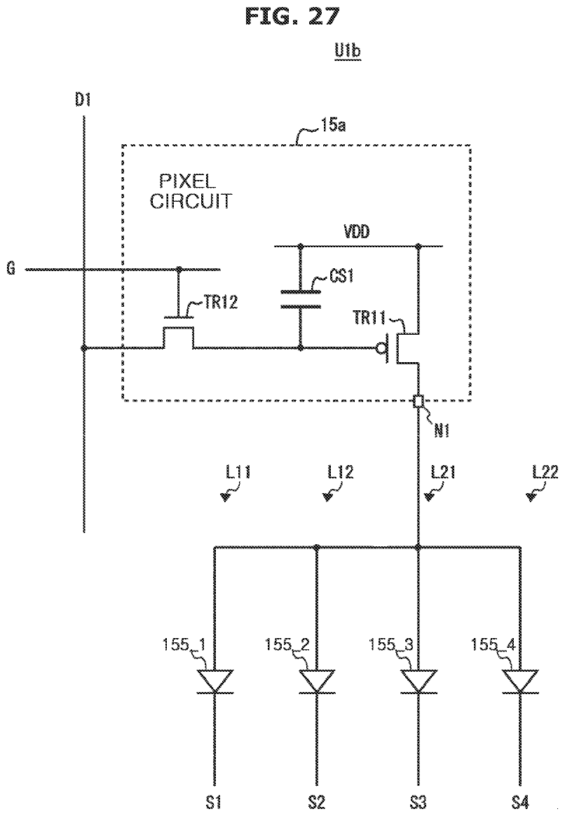

FIG. 27 is a diagram illustrating a pixel unit U1 as a pixel unit U1b. The pixel unit U1b employs a Pulse Amplitude Modulation (PAM) method and a pixel driving method such as a cathode pulse control method.

The pixel unit U1b includes four pixels L11, L12, L21, and L22. In addition, the pixel unit U1b is not provided with switch elements SW_1 to SW_4.

An anode of each of the light emitting elements 155_1 to 155_4 is connected to a node N1 that is an output node of the pixel circuit 15a. A cathode of the light emitting element 155_1 is connected to the control power line S1. A cathode of the light emitting element 155_2 is connected to the control power line S2. A cathode of the light emitting element 155_3 is connected to the control power line S3. A cathode of the light emitting element 155_4 is connected to the control power line S4.

A configuration of the pixel circuit 15a in FIG. 27 is the same as the above mentioned-description with respect to FIG. 26. For example, in response to the switch transistor TR12 that is temporarily turned on by a high H level of a pulse wave of the gate control signal G, the image signal (that is, the image signal D1) applied through the data line D1 is applied to the gate of the drive transistor TR11 through the switch transistor TR12. That is, a voltage level of the image signal D1 applied to the gate of the drive transistor TR11 is maintained by the capacitor CS1 until the gate control signal G is increased. That is, the voltage level of the image signal D1 applied to the gate of the drive transistor TR11 is maintained for a sub-field period that is divided by the pulse wave of the gate control signal G1. During the sub-field period, a current signal having a current value according to the image signal D1 is continuously supplied to the node N1. Therefore, the node N1 is maintained at the voltage value according to the current signal.

For example, as each cathode of the light emitting elements 155_1, 155_3, 155_2, and 155_4 is temporarily and sequentially at the low L level in units of subfields, the light emitting elements 155_1, 155_3, 155_2, and 155_4 emit light in sequence with the luminance according to the image signal D1.

Further, in a configuration in which the scan driver 13 transmits a gate control signal to the pixel circuit 15b corresponding to each pixel unit U1b, and a voltage control circuit 14, which is described with respect to FIGS. 1 to 20, is provided between the plurality of light emitting elements 155_1 to 155_4 included in each pixel unit U1b and a power supply, the voltage control circuit 14 may sequentially transmit a reference voltage to each of the plurality of light emitting elements 155_1 to 155_4. For example, the voltage control circuit 14 sequentially transmits the reference voltage to each of the plurality of light emitting elements 155_1 to 155_4 in units of subfields, and thus the light emitting elements 155_1 to 155_4 sequentially emit light with luminance according to each image signal D1.

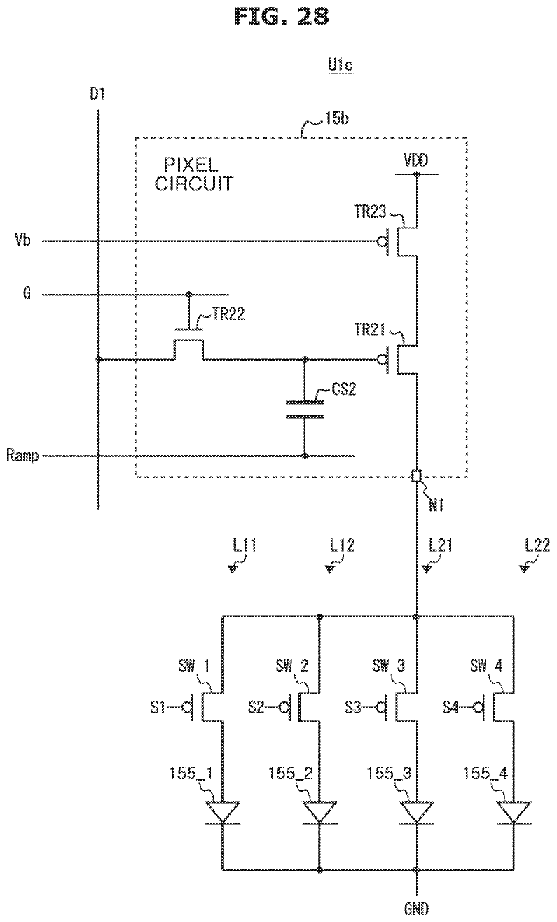

FIG. 28 is a diagram illustrating the pixel unit U1 as a pixel unit U1c. The pixel unit U1c employs Pulse Width Modulation (PWM) and a pixel driving method, such as a switch control method.

The pixel unit U1c includes four pixels L11, L12, L21, and L22. In addition, the pixel unit U1c includes switch elements SW_1 to SW_4. For example, each of the switch elements SW_1 to SW_4 is a P-channel MOS transistor.

In an example of FIG. 28, the pixel L11 is composed of one light emitting element 155_1 and a pixel circuit 15b configured to drive the light emitting element 155_1. The pixel L12 is composed of one light emitting element 155_2 and the pixel circuit 15b configured to drive the light emitting element 155_2. The pixel L21 is composed of one light emitting element 155_3 and the pixel circuit 15b configured to drive the light emitting element 155_3. The pixel L22 is composed of one light emitting element 155_4 and the pixel circuit 15b configured to drive the light emitting element 155_4. In the example of FIG. 28, the pixel circuit 15a is shared by the four pixels L11, L12, L21, and L22.

An anode of the light emitting element 155_1 is connected to a node N1, which is an output node of the pixel circuit 15b, through the switch element SW_1. An anode of the light emitting element 155_2 is connected to the node N1 through the switch element SW_2. An anode of the light emitting element 155_3 is connected to the node N1 through the switch element SW_3. An anode of the light emitting element 155_4 is connected to the node N1 through the switch element SW_4. Each cathode of the light emitting elements 155_1 to 155_4 is connected to a ground voltage GND.

The switch elements SW_1 to SW_4 are provided between the light emitting elements 155_1 to 155_4 and the node N1, which is an output node of the pixel circuit 15b, respectively, and the switch elements SW_1 to SW_4 controls on-off states according to the control voltage S1 to S4.

The pixel circuit 15b includes transistors TR21, TR22, and TR23, and a capacitor CS2.

In the embodiment, a configuration in which the transistors TR21, and TR23 are a P-channel MOS transistor and the transistor TR22 is an N-channel MOS transistor is described as an example, but the configuration is not limited thereto. Alternatively, the transistors TR21, and TR23 may be an N-channel MOS transistor, and the transistor TR22 may be a P-channel MOS transistor. However, in this configuration, a voltage applied to a gate of each transistor is reversed.

The transistors TR23 and TR21 are provided in series between a power supply voltage source VDD and the node N1 that is an output node of the pixel circuit 15a. A bias voltage Vb is applied to a gate of the transistor TR23. Therefore, the transistor TR23 is operated as a constant current source.

The transistor TR22 is provided between the data line D1 and the gate of the transistor TR21, and the transistor TR22 switches on-off states based on a gate control signal G of the gate driver. Further, one end of the capacitor CS2 is connected to the gate of the transistor TR21, and a ramp signal is applied to the other end of the capacitor CS2. The ramp signal is a signal in which a voltage is increased at a predetermined slew rate.

For example, in response to the transistor TR22 that is temporarily turned on by a high H level of a pulse wave of the gate control signal G1, an image signal (that is, an image signal D1) transmitted through the data line D1 is applied to the gate of the transistor TR21. At this time, the transistor TR21 is turned off because a gate-source voltage of the transistor TR21 is pre-set to be less than or equal to a threshold voltage of the corresponding transistor TR21. Therefore, a constant current is not supplied to the node N1 from the pixel circuit 15b.

In response to the transistor TR22 that is turned off as a high H level of a pulse wave of the gate control signal G is lowered (switched to a low L level), a voltage of the ramp signal is initialized as a lowest voltage 0V (zero V), and then slowly increased. Accordingly, a gate voltage of the transistor TR21 is lowered once and then starts to slowly increase.

When the ramp signal is initialized and the gate voltage of the transistor TR21 is lowered, the gate-source voltage of the transistor TR21 becomes greater than the threshold voltage and thus the transistor TR21 is turned on. At this time, a constant current generated by the transistor TR23 is supplied to the node N1.

When the gate voltage of the transistor TR21 is slowly increased and then the gate-source voltage of the transistor TR21 becomes less than or equal to the threshold vale of the corresponding transistor TR21, the transistor TR21 is turned off. The node N1 is maintained at a predetermined voltage during an on-period of the transistor TR21. The on-period of the transistor TR21 depends on the image signal D1. Therefore, a constant current is supplied to the node N1 during a time-division period according to the image signal D1. Accordingly, in the pixel circuit 15b, a gradation of the image signal D1 is represented by time-division driving.

The pixel circuit 15b employing PWM shown in FIG. 28 is used as the constant current source and thus luminance efficiency or chromaticity of a diode element that is easily changed by a current density may be stabilized.

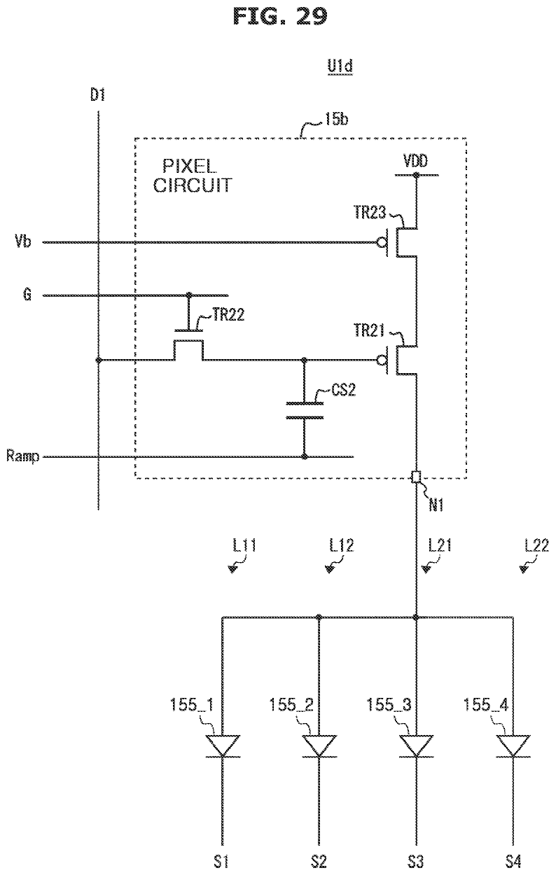

FIG. 29 is a diagram illustrating a pixel unit U1 as a pixel unit U1d. The pixel unit U1d employs Pulse Width Modulation (PWM) and a pixel driving method, such as a cathode pulse control method.

The pixel unit U1d includes four pixels L11, L12, L21, and L22. In addition, switch elements SW_1 to SW_4 are not provided in the pixel unit U1d.

An anode of each of the light emitting elements 155_1 to 155_4 is connected to a node N1 that is an output node of the pixel circuit 15b. A cathode of the light emitting element 155_1 is connected to the control power line S1. A cathode of the light emitting element 155_2 is connected to the control power line S2. A cathode of the light emitting element 155_3 is connected to the control power line S3. A cathode of the light emitting element 155_4 is connected to the control power line S4.

In addition, in a configuration in which the scan driver 13 transmits a gate control signal to the pixel circuit 15b corresponding to each pixel unit U1d, and a voltage control circuit 14, which is described with respect to FIGS. 1 to 20, is provided between the plurality of light emitting elements 155_1 to 155_4 included in each pixel unit U1d and a power supply, the voltage control circuit 14 may sequentially transmit a reference voltage to each of the plurality of light emitting elements 155_1 to 155_4. For example, the voltage control circuit 14 sequentially transmits the reference voltage to each of the plurality of light emitting elements 155_1 to 155_4 in units of subfields, and thus the light emitting elements 155_1 to 155_4 sequentially emit light with luminance according to each image signal D1.

A configuration of the pixel circuit 15b in FIG. 29 is the same as the above mentioned-descriptions of FIGS. 26 to 28.

Further, the configuration of the pixel unit U is not limited to the above-described specific configurations, and thus the configuration may be appropriately changed to implement equivalent functions. Further, the pixel circuits 15a and 15b may include a deviation correction function.

As described above, the pixel unit U may be described as including the pixel circuit 15a (or 15b). However, the pixel circuit 15a (or 15b) may be provided separately from the pixel unit U, and in this configuration, the pixel unit U may be composed of only the plurality of light emitting elements, and the pixel unit U may receive the image signal from the pixel circuit 15a (or 15b).

Further, in the above description, the configuration in which the common pixel circuit 15a (or 15b) is provided for the light emitting elements of the plurality of pixels L forming the pixel unit U has been described as an example, but the configuration is not limited thereto. Therefore, an individual pixel circuit may be provided in each of the plurality of pixels L forming the pixel unit U.

Hereinafter in the embodiment, a configuration in which the PWM method and the pixel driving method such as the switch control method as shown in FIG. 28 is applied to each pixel unit U will be described as an example.

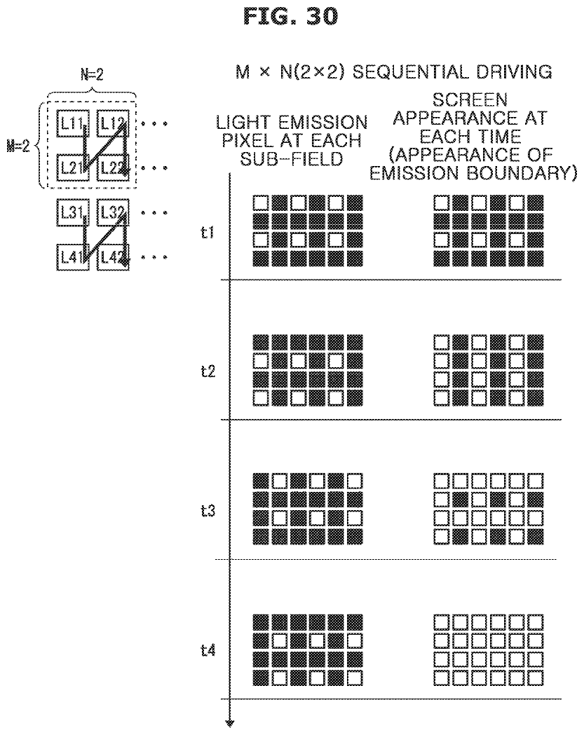

FIG. 30 is a diagram illustrating a driving operation of the display apparatus. FIG. 30 illustrates in a plurality of pixels L from the first row to the fourth row and from the first column to the sixth column, a light emission pixel for each sub-field and a screen (a light emission boundary) of a viewer.

In an example of FIG. 30, a pixel L at the first row and first column of each pixel unit U (an upper left pixel L; particularly, the pixels L11, L13, L15, L31, L33, and L35) emits light at the time t1, a pixel L at the second row and first column of each pixel unit U (a lower left pixel L; particularly, the pixels L21, L23, L25, L41, L43, and L45) emits light at the time t2, a pixel L at the first row and second column of each pixel unit U (an upper right pixel L; particularly, the pixels L12, L14, L16, L32, L34, and L36) emits light at the time t3, and a pixel L at the second row and second column of each pixel unit U (a lower right pixel L; particularly, the pixels L22, L24, L26, L42, L44, and L46) emits light at the time t4. A viewer visually recognizes light emission persistence at a pixel region after the pixel emission during at least one period, for example at least one period of t1 to t4.

Unlike the display apparatus P, light-emitting pixels at each sub-field are not concentrated in one row but dispersed according to the display apparatus 6. Therefore, in the display apparatus, even when the emission frequency (that is, a movement speed of light emission) of the pixel is less than the visible speed (a speed that can be recognized by the viewer), it becomes difficult to visually recognize an emission and non-emission boundary, and thus the deterioration of display quality may be prevented. In this configuration, the display apparatus does not require complicated wiring unlike the configuration of the related art. That is, the display apparatus may improve display quality while suppressing wiring congestion. In addition, in the display apparatus, the light emission sequence of the pixels may be easily changed even after being manufactured.

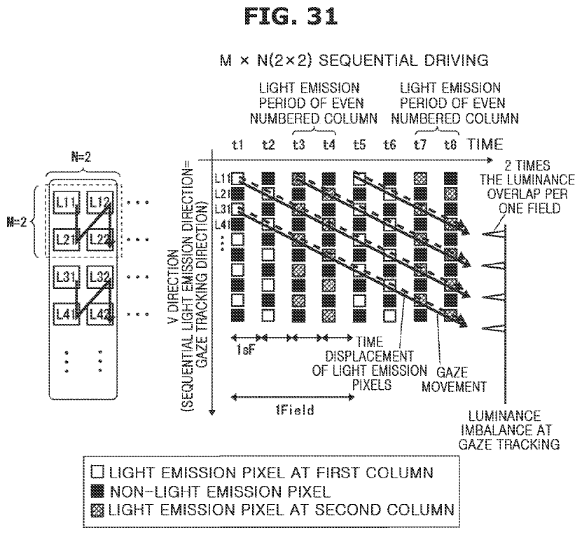

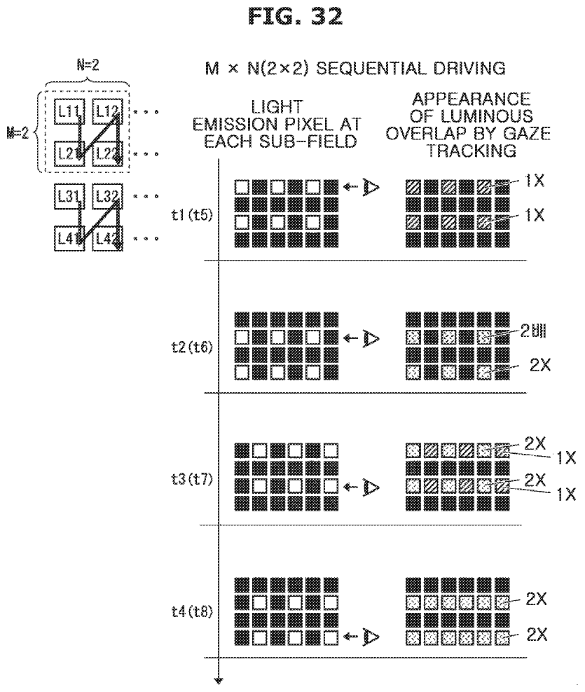

FIGS. 31 and 32 are diagrams illustrating a driving operation of the display apparatus. FIGS. 31 and 32 illustrate an example in which a movement direction of viewer gaze is a vertical direction (V direction and a vertical direction of the paper). Further, as described above, a single field is composed of four subfields.

FIG. 31 illustrates, in a plurality of pixels L (pixels L11, L21, L31, . . . ) at the first and second column, a light-emitting pixel for each sub-field, and the light emission luminance of the light-emitting pixels visually recognized by a viewer. FIG. 32 illustrates, in a plurality of pixels L at from the first row to the fourth row and from the first column to the sixth column, a light-emitting pixel for each sub-field and the light emission luminance (luminance overlap) of the light-emitting pixels visually recognized by a viewer.

As shown in FIG. 31, as for the plurality of pixels L at the first and second column, the pixels L11 and L21 sequentially emit light at time t1 to t2 corresponding one field period. Thereafter, at time t3 to t4, the pixels L31, and L41, which are adjacent to the pixels L11 and L21, do not sequentially emit light. At time t3 to t4, the pixels L32 and L42 adjacent to the pixels L31 and L41 sequentially emit light. In addition, at time t1 to t2 in time t1 to t4, the pixels L31 and L41 sequentially emit light, but at time t3 to t4, pixels L51 and L61, which are adjacent to the pixels L31 and L41, do not sequentially emit light. At time t3 to t4, the pixels L52 and L62 adjacent to the pixels L51 and L61 sequentially emit light.

In addition, the pixels L11 and L21 sequentially emit light at time t5 to t6 in time t5 to t8. Thereafter, at time t7 to t8, the pixels L31, and L41, which are adjacent to the pixels L11 and L21, do not sequentially emit light. At time t7 to t8, the pixels L32 and L42 adjacent to the pixels L31 and L41 sequentially emit light. In addition, at time t5 to t6 in time t5 to t8, the pixels L31 and L41 sequentially emit light, but at the time t7 to t8, pixels L51 and L61, which are adjacent to the pixels L31 and L41, do not sequentially emit light. At time t7 to t8, the pixels L52 and L62 adjacent to the pixels L51 and L61 sequentially emit light.

That is, when the plurality of pixels L at each column is viewed in a horizontal direction (H direction, and a horizontal direction of the paper), the movement speed of light emission is different in at least two periods in one field period. In other words, when the plurality of pixels L at each column is viewed in the horizontal direction, the movement speed of light emission during one field period is not always constant, but is divided into two or more movement speeds. That is, a predetermined light emission sequence in the pixel unit U may be determined to allow a speed of light emission in the row direction of each column of the plurality of pixels L in the pixel unit U to be changed at least once within one field.

In addition, as shown in FIG. 32, as for the plurality of pixels L from the first row to the fourth row and from the first column to the sixth column, at time t1 to t4, a pixel L at the first row and first column of each pixel unit U, a pixel L at the second row and first column of each pixel unit U, a pixel L at the first row and second column of each pixel unit U, and a pixel L at the second row and second column of each pixel unit U sequentially emit light in units of subfields. Similarly, at time t5 to t8, a pixel L at the first row and first column of each pixel unit U, a pixel L at the second row and first column of each pixel unit U, a pixel L at the first row and second column of each pixel unit U, and a pixel L at the second row and second column of each pixel unit U sequentially emit light in units of subfields.

For example, at time t1 to t4, even when the viewer's gaze is sequentially moved from the plurality of pixels L at the first row to the plurality of pixels L at the fourth row, the movement direction and speed of the light emission and the movement direction and speed of viewer gaze do not coincide with each other at each column. Therefore, overlap between the pixel emission and the light emission persistence may be prevented. Particularly, suppression of the light emission luminance of the light-emitting pixel visually recognized by a viewer is at least doubled as compared to the typical configuration.

Similarly, at time t5 to t8, even when the viewer's gaze is sequentially moved from the plurality of pixels L at the first row to the plurality of pixels L at the fourth row, the movement direction and speed of the light emission and the movement direction and speed of viewer gaze do not coincide with each other at each column. Therefore, overlap between the pixel emission and the light emission persistence may be prevented. Particularly, suppression of the light emission luminance of the light-emitting pixel visually recognized by a viewer is at least doubled as compared to the typical configuration.

That is, when the plurality of pixels L at each column is viewed in the horizontal direction, a quantity of light-emitting pixels per field is suppressed to M or less, and thus the light emission luminance of the light-emitting pixels visually recognized by the viewer is suppressed to M times more than the typical configuration. Similarly, when the plurality of pixels L at each row is viewed in the vertical direction, a quantity of light-emitting pixels per field is suppressed to N or less, and thus the light emission luminance of the light-emitting pixels visually recognized by the viewer is suppressed to N times more than the typical configuration.

Therefore, in the display apparatus, recognizing the luminance imbalance caused by the luminance overlap is difficult to detect, and thus the deterioration of the display quality may be prevented.

As mentioned above, the display apparatus according to the embodiment allows the plurality of pixels L forming each pixel unit U to regularly emit light in the same light emission sequence as in the configuration of the other pixel units U. Therefore, the display apparatus may not require the complicated wiring and suppress recognition of an emission and non-emission boundary between pixels, or suppress recognition of a luminance imbalance caused by luminance overlap. That is, the display apparatus according to the embodiment may improve display quality while suppressing wiring congestion.

In the embodiment, the configuration in which a plurality of pixels L forming each pixel unit U is connected to a common data line and is connected to another control power line (reference power line) has been described as an example, but the configuration it is not limited thereto. Alternatively, in a configuration in which a plurality of pixels L forming each pixel unit U sequentially emits light during one field period, the plurality of pixels L may be connected to different data line. In a configuration in which the plurality of pixels L forming each pixel unit U is connected to different data line, the plurality of pixels L may be connected to a common control power line (reference power line). As mentioned above, the voltage control circuit 14, which is described with respect to FIGS. 1 to 20, is provided between the plurality of light emitting elements forming the pixel unit (light emitting element group) U and the power supply. The voltage control circuit 14 may sequentially transmit a reference voltage to each of the plurality of light emitting elements. For example, the voltage control circuit 14 sequentially transmits the reference voltage to each of the plurality of light emitting elements in units of subfields, and thus the light emitting elements sequentially emit light with luminance according to each image signal. That is, the voltage control circuit 14 may control the pixel L, which emits light in the pixel unit (light emitting element group) U, to be changed according to the plurality of sub-fields.

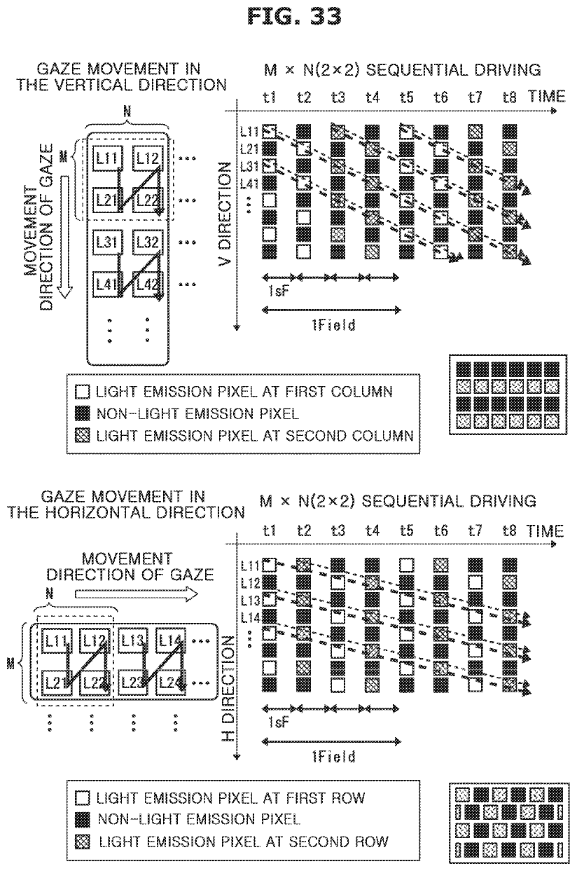

FIG. 33 is a diagram illustrating a driving operation of the display apparatus in which four pixels forming each pixel unit U emit light in such a way that an upper left pixel, a lower left pixel, an upper right pixel and a lower right pixel sequentially emit light.

FIG. 33 illustrates light-emitting pixel for each sub-field in the plurality of pixels L at the first and second column (the pixels L11, L21, L31, . . . ) and light-emitting pixel for each sub-field in the plurality of pixels L at the first and second row (the pixels L11, L12, L13, . . . ).

Referring to an upper portion of FIG. 33, in a configuration in which the movement direction of viewer gaze is the vertical direction (V direction), the overlap between the pixel light emission and the light emission persistence at each column may coincide with each other when viewed from the horizontal direction (H direction). Therefore, the overlapped-emission extends in the horizontal direction and thus there is risk that a user may recognize the overlapped-emission as a bright line.

In addition, referring to a lower portion of FIG. 33, in a configuration in which the movement direction of viewer gaze is the horizontal direction (H direction), the overlap between the light emission and the light emission persistence at each row may not coincide with each other when viewed from the vertical direction (V direction). Therefore, the overlapped-emission extends in the vertical direction and thus recognition of the overlapped-emission may be suppressed.

Therefore, in a modified example of the display apparatus, the light emission sequence of the four pixels forming each pixel unit U is set to prevent recognition of the overlapped-emission as the bright line even when the plurality of pixels L, which is arranged in the matrix form, is viewed from the vertical and horizontal direction. That is, a predetermined light emission sequence in the pixel unit U may be determined to control the speed of light emission in the row direction of each column of the plurality of pixels L in the pixel unit U to be changed at least once within one field. In addition, a predetermined light emission sequence in the pixel unit U may be determined to control the speed of light emission in the column direction of each row of the plurality of pixels L in the pixel unit U to be changed at least once within one field.

Hereinafter a modified example of the display apparatus will be described in detail.

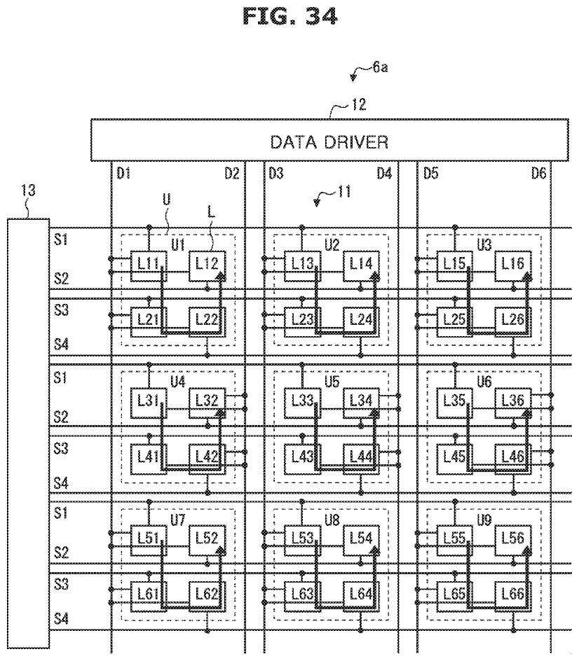

FIG. 34 is a diagram illustrating a configuration example of a display apparatus 6a corresponding to a modified example of the display apparatus 6. The display apparatus 6a controls four pixels L forming each pixel unit U to emit light in a different light emission sequence from that of the display apparatus 6.

Particularly, the display apparatus 6a controls four pixels L forming each pixel unit U to emit light in such a way that an upper left pixel, a lower left pixel, a lower right pixel and an upper right pixel sequentially emit light during one field. Other configurations and operations of the display apparatus 6a are the same as those of the display apparatus 6, and thus a redundant description thereof is omitted.

In the display apparatus 6a, an effect equivalent to that of the display apparatus 6 may be obtained. That is, the display apparatus 6a allows the plurality of pixels L forming each pixel unit U to regularly emit light in the same light emission sequence as in the configuration of the other pixel units U. Therefore, the display apparatus 6a may not require the complicated wiring and make suppress recognition of an emission and non-emission boundary between pixels, or suppress recognition of a luminance imbalance caused by luminance overlap. That is, the display apparatus 6a may improve display quality while avoiding wiring congestion.

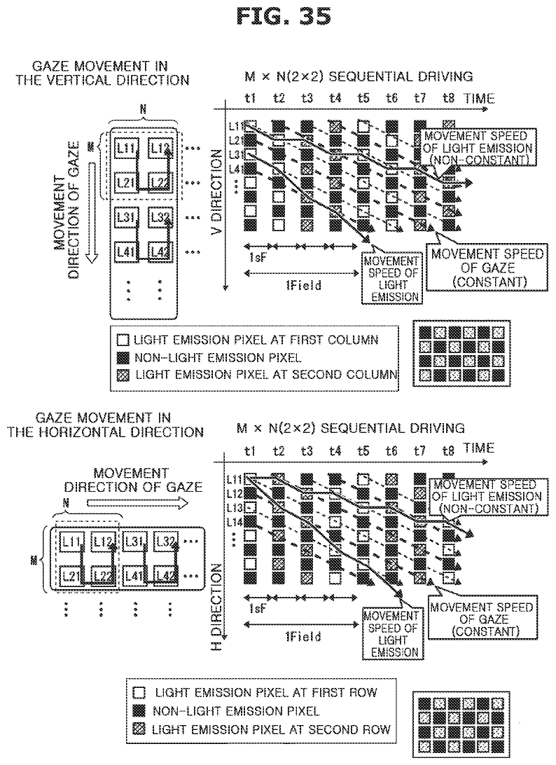

Further, in the display apparatus 6a, visually recognizing the overlapped-emission as the bright line is difficult even when the plurality of pixels L, which is arranged in the matrix form, is viewed from the vertical and horizontal direction, as described with reference to FIG. 35.

FIG. 35 is a diagram illustrating an effect of the display apparatus 6a in which four pixels forming each pixel unit U emit light in such a way that an upper left pixel, a lower left pixel, a lower right pixel and an upper right pixel sequentially emit light.

FIG. 35 illustrates light-emitting pixel for each sub-field in the plurality of pixels L at the first and second column (the pixels L11, L21, L31, . . . ) and light-emitting pixel for each sub-field in the plurality of pixels L at the first and second row (the pixels L11, L12, L13, . . . ).

Referring to an upper portion of FIG. 35, in a configuration in which the movement direction of viewer gaze is the vertical direction (V direction), the overlap between the pixel light emission and the light emission persistence at each column may not coincide with each other when viewed from the horizontal direction (H direction) and the overlapped-emission may be visually recognized as a zigzag shape. Therefore, the overlapped-emission extends in the horizontal direction and thus the overlapped-emission is unlikely to be visually recognized as a bright line.

At this time, when the plurality of pixels L arranged in a matrix form is viewed in the horizontal direction (H direction), the movement speed of each light emission is different in at least two periods during one field period. In other words, when the plurality of pixels L arranged in a matrix form is viewed in the horizontal direction, the movement speed of the gaze is constant during one field period, but the movement speed of light emission is not always constant, and divided into two or more movement speeds.

Referring to a lower portion of FIG. 35, in a configuration in which the movement direction of viewer gaze is the horizontal direction (H direction), the overlap between the pixel light emission and the light emission persistence at each row may not coincide with each other when viewed from the vertical direction (V direction), and the overlapped-emission may be visually recognized as a zigzag shape. Therefore, the overlapped-emission extends in the vertical direction and thus the overlapped-emission is unlikely to be visually recognized as a bright line.

At this time, when the plurality of pixels L arranged in a matrix form is viewed in the vertical direction (V direction), the movement speed of each light emission is different in at least two periods during one field period. In other words, when the plurality of pixels L arranged in a matrix form is viewed in the vertical direction, the movement speed of the gaze is constant during one field period, but the movement speed of light emission is not always constant, and may be divided into two or more movement speeds.

As mentioned above, in the display apparatus 6a, visually recognizing the overlapped-emission as the bright line is difficult even when the plurality of pixels L, which is arranged in the matrix form, is viewed from the vertical and horizontal direction. Accordingly, the display apparatus 6a may further improve display quality. That is, the predetermined light emission sequence in the pixel unit U may be determined to control the speed of light emission in the row direction of each column of the plurality of pixels L in the pixel unit U to be changed at least once within one field. Further, the predetermined light emission sequence in the pixel unit U may be determined to control the speed of light emission in the column direction of each row of the plurality of pixels L in the pixel unit U to be changed at least once within one field.

The four pixels L forming each pixel unit U are not limited to the configuration of emitting light in the above-described light emission sequence, and may regularly emit light in any light emission sequence.

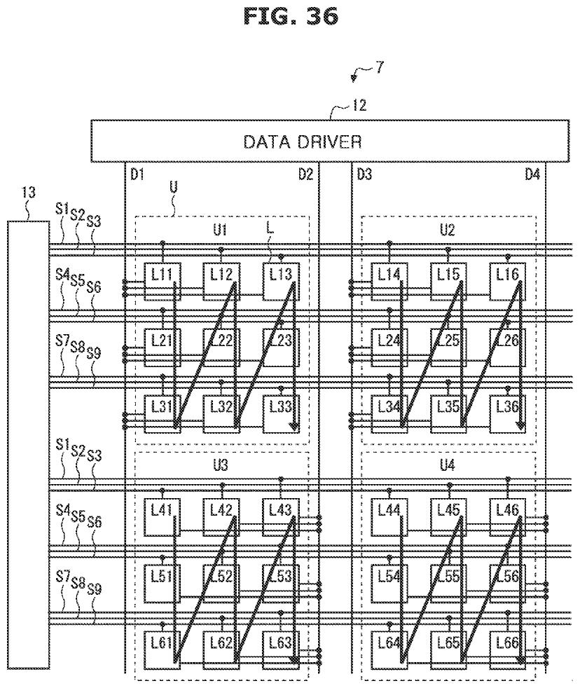

FIG. 36 is a diagram illustrating a display apparatus according to an embodiment of the disclosure. In FIG. 7, a display apparatus 7 includes a plurality of pixels L provided on a panel 11 divided into a plurality of pixel units U composed of nine pixels L at 3 rows×3 columns. In the embodiment, a configuration in which one field is composed of nine sub-fields is described as an example.

More particularly, one pixel unit U (hereinafter U1) is composed of nine pixels L11 to L13, L21 to L23, and L31 to L33. One pixel unit U (hereinafter U2) is composed of nine pixels L14 to L16, L24 to L26, and L34 to L36. One pixel unit U (hereinafter U3) is composed of nine pixels L41 to L43, L51 to L53, and L61 to L63. One pixel unit U (hereinafter U4) is composed of nine pixels L44 to L46, L54 to L56, and L64 to L66.

The nine pixels L forming each pixel unit U are connected to a common data line. Particularly, the nine pixels L forming the pixel unit U1 are connected to a common data line D1. The nine pixels L forming the pixel unit U2 are connected to a common data line D3. The nine pixels L forming the pixel unit U3 are connected to a common data line D2. The nine pixels L forming the pixel unit U4 are connected to a common data line D4.

Based on an instruction from a control circuit, a data driver 12 sequentially outputs image signals with respect to the plurality of pixels L forming each pixel unit U in units of subfields

For example, the data driver 12 sequentially outputs a plurality of image signals with respect to the nine pixels L forming the pixel unit U1 to the data line D1 during nine sub-field periods forming a single field. The data driver 12 sequentially outputs a plurality of image signals with respect to the nine pixels L forming the pixel unit U2 to the data line D3 during the nine sub-field periods forming the single field. The data driver 12 sequentially outputs a plurality of image signals with respect to the nine pixels L forming the pixel unit U3 to the data line D2 during the nine sub-field periods forming the single field. The data driver 12 sequentially outputs a plurality of image signals with respect to the nine pixels L forming the pixel unit U4 to the data line D4 during the nine sub-field periods forming the single field.

Based on an instruction from the control circuit, the scan driver 13 supplies a control voltage (reference voltage such as a ground voltage) to a control power line (reference power line) provided in accordance with each of the plurality of pixels L forming each pixel unit U. A pixel L, which is supplied with the control voltage through the control power line, emits light with luminance according to the image signal supplied through the data line.

Particularly, a control power line S1 is wired to a pixel at the first row and first column (an upper left pixel L; particularly, the pixels L11, L14, L41, and L44) among the nine pixels L forming each pixel unit U. A control power line S2 is wired to a pixel at the first row and second column (an upper middle pixel L; particularly, the pixels L12, L15, L42, and L45) among the nine pixels L forming each pixel unit U. A control power line S3 is wired to a pixel at the first row and third column (an upper right pixel L; particularly, the pixels L13, L16, L43, and L46) among the nine pixels L forming each pixel unit U. A control power line S4 is wired to a pixel at the second row and first column (a left middle pixel L; particularly, the pixels L21, L24, L51, and L54) among the nine pixels forming each pixel unit U. A control power line S5 is wired to a pixel at the second row and second column (a central pixel L; particularly, the pixels L22, L25, L52, and L55) among the nine pixels forming each pixel unit U. A control power line S6 is wired to a pixel at the second row and third column (a right middle pixel L; particularly, the pixels L23, L26, L53, and L56) among the nine pixels forming each pixel unit U. A control power line S7 is wired to a pixel at the third row and first column (a lower left pixel L; particularly, the pixels L31, L34, L61, and L64) among the nine pixels forming each pixel unit U. A control power line S8 is wired to a pixel at the third row and second column (a lower middle pixel L; particularly, the pixels L32, L35, L62, and L65) among the nine pixels forming each pixel unit U. A control power line S9 is wired to a pixel at the third row and third column (a lower right pixel L; particularly, the pixels L33, L36, L63, and L66) among the nine pixels forming each pixel unit U.

Through the control power lines S1, S4 S7, S2, S5, S8, S3, S6, and S9, the scan driver 13 sequentially supplies the control voltage in units of subfields. Accordingly, the nine pixels L forming each pixel unit U emit light in the same light emission sequence as the other pixel units U during one field period. In the example of FIG. 35, the nine pixels L forming each pixel unit U emit light such that an upper left pixel, a left middle pixel, a lower left pixel, an upper middle pixel, a central pixel, a lower middle pixel, an upper right pixel, a right middle pixel, and a lower right pixel sequentially emit light.

The scan driver 13 may transmit a gate control signal to a pixel circuit corresponding to each pixel unit U, and in a configuration in which the voltage control circuit 14, which is described with respect to FIGS. 1 to 20, is provided between the plurality of light emitting elements included in each pixel unit U and a power supply, the voltage control circuit 14 may sequentially transmit a reference voltage to each of the plurality of light emitting elements. For example, the voltage control circuit 14 sequentially transmits a reference voltage to each of the plurality of light emitting elements in units of subfields, and thus the light emitting elements sequentially emit light with luminance according to each image signal.

Other configurations and operations of the display apparatus 7 are the same as those of the display apparatus 6, and thus a redundant description thereof is omitted.

In the display apparatus 7, an effect equivalent to that of the display apparatus 6 may be obtained. That is, the display apparatus 7 allows the plurality of pixels L forming each pixel unit U to regularly emit light in the same light emission sequence as in the configuration of the other pixel units U. Therefore, the display apparatus 7 may not require the complicated wiring and may suppress visual recognition of an emission and non-emission boundary between pixels, or suppress visual recognition of a luminance imbalance caused by luminance overlap. That is, the display apparatus 7 may improve display quality while avoiding wiring congestion.

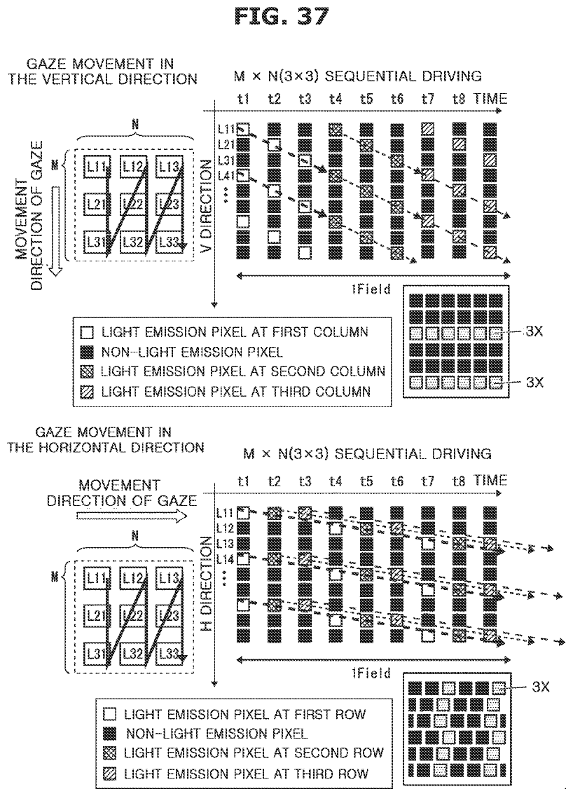

FIG. 37 is a diagram illustrating a driving operation of the display apparatus in which the nine pixels forming each pixel unit U emit light in such a way that an upper left pixel, a left middle pixel, a lower left pixel, an upper middle pixel, a central pixel, a lower middle pixel, an upper right pixel, a right middle pixel, and a lower right pixel sequentially emit light.

FIG. 37 illustrates a light-emitting pixel for each sub-field in the plurality of pixels L at the first to third column (the pixels L11, L21, L31, . . . ) and a light-emitting pixel for each sub-field in the plurality of pixels L at the first to third row (the pixels L11, L12, L13, . . . ).

As shown in an upper side of FIG. 37, as for the plurality of pixels L at the first to third columns, the pixels L11, L21, and L31 at the first column sequentially emit light, or the pixels L41, L51 and L61 at the first column sequentially emit light at time t1 to t3. Thereafter, at time t4 to t6, the pixels L12, L22, and L32 at the second column sequentially emit light or the pixels L42, L52, and L62 at the second column sequentially emit light. Thereafter, at time t7 to t9, the pixels L13, L23, and L33 at the third column sequentially emit light or the pixels L43, L53, and L63 at the third column sequentially emit light.

For example, at time t1 to t3, when the viewer's gaze is sequentially moved from the plurality of pixels L at the first row to the plurality of pixels L at the third row, the movement direction and speed of the light emission and the movement direction and speed of viewer gaze coincide with each other at, for example, the plurality of pixels L at the first column. Therefore, light emission of the pixel L at the third row at the time 3, light emission persistence of the pixel L at the first row at time 1, and light emission persistence of the pixel L at the second row at time 2 are overlapped. As a result, the light emission luminance of the emission pixels (the pixel L at the third row) visually recognized by a viewer may be suppressed to nine times more than the typical configuration, but may be increased to three times (M times) more than the typical configuration. This may be applied to a configuration in which the viewer's gaze is sequentially moved from the plurality of pixels L at the fourth row to the plurality of pixels L at the sixth row.

In addition, at time t4 to t6, when the viewer's gaze is sequentially moved from the plurality of pixels L at the first row to the plurality of pixels L at the third row, the movement direction and speed of the light emission and the movement direction and speed of viewer gaze coincide with each other at, for example, the plurality of pixels L at the second column. Therefore, light emission of the pixel L at the sixth row at time 6, light emission persistence of the pixel L at the fourth row at time 4, and light emission persistence of the pixel L at the fifth row at time 5 are overlapped. Therefore, the light emission luminance of the emission pixels (the pixel L at the sixth row) visually recognized by a viewer may be suppressed to nine times more than the typical configuration, but may be increased to three times (M times) more than the typical configuration. This may be applied to a configuration in which the viewer's gaze is sequentially moved from the plurality of pixels L at the fourth row to the plurality of pixels L at the sixth row.

In addition, at time t7 to t9, when the viewer's gaze is sequentially moved from the plurality of pixels L at the first row to the plurality of pixels L at the third row, the movement direction and speed of the light emission and the movement direction and speed of viewer gaze coincide with each other at, for example, the plurality of pixels L at the third column. Therefore, light emission of the pixel L at the ninth row at time 9, light emission persistence of the pixel L at the seventh row at time 7, and light emission persistence of the pixel L at the eighth row at time 8 are overlapped. Accordingly, the light emission luminance of the emission pixels (the pixel L at the ninth row) visually recognized by a viewer may be suppressed to nine times more than the typical configuration, but may be increased to three times (M times) more than the typical configuration. This may be applied to a configuration in which the viewer's gaze is sequentially moved from the plurality of pixels L at the fourth row to the plurality of pixels L at the sixth row.

As shown in a lower side of FIG. 37, as for the plurality of pixels L at the first to third rows, the pixels L11 to L13 at the first row sequentially emit light, or the pixels L14 to L16 at the first row sequentially emit light at times t1, t4 and t7. At times t2, t5 and t8, the pixels L21 to L23 at the second row sequentially emit light or the pixels L24 to L26 at the second row sequentially emit light. At times t3, t6 and t9, the pixels L31 to L33 at the third row sequentially emit light or the pixels L34 to L36 at the third row sequentially emit light.

For example, at times t1, t4 and t7, when the viewer's gaze is sequentially moved from the plurality of pixels L at the first column to the plurality of pixels L at the third column, the movement direction and speed of the light emission and the movement direction and speed of viewer gaze coincide with each other at, for example, the plurality of pixels L at the first row. Therefore, light emission of the pixel L at the third column at time 7, light emission persistence of the pixel L at the first column at time 1, and light emission persistence of the pixel L at the second column at time 4 are overlapped. Accordingly, the light emission luminance of the emission pixels (the pixel L at the third column) visually recognized by a viewer may be suppressed to nine times more than the typical configuration, but may be increased to three times (N times) more than the typical configuration. This may be applied to a configuration in which the viewer's gaze is sequentially moved from the plurality of pixels L at the fourth column to the plurality of pixels L at the sixth column.

In addition, at times t2, t5 and t8, when the viewer's gaze is sequentially moved from the plurality of pixels L at the first column to the plurality of pixels L at the third column, the movement direction and speed of the light emission and the movement direction and speed of viewer gaze coincide with each other at, for example, the plurality of pixels L at the second row. Therefore, light emission of the pixel L at the third column at time 8, light emission persistence of the pixel L at the first column at time 2, and light emission persistence of the pixel L at the second column at time 5 are overlapped. Accordingly, the light emission luminance of the emission pixels (the pixel L at the third column) visually recognized by a viewer may be suppressed to nine times more than the typical configuration, but may be increased to three times (N times) more than the typical configuration. This may be applied to a configuration in which the viewer's gaze is sequentially moved from the plurality of pixels L at the fourth column to the plurality of pixels L at the sixth column.

In addition, at times t3, t6 and t9, when the viewer's gaze is sequentially moved from the plurality of pixels L at the first column to the plurality of pixels L at the third column, the movement direction and speed of the light emission and the movement direction and speed of viewer gaze coincide with each other at, for example, the plurality of pixels L at the third row. Therefore, light emission of the pixel L at the third column at time 9, light emission persistence of the pixel L at the first column at time 3, and light emission persistence of the pixel L at the second column at time 6 are overlapped. Therefore, the light emission luminance of the emission pixels (the pixel L at the third column) visually recognized by a viewer may be suppressed to nine times more than the typical configuration, but may be increased to three times (N times) more than the typical configuration. This may be applied to a configuration in which the viewer's gaze is sequentially moved from the plurality of pixels L at the fourth column to the plurality of pixels L at the sixth column.

In the modified example of the display apparatus 7, the light emission sequence of the nine pixels forming each pixel unit U is set to control the luminance of the overlapped-emission that is visually recognized by a viewer to be further suppressed. Hereinafter a modified example of the display apparatus 7 will be described in detail.

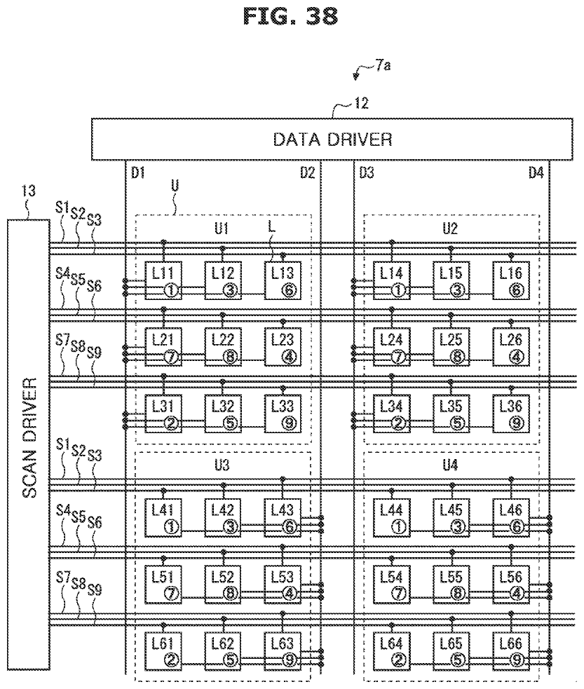

FIG. 38 is a diagram illustrating a configuration example of a display apparatus 7a corresponding to a modified example of the display apparatus 7. The display apparatus 7a allows nine pixels L forming each pixel unit U to emit light in a different light emission sequence from that of the display apparatus 7.

Particularly, the display apparatus 7a allows nine pixels L forming each pixel unit U to emit light in such a way that an upper left pixel, a lower left pixel, an upper middle pixel, a right middle pixel, a lower middle pixel, an upper right pixel, a left middle pixel, a central pixel and a lower right pixel sequentially emit light during one field. Other configurations and operations of the display apparatus 7a are the same as those of the display apparatus 7, and thus a redundant description thereof is omitted.

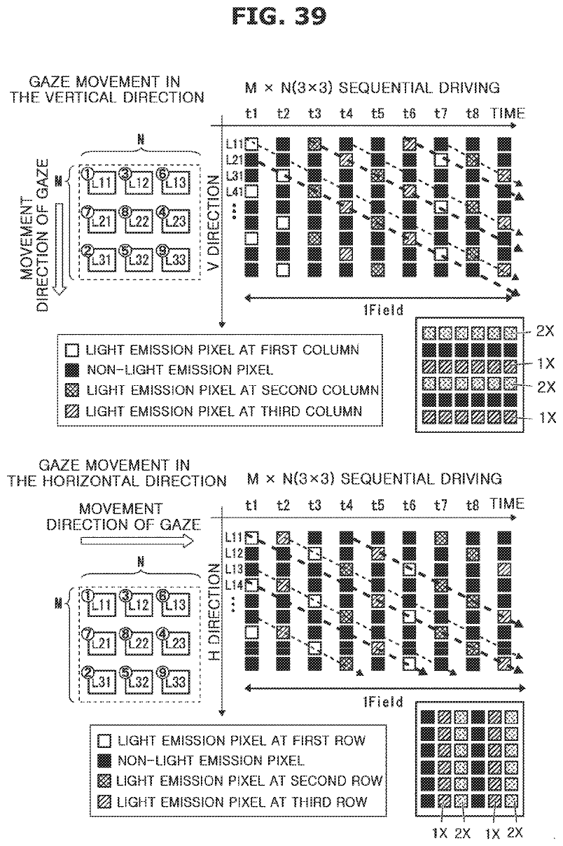

FIG. 39 is a diagram illustrating a driving operation of the display apparatus 7a in which nine pixels forming each pixel unit U emit light in such a way that an upper left pixel, a lower left pixel, an upper middle pixel, a right middle pixel, a lower middle pixel, an upper right pixel, a left middle pixel, a central pixel and a lower right pixel sequentially emit light.

FIG. 39 illustrates light emitting pixel for each sub-field in the plurality of pixels L at the first to third column (the pixels L11, L21, L31, . . . ) and light-emitting pixel for each sub-field in the plurality of pixels L at the first to third row (the pixels L11, L12, L13, . . . ).

Referring to an upper side of FIG. 39, in a configuration in which the movement direction of viewer gaze is the vertical direction (V direction), as for the plurality of pixels L at each column, a quantity of the pixel L, which emits light according to the movement of the viewer gaze for one field period (nine sub-fields period), is less than three (M). Therefore, the luminance of the overlapped-emission visually recognized by a viewer is suppressed to less than 3 times (M times) the typical configuration.

Referring to a lower side of FIG. 39, in a configuration in which the movement direction of viewer gaze is the horizontal direction (H direction), as for the plurality of pixels L at each row, a quantity of the pixel L, which emits light according to the movement of the viewer gaze for one field period (nine sub-fields period), is less than three (N). Therefore, the luminance of the overlapped emission visually recognized by a viewer is suppressed to less than 3 times (N times) the typical configuration.

As described above, by a research of the light emission sequence of the plurality of pixels L forming each pixel unit U, in response to the movement direction of viewer gaze being the vertical direction, the display apparatus 7a may suppress the luminance of the overlapped-emission, which is visually recognized by a viewer, to less than M times the typical configuration. In response to the movement direction of viewer gaze being the horizontal direction, the display apparatus 7a may suppress the luminance of the overlapped-emission, which is visually recognized by a viewer, to less than N times the typical configuration. That is, the display apparatus 7a may further improve display quality. That is, the predetermined light emission sequence in the pixel unit U may be determined to allow the speed of light emission in the row direction of each column of the plurality of pixels L in the pixel unit U to be changed at least once within one field. Further, the predetermined light emission sequence in the pixel unit U may be determined to allow the speed of light emission in the column direction of each row of the plurality of pixels L in the pixel unit U to be changed at least once within one field.

The nine pixels L forming each pixel unit U are not limited to the configuration of emitting light in the above-described light emission sequence, and may regularly emit light in any light emission sequence.

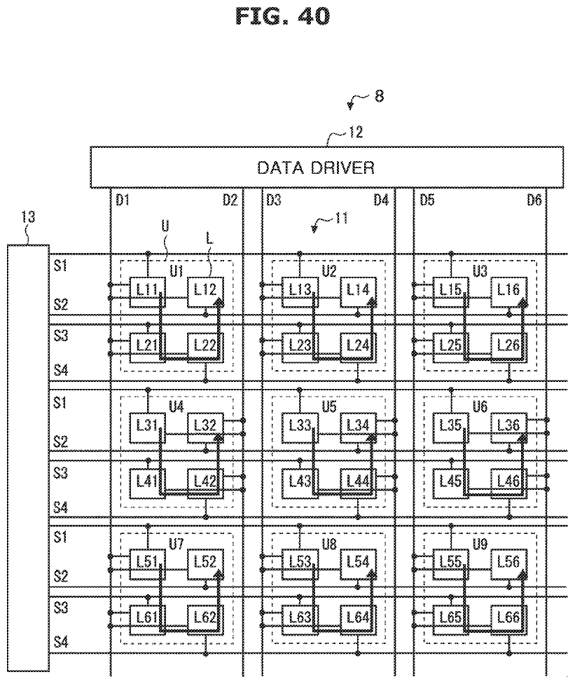

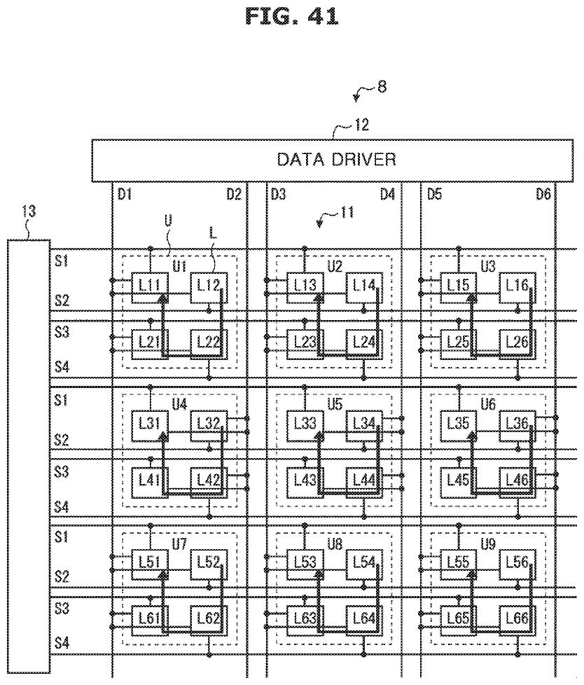

FIGS. 40 and 41 illustrate a light emitting sequence of a plurality of pixels L forming each pixel unit U, which is provided in a display apparatus according to an embodiment of the disclosure, at a first field and a second field. As shown in FIGS. 40 and 41, the display apparatus 8 includes the same configuration as the display apparatus 6, and the light emitting sequence of the four pixels L forming each pixel unit U is changed in units of one field.

Particularly, the display apparatus 8 control the four pixels L forming each pixel unit U to emit light in such a way that an upper left pixel, a lower left pixel, a lower right pixel and an upper right pixel emit light in sequence during the first field period, and in such a way that the upper right pixel, the lower right pixel, the lower left pixel, and the upper left pixel emit light in sequence during the second period. After the third field, operations of the first field and the second field are repeated.

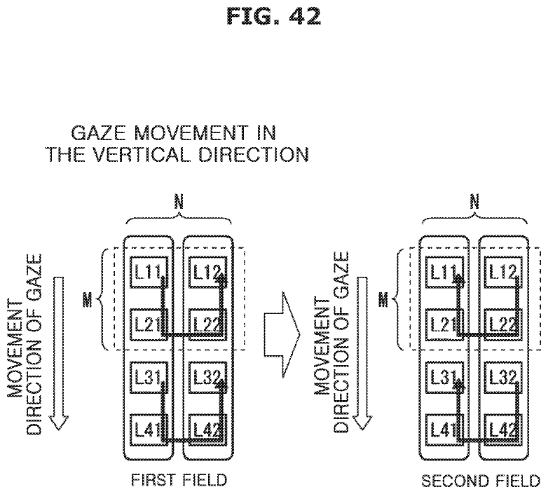

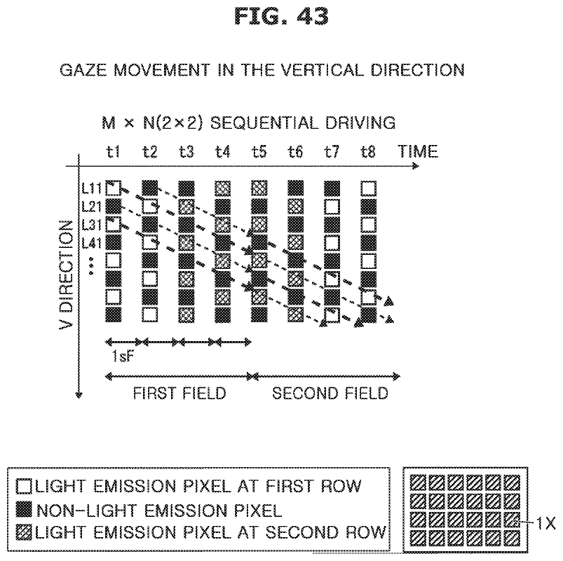

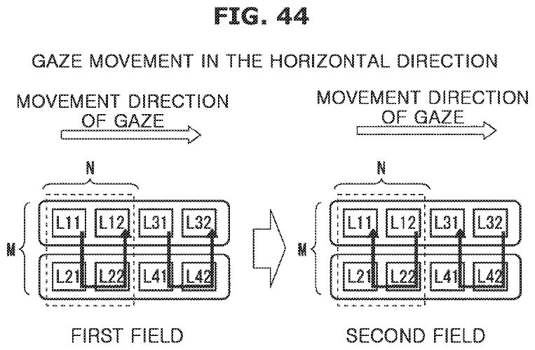

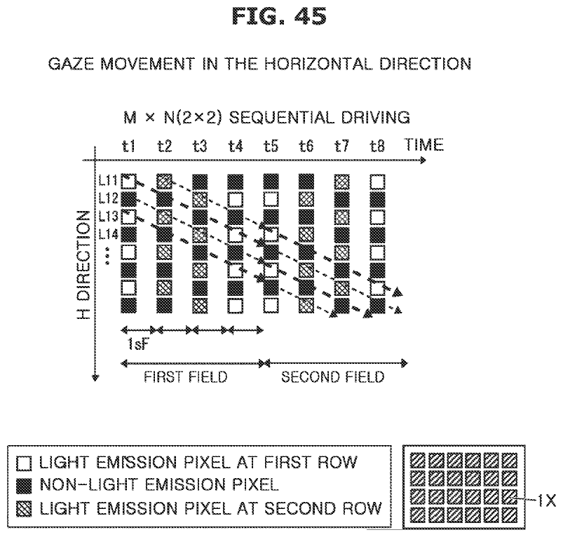

FIGS. 42 to 45 are diagrams illustrating a driving operation of the display apparatus 8. FIGS. 42 and 43 illustrate an example in which the movement direction of the viewer gaze is in the vertical direction (V direction), and FIGS. 44 and 45 illustrate an example in which the movement direction of the viewer gaze is in the horizontal direction (H direction).

First, referring to FIGS. 42 and 43, based on the movement direction of the viewer gaze in the vertical direction (V direction), as for the plurality of pixels L at each column, the sum of a quantity of pixels that emits light according to the movement of the viewer gaze during the first field period (four sub-field periods), and a quantity of pixels that emits light according to the movement of the viewer gaze during the second field period is two. That is, based on the movement direction of the viewer gaze in the vertical direction (V direction), as for the plurality of pixels L at each column, the average of a quantity of pixels L that emits light according to the movement of the viewer gaze is suppressed to one per one field. Therefore, the luminance of the overlapped-light emission visually recognized by the viewer is maintained at a level of the typical light emission luminance.

Further, referring to FIGS. 44 and 45, based on the movement direction of the viewer gaze in the horizontal direction (H direction), as for the plurality of pixels L at each row, the sum of a quantity of pixels that emits light according to the movement of the viewer gaze during the first field period (four sub-field periods), and a quantity of pixels that emits light according to the movement of the viewer gaze during the second field period is two. That is, based on the movement direction of the viewer gaze in the horizontal direction (H direction), as for the plurality of pixels L at each row, the average of a quantity of pixels L that emits light according to the movement of the viewer gaze is suppressed to one per one field. Therefore, the luminance of the overlapped-light emission visually recognized by the viewer is maintained at a level of the typical light emission luminance.

As mentioned above, the display apparatus 8 changes the light emission sequence of the plurality of pixels L forming each pixel unit U in units of one field. Accordingly, the display apparatus 8 may further suppress the luminance of the overlapped-light emission visually recognized by a viewer. That is, the display apparatus 8 may further improve display quality.

For example, the voltage control circuit 14 may change the light emission sequence of the plurality of pixels L forming each pixel unit U in units of one field by changing the predetermined light emission sequence in units of one field.

In the embodiment, the configuration in which a quantity of pixels L forming each pixel unit U is four is described as an example, but the configuration is not limited thereto. Therefore, a quantity of pixels L forming each pixel unit U may be any number.

In addition, in the configuration in which the light emission sequence of the plurality of pixels L forming each pixel unit U is changed in units of one field, the light emission sequence may be any light emission sequence.

In addition, in the embodiment, the configuration in which the light emission sequence at the first to second fields is different, and the operation of the first and second fields is repeated after the third field has been described as an example, but the configuration is not limited thereto. For example, the light emission sequence at the first to third fields may be different and an operation of the first to third fields may be repeated after the fourth field.

A display apparatus 9 according to an embodiment has different maximum light emission times of the plurality of pixels L forming each pixel unit U. A configuration and basic operation of the display apparatus 9 are the same as those of the display apparatus 6a. Therefore, in the embodiment, a configuration in which a quantity of sub-fields forming one field is four will be described as an example.

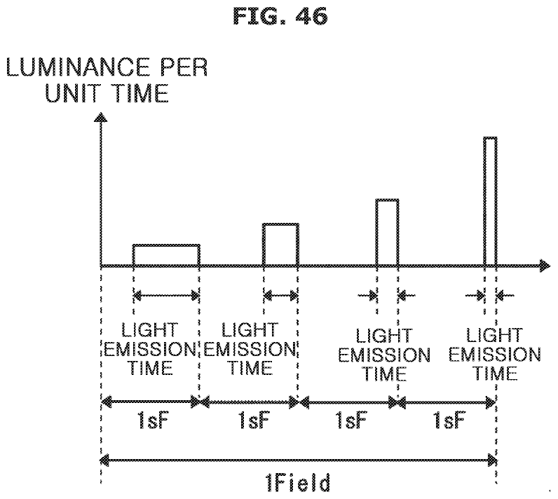

FIG. 46 is a diagram illustrating a driving operation example of the display apparatus 9 according to an embodiment of the disclosure. FIG. 46 illustrates a relationship between a maximum light emission time and the luminance per unit time of four pixels L forming each pixel unit U.

Referring to FIG. 46, the four pixels L forming each pixel unit U emit light sequentially in units of sub-fields and in different maximum light emission time ranges. In this configuration, the maximum light emission time and the light emission luminance per unit time are adjusted to make a value, which is obtained by multiplying the maximum light emission time and the light emission luminance per unit time, the same. Accordingly, even when the maximum light emission time is different, the light emission luminance per one subfield is maintained at the equivalent level.

Particularly, each pixel unit U employs a PWM method and pixel driving method such as a switch control method as shown in FIG. 28. A pixel circuit 15a provided in each pixel unit U adjusts a constant current supplied from the pixel circuit 15a to the light emitting elements 155_1 to 155_4 by adjusting an on-resistance of a transistor TR23 corresponding to a constant current source. Accordingly, a predetermined voltage per unit time applied to each of the light emitting element 155_1 to 155_4 (that is, the light emission luminance) is adjusted. Further, the pixel circuit 15a adjusts a supply period of the constant current, which is supplied from the pixel circuit 15a to the light emitting elements 155_1 to 155_4, by adjusting an on-period of a transistor TR21. Accordingly, an application period of the predetermined voltage (that is, the light emission luminance) applied to each of the light emitting elements 155_1 to 155_4 is adjusted.

For example, in a state in which the supply period of the constant current supplied from the pixel circuit 15a to the light-emitting element 155_1 is longer than usual by increasing the on-period of the transistor TR21, a constant current value, which is supplied to the light emitting element 155_1 from the pixel circuit 15a, may be reduced by increasing the on-resistance of the transistor TR23 and the predetermined voltage per unit time applied to the light emitting element 155_1 is controlled to be less than usual. Further, in a state in which the supply period of the constant current supplied from the pixel circuit 15a to the light-emitting element 155_1 is less than usual by reducing the on-period of the transistor TR21, a constant current value, which is supplied to the light emitting element 155_1 from the pixel circuit 15a, may be increased by reducing the on-resistance of the transistor TR23 and thus the predetermined voltage per unit time applied to the light emitting element 155_1 is controlled to be greater than usual. Therefore, even when the maximum light emission times are different, the light emission luminance per field is maintained at the equivalent level.

In addition, in a configuration in which the scan driver 13 transmits a gate control signal to the pixel circuit 15b corresponding to the pixel unit U, and the voltage control circuit 14 described in FIGS. 1 to 20 is provided between the plurality of light emitting elements 155_1 to 155_4 included in the pixel unit U and the power supply, the voltage control circuit 14 may control any one pixel provided in each pixel unit U to emit light during a first light emission time, and may control other pixels provided in each pixel unit U to emit light during a second light emission time.

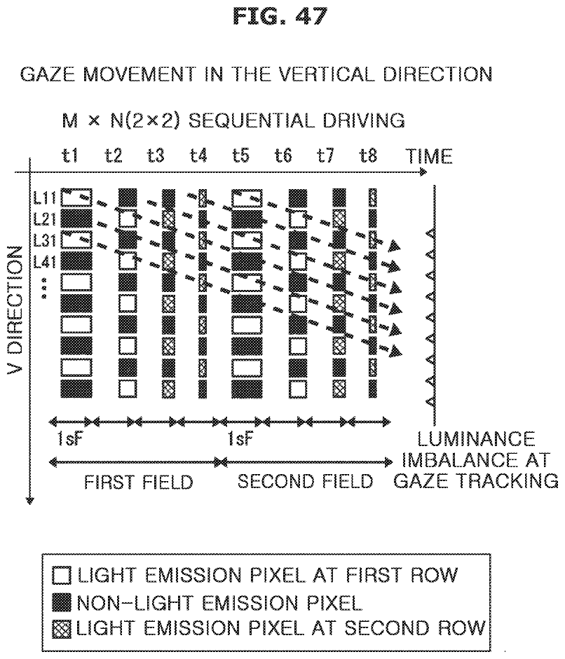

FIG. 47 is a diagram illustrating a driving operation of the display apparatus 9. FIG. 47 illustrates an example in which the movement direction of the gaze by a viewer is the vertical direction (V direction).

Referring to FIG. 47, based on the movement direction of the viewer gaze in the vertical direction (V direction), as for the plurality of pixels L at each column, the sum of a quantity of pixels that emit light according to the movement of the viewer gaze during the first field period (four sub-field periods), and a quantity of pixels that emits light according to the movement of the viewer gaze during the second field period is two. That is, based on the movement direction of the viewer gaze in the vertical direction (V direction), as for the plurality of pixels L at each column, the average of a quantity of pixels L that emit light according to the movement of the viewer gaze is suppressed to one per one field. Therefore, the luminance of the overlapped-light emission visually recognized by the viewer is maintained at a level of the typical light emission luminance. This may be applied to the configuration in which the movement direction of the gaze by a viewer is the horizontal direction (H direction).

As mentioned above, the display apparatus 9 has different lengths of the maximum light emission times of the plurality of pixels L forming each pixel unit U. Accordingly, the display apparatus 9 may further suppress the luminance of the overlapped-light emission visually recognized by a viewer because the display apparatus 9 allows transition of a light emission start time to be non-linear. That is, the display apparatus 9 may further improve display quality.

In the embodiment, the configuration in which a quantity of pixels L forming each pixel unit U is four has been described as an example, but the configuration is not limited thereto. A quantity of pixels L forming each pixel unit U may be any number.

Further, in the embodiment, the configuration in which the maximum light emission times of the plurality of pixels L forming each pixel unit U is different from each other has been described as an example, but the configuration is not limited thereto. Each of the plurality of pixels L forming each pixel unit U may emit light by dividing the maximum light emission time by at least two types of lengths. For example, any pixel L among plurality of pixels L forming each pixel unit U emit light in the first maximum light emission time range, and other pixel L among plurality of pixels L forming each pixel unit U emit light in the second maximum light emission time range.

In addition, a configuration in which the maximum emission time of each of the plurality of pixels L forming each pixel unit U is different, and a configuration in which the light emission sequence of the plurality of pixels L forming each pixel unit U is switched in units of one field described in the eighth embodiment may be used in combination therewith.

In an embodiment, a specific configuration example of each pixel unit U and several modified examples will be described. In the embodiment, a configuration in which each pixel unit U is composed of four pixels L and each pixel L includes three RGB light emitting elements 155 will be described as an example. That is, each of the plurality of pixels L may include a red light emitting element, a green light emitting element, and a blue light emitting element. Further, in the embodiment, a specific configuration example of the pixel unit U1 is described as a representative, but the other pixel units U also include the same configuration as in the configuration of the pixel unit U1.

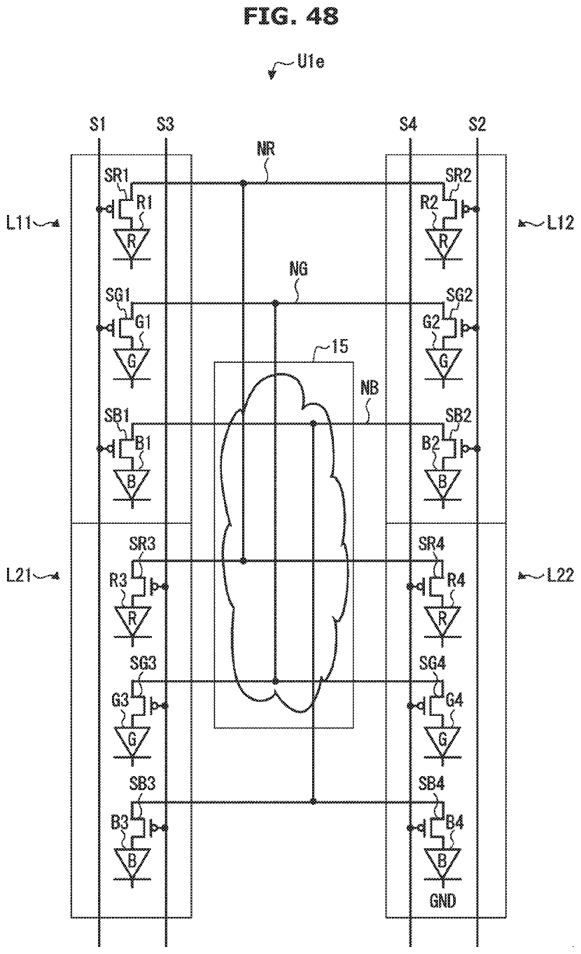

FIG. 48 is a diagram illustrating a pixel unit U1 as a pixel unit U1e. The pixel unit U1e employs the pixel driving method, such as the switch control method.

As shown in FIG. 48, the pixel unit U1e includes four pixels L11, L12, L21, and L22. Further, the pixel unit U1e includes switch elements SR1 to SR4, SG1 to SG4, and SB1 to SB4. For example, each switch element is a P-channel MOS transistor.

The pixel L11 is composed of three RGB light emitting diodes 155 (hereinafter referred to as light emitting elements R1, G1, and B1) and a pixel circuit 15 configured to drive the light emitting elements. The pixel L12 is composed of three RGB light emitting diodes 155 (hereinafter referred to as light emitting elements R2, G2, and B2), and the pixel circuit 15 configured to drive the light emitting elements. The pixel L21 is composed of three RGB light emitting diodes 155 (hereinafter referred to as light emitting elements R3, G3, and B3), and the pixel circuit 15 configured to drive the light emitting elements. The pixel L22 is composed of three RGB light emitting diodes 155 (hereinafter referred to as light emitting elements R4, G4, and B4), and the pixel circuit 15 configured to drive the light emitting elements. In the embodiment, the pixel circuit 15 is shared by the four pixels L11, L12, L21, and L22. The pixel circuit 15 may be a PAM type pixel circuit 15a or a PWM type pixel circuit 15b.

Each cathode of the light emitting elements R1, G1, and B1 provided in the pixel L11 is connected to a ground voltage GND. Further, an anode of the light-emitting element R1 is connected to a node NR, which is an output node of the pixel circuit 15, through the switch element SR1. An anode of the light emitting element G1 is connected to a node NG, which is an output node of the pixel circuit 15, through the switch element SG1. An anode of the light emitting element B1 is connected to a node NB, which is an output node of the pixel circuit 15, through the switch element SB1.

Each cathode of the light emitting elements R2, G2, and B2 provided in the pixel L12 is connected to the ground voltage GND. Further, an anode of the light-emitting element R2 is connected to the node NR, which is an output node of the pixel circuit 15, through the switch element SR2. An anode of the light emitting element G2 is connected to the node NG, which is an output node of the pixel circuit 15, through the switch element SG2. An anode of the light emitting element B2 is connected to the node NB, which is an output node of the pixel circuit 15, through the switch element SB2.

Each cathode of the light emitting elements R3, G3, and B3 provided in the pixel L21 is connected to the ground voltage GND. Further, an anode of the light-emitting element R3 is connected to the node NR, which is an output node of the pixel circuit 15, through the switch element SR3. An anode of the light emitting element G3 is connected to the node NG, which is an output node of the pixel circuit 15, through the switch element SG3. An anode of the light emitting element B3 is connected to the node NB, which is an output node of the pixel circuit 15, through the switch element SB3.

Each cathode of the light emitting elements R4, G4, and B4 provided in the pixel L22 is connected to the ground voltage GND. Further, an anode of the light-emitting element R4 is connected to the node NR, which is an output node of the pixel circuit 15, through the switch element SR4. An anode of the light emitting element G4 is connected to the node NG, which is an output node of the pixel circuit 15, through the switch element SG4. An anode of the light emitting element B4 is connected to the node NB, which is an output node of the pixel circuit 15, through the switch element SB4.

That is, each anode of the red light emitting elements R1 to R4 is connected in common to the node NR. Each anode of the green light emitting elements G1 to G4 is connected in common to the node NG. Each anode of the blue light emitting elements B1 to B4 is connected in common to the node NB.

The switch elements SR1, SG1, and SB1 switch on-off states according to a control voltage S1. The switch elements SR2, SG2, and SB2 switch on and off according to a control voltage S2. The switch elements SR3, SG3, and SB3 switch on-off states according to a control voltage S3. The switch elements SR4, SG4, and SB4 switch on-off states according to a control voltage S4.

A data driver 12 sequentially outputs image signals for the four pixels L forming each pixel unit U in units of sub-fields. For example, the data driver 12 sequentially outputs image signals for the four pixels L11, L12, L21, and L22 forming the pixel unit U1e in units of sub-fields. The pixel circuit 15 provided in the pixel unit U1e outputs a current according to the image signal, which is supplied from the data driver 12 to the pixel unit U1e, to the nodes NR, NG, and NB in units of sub-fields.

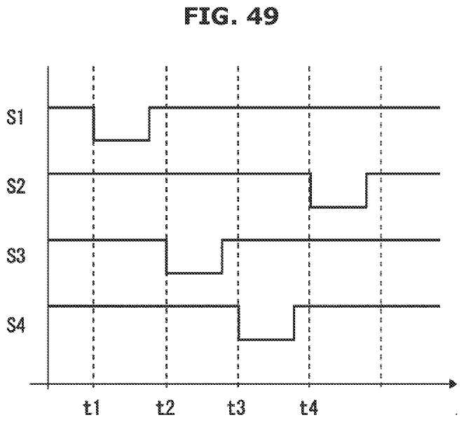

For example, as shown in FIG. 49, the scan driver 13 controls the control voltages S1, S3, and S4 S2 to be at the low L level in sequence in sub-field units (times t1, t2, t3, and t4).

Accordingly, the four pixels L forming each pixel unit U emit light in the same light emission sequence as in the configuration of the other pixel units U.

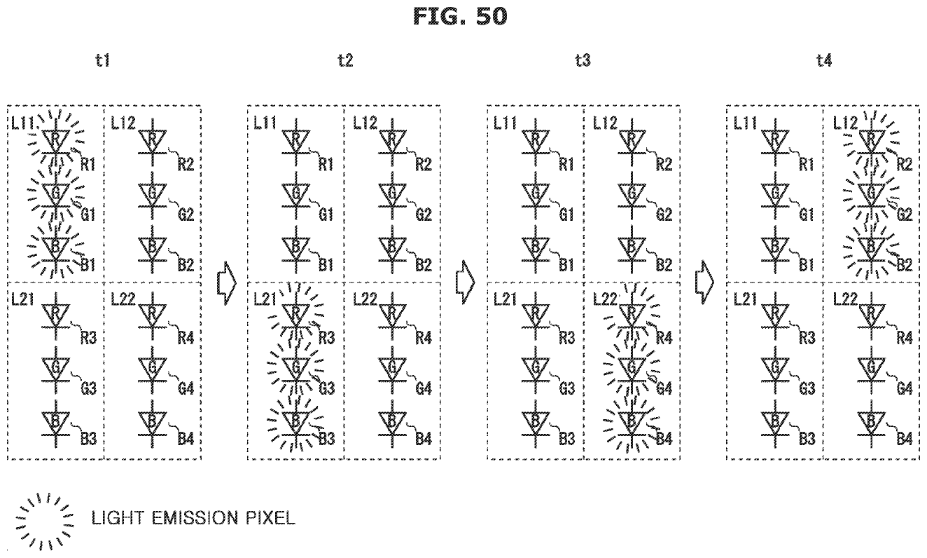

FIG. 50 is a conceptual diagram illustrating a state in which the four pixels forming the pixel unit U1e emit light. Referring to FIG. 50, the four pixels L11, L12, L21, and L22 forming the pixel unit U1e emit light in such a way that the pixels L11, L21, L22, and L12 sequentially emit light in units of sub-fields.

In response to the emission of the pixel L11 in the pixel unit U1e, all of the light emitting elements R1, G1, and B1 simultaneously emit light (time t1). In response to the emission of the pixel L21, all of the light emitting elements R3, G3, and B3 simultaneously emit light (time t2). In response to the emission of the pixel L22, all of the light emitting elements R4, G4, and B4 simultaneously emit light (time t3). In response to the emission of the pixel L12, all of the light emitting elements R2, G2, and B2 simultaneously emit light (time t4).

Next, a modified example of the pixel unit U1e will be described.

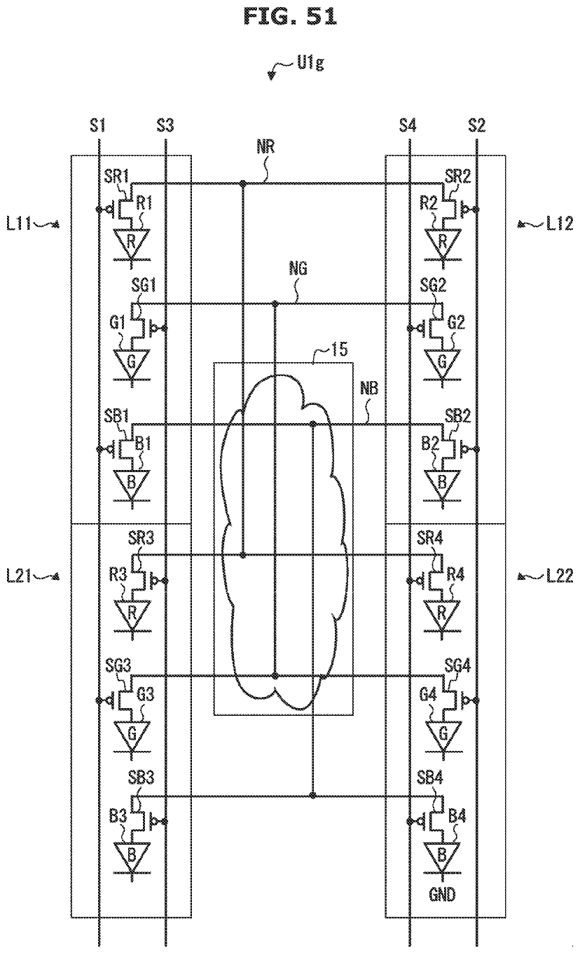

FIG. 51 is a diagram illustrating the modified example of the pixel unit U1e as a pixel unit U1g.

As shown in FIG. 51, the pixel unit U1g includes the same configuration as the pixel unit U1e. However, a connection relationship between the control power lines S1 to S4 in the pixel unit U1g is partially different from that of the pixel unit U1e.

Particularly, a control terminal (gate) of the switch element SG1, which is provided in series with the light emitting element G1 that is one of the light emitting elements R1, G1, and B1 provided in the pixel L11, is connected to, for example, the control power line S3, not the control power line S1. A control terminal (gate) of the switch element SG2, which is provided in series with the light emitting element G2 that is one of the light emitting elements R2, G2, and B2 provided in the pixel L12, is connected to, for example, the control power line S4, not the control power line S2. A control terminal (gate) of the switch element SG3, which is provided in series with the light emitting element G3 that is one of the light emitting elements R3, G3, and B3 provided in the pixel L21, is connected to, for example, the control power line S1, not the control power line S3. A control terminal (gate) of the switch element SG4, which is provided in series with the light emitting element G4 that is one of the light emitting elements R4, G4, and B4 provided in the pixel L22, is connected to, for example, the control power line S2, not the control power line S4.

Other configurations of the pixel unit U1g are the same as that of the pixel unit U1e, and thus a redundant description thereof is omitted.

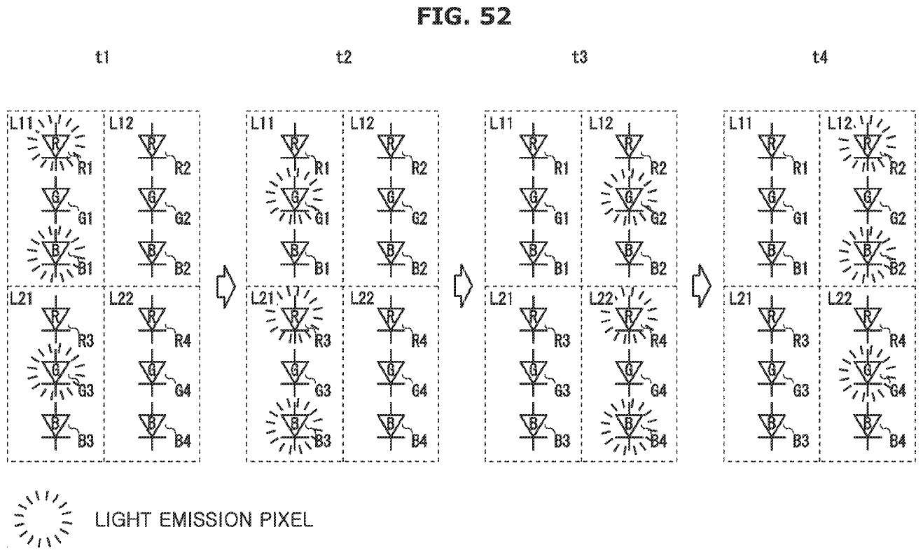

FIG. 52 is a conceptual diagram illustrating a state in which the pixels forming the pixel unit U1g emit light. Referring to FIG. 52, the four pixels L11, L12, L21, and L22 forming the pixel unit U1e emit light in such a way that the pixels L11, L21, L22, and L12 sequentially emit light in units of sub-fields.

In response to the emission of the pixel L11 in the pixel unit U1g, the light emitting elements R1 and B1 emit light but the light emitting element G1 does not emit light among the light emitting elements R1, G1, and B1 (time t1). At this time, the light emitting element G3 emits light instead of the light emitting element G1. In response to the emission of the pixel L21, the light emitting elements R3 and B3 emit light but the light emitting element G3 does not emit light among the light emitting elements R3, G3, and B3 (time t2). At this time, the light emitting element G1 emits light instead of the light emitting element G3. In response to the emission of the pixel L22, the light emitting elements R4 and B4 emit light but the light emitting element G4 does not emit light among the light emitting elements R4, G4, and B4 (time t3). At this time, the light emitting element G2 emits light instead of the light emitting element G4. In response to the emission of the pixel L12, the light emitting elements R2 and B2 emit light but the light emitting element G2 does not emit light among the light emitting elements R2, G2, and B2 (time t4). At this time, the light emitting element G4 emits light instead of the light emitting element G2.

Accordingly, in each pixel unit U, some of the plurality of light emitting elements provided in each pixel L emit light at a light emission timing of the other pixels to disperse the light-emitting elements, which emit light, thereby improving display quality.

Next, a modified example of the pixel unit U1e will be described.

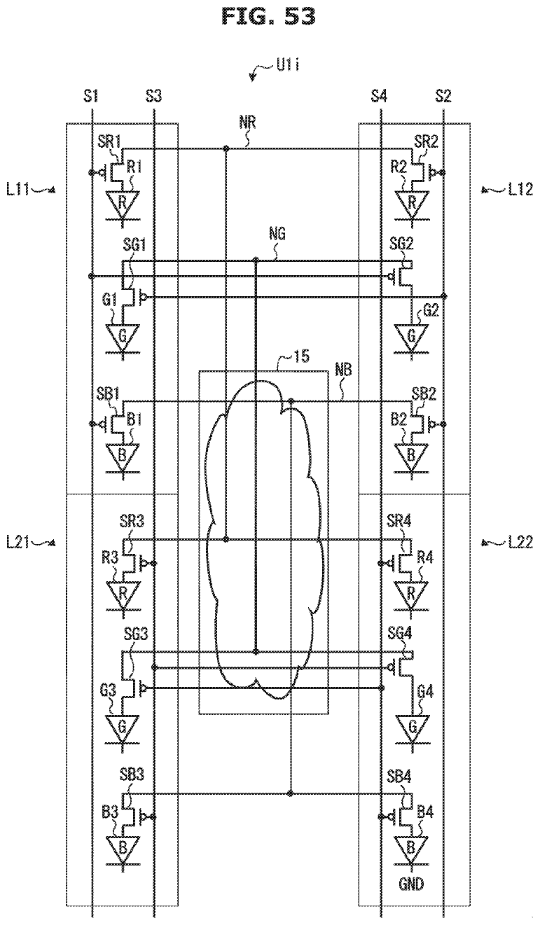

FIG. 53 is a diagram illustrating the modified example of the pixel unit U1e as a pixel unit U1i.

As shown in FIG. 53, the pixel unit U1i includes the same configuration as the pixel unit U1e. However, a connection relationship between the control power lines S1 to S4 in the pixel unit U1i is partially different from that of the pixel unit U1e.

Particularly, a control terminal (gate) of the switch element SG1, which is provided in series with the light emitting element G1 that is one of the light emitting elements R1, G1, and B1 provided in the pixel L11, is connected to, for example, the control power line S2, not the control power line S1. A control terminal (gate) of the switch element SG2, which is provided in series with the light emitting element G2 that is one of the light emitting elements R2, G2, and B2 provided in the pixel L12, is connected to, for example, the control power line S1, not the control power line S2. A control terminal (gate) of the switch element SG3, which is provided in series with the light emitting element G3 that is one of the light emitting elements R3, G3, and B3 provided in the pixel L21, is connected to, for example, the control power line S4, not the control power line S3. A control terminal (gate) of the switch element SG4, which is provided in series with the light emitting element G4 that is one of the light emitting elements R4, G4, and B4 provided in the pixel L22, is connected to, for example, the control power line S3, not the control power line S4.

Other configurations of the pixel unit U1i are the same as that of the pixel unit U1e, and thus a redundant description thereof is omitted.

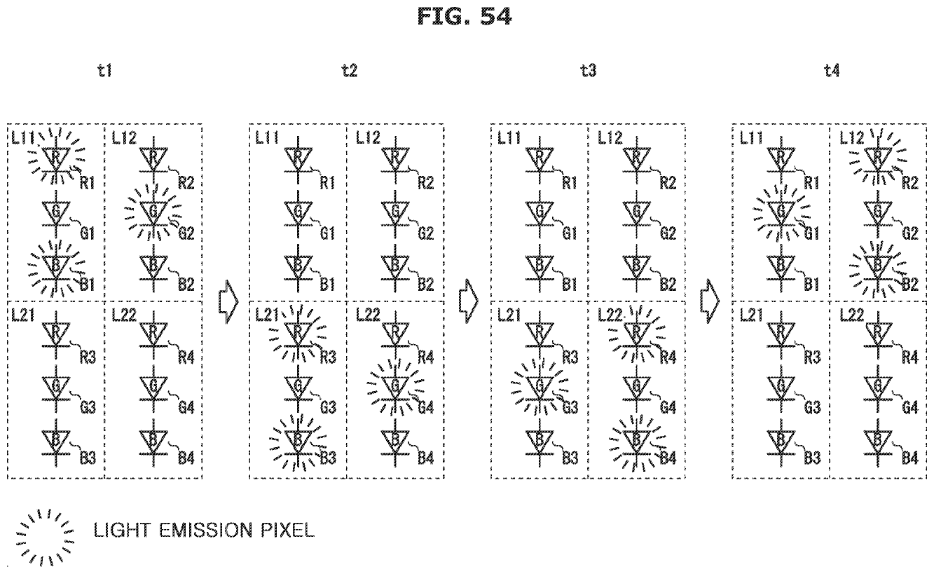

FIG. 54 is a conceptual diagram illustrating a state in which the four pixels forming the pixel unit U1i emit light. Referring to FIG. 54, the four pixels L11, L12, L21, and L22 forming the pixel unit U1e emit light in such a way that the pixels L11, L21, L22, and L12 sequentially emit light in units of sub-fields.

In response to the emission of the pixel L11 in the pixel unit U1i, the light emitting elements R1 and B1 emit light but the light emitting element G1 does not emit light among the light emitting elements R1, G1, and B1 (time t1). At this time, the light emitting element G2 emits light instead of the light emitting element G1. In response to the emission of the pixel L21, the light emitting elements R3 and B3 emit light but the light emitting element G3 does not emit light among the light emitting elements R3, G3, and B3 (time t2). At this time, the light emitting element G4 emits light instead of the light emitting element G3. In response to the emission of the pixel L22, the light emitting elements R4 and B4 emit light but the light emitting element G4 does not emit light among the light emitting elements R4, G4, and B4 (time t3). At this time, the light emitting element G3 emits light instead of the light emitting element G4. In response to the emission of the pixel L12, the light emitting elements R2 and B2 emit light but the light emitting element G2 does not emit light among the light emitting elements R2, G2, and B2 (time t4). At this time, the light emitting element G1 emits light instead of the light emitting element G2.

Accordingly, in each pixel unit U, some of the plurality of light emitting elements provided in each pixel L emit light at a light emission timing of the other pixels so as to disperse the light-emitting elements, which emit light, thereby improving display quality.

Next, a modified example of the pixel unit U1e will be described.

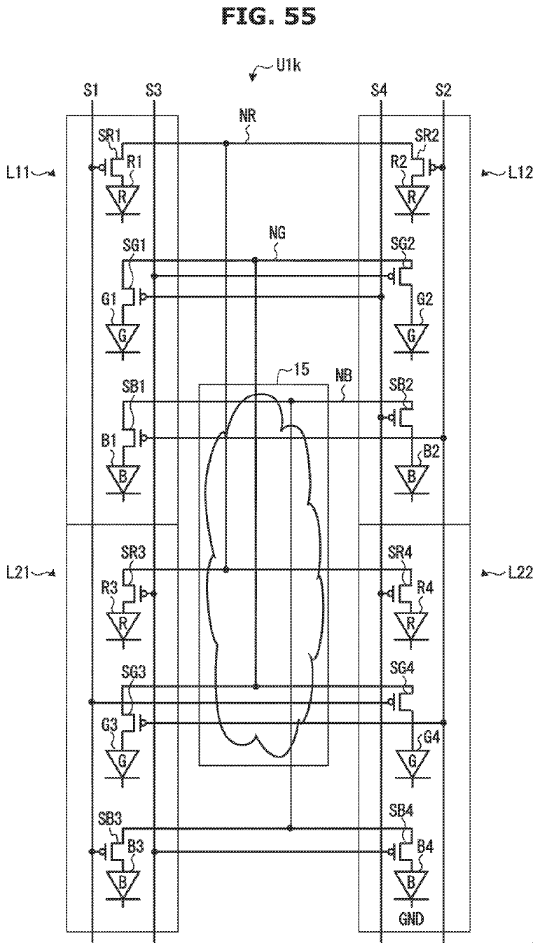

FIG. 55 is a diagram illustrating the modified example of the pixel unit U1e as a pixel unit U1k.

As shown in FIG. 55, the pixel unit U1k includes the same configuration as the pixel unit U1e. However, a connection relationship between the control power lines S1 to S4 in the pixel unit U1k is partially different from that of the pixel unit U1e.

Particularly, a control terminal (gate) of the switch element SG1, which is provided in series with the light emitting element G1 that is one of the light emitting elements R1, G1, and B1 provided in the pixel L11, is connected to, for example, the control power line S4, not the control power line S1, and a control terminal (gate) of the switch element SB1, which is provided in series with the light emitting element B1, is connected to, for example, the control power line S2, not the control power line S1. A control terminal (gate) of the switch element SG2, which is provided in series with the light emitting element G2 that is one of the light emitting elements R2, G2, and B2 provided in the pixel L12, is connected to, for example, the control power line S3, not the control power line S2, and a control terminal (gate) of the switch element SB2, which is provided in series with the light emitting element B2, is connected to, for example, the control power line S4, not the control power line S2. A control terminal (gate) of the switch element SG3, which is provided in series with the light emitting element G3 that is one of the light emitting elements R3, G3, and B3 provided in the pixel L21, is connected to, for example, the control power line S2, not the control power line S3, and a control terminal (gate) of the switch element SB3, which is provided in series with the light emitting element B3, is connected to, for example, the control power line S1, not the control power line S3. A control terminal (gate) of the switch element SG4, which is provided in series with the light emitting element G4 that is one of the light emitting elements R4, G4, and B4 provided in the pixel L22, is connected to, for example, the control power line S1, not the control power line S4, and a control terminal (gate) of the switch element SB4, which is provided in series with the light emitting element B4, is connected to, for example, the control power line S3, not the control power line S4.

Other configurations of the pixel unit U1k are the same as that of the pixel unit U1e, and thus a redundant description thereof is omitted.

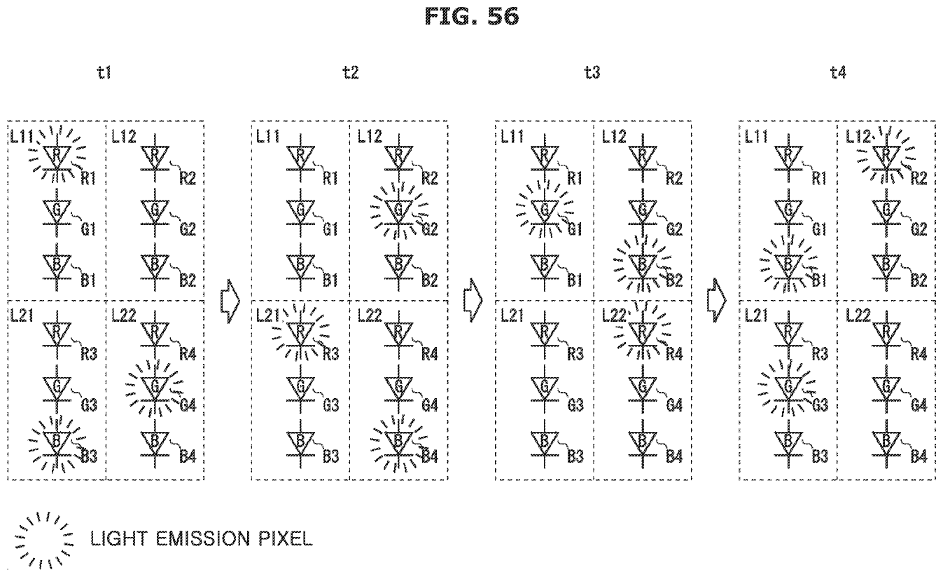

FIG. 56 is a conceptual diagram illustrating a state in which the pixels forming the pixel unit U1k emit light. Referring to FIG. 56, the four pixels L11, L12, L21, and L22 forming the pixel unit U1k emit light in such a way that the pixels L11, L21, L22, and L12 sequentially emit light in units of sub-fields.

In response to the emission of the pixel L11 in the pixel unit U1k, the light emitting element R1 emits light but the light emitting elements G1 and B1 do not emit light among the light emitting elements R1, G1, and B1 (time t1). At this time, the light emitting element G4 emits light instead of the light emitting element G1, and the light emitting element B3 emits light instead of the light emitting element B1. In response to the emission of the pixel L21, the light emitting element R3 emits light but the light emitting elements G3 and B3 do not emit light among the light emitting elements R3, G3, and B3 (time t2). At this time, the light emitting element G2 emits light instead of the light emitting element G3, and the light emitting element B4 emits light instead of the light emitting element B3. In response to the emission of the pixel L22, the light emitting element R4 emits light but the light emitting elements G4 and B4 do not emit light among the light emitting elements R4, G4, and B4 (time t3). At this time, the light emitting element G1 emits light instead of the light emitting element G4, and the light emitting element B2 emits light instead of the light emitting element B4. In response to the emission of the pixel L12, the light emitting element R2 emits light but the light emitting elements G2 and B2 do not emit light among the light emitting elements R2, G2, and B2 (time t4). At this time, the light emitting element G3 emits light instead of the light emitting element G2, and the light emitting element B1 emits light instead of the light emitting element B2.

Accordingly, in each pixel unit U, some of the plurality of light emitting elements provided in each pixel L emit light at a light emission timing of the other pixels so as to disperse the light-emitting elements, which emit light, thereby improving display quality.

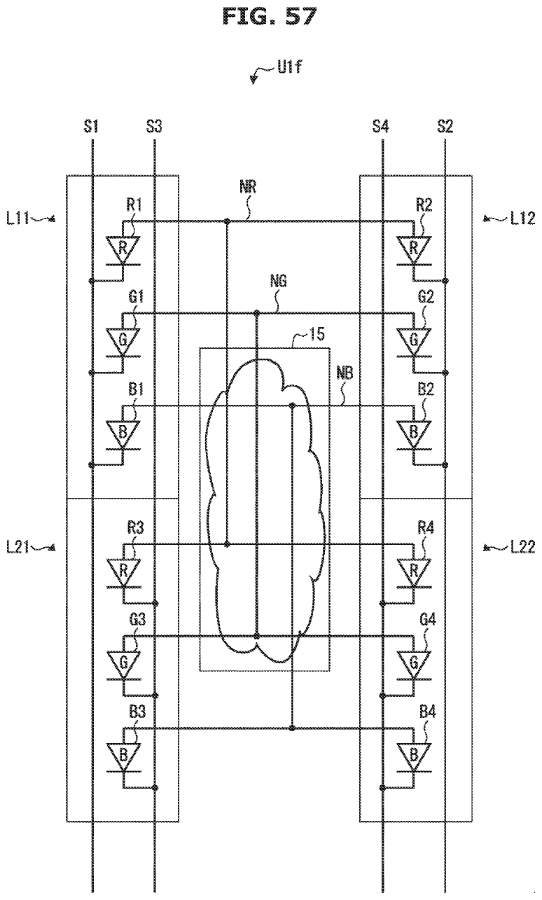

FIG. 57 is a diagram illustrating a pixel unit U1 as a pixel unit U1f. At this time, the pixel unit U1f employs the pixel driving method, such as the cathode pulse control.

As shown in FIG. 57, the pixel unit U1f includes four pixels L11, L12, L21, and L22. The pixel L11 is provided with light emitting elements R1, G1, and B1 and a pixel circuit 15. The pixel L12 is provided with light emitting elements R2, G2, and B2 and the pixel circuit 15. The pixel L21 is provided with light emitting elements R3, G3, and B3 and the pixel circuit 15. The pixel L22 is provided with light emitting elements R4, G4, and B4 and the pixel circuit 15. In the embodiment, the pixel circuit 15 is shared by the four pixels L11, L12, L21, and L22. The pixel circuit 15 may be a PAM type pixel circuit 15a or a PWM type pixel circuit 15b.

Each cathode of the light emitting elements R1, G1, and B1 provided in the pixel L11 is connected to a control power line S1. Further, an anode of the light emitting element R1 is connected to a node NR that is an output node of the pixel circuit 15. An anode of the light emitting element G1 is connected to a node NG that is an output node of the pixel circuit 15. An anode of the light emitting element B1 is connected to a node NB that is an output node of the pixel circuit 15.

Each cathode of the light emitting elements R2, G2, and B2 provided in the pixel L12 is connected to a control power line S2. Further, an anode of the light emitting element R2 is connected to the node NR that is the output node of the pixel circuit 15. An anode of the light emitting element G2 is connected to the node NG that is the output node of the pixel circuit 15. An anode of the light emitting element B2 is connected to the node NB that is the output node of the pixel circuit 15.

Each cathode of the light emitting elements R3, G3, and B3 provided in the pixel L21 is connected to a control power line S3. Further, an anode of the light-emitting element R3 is connected to the node NR that is the output node of the pixel circuit 15. An anode of the light emitting element G3 is connected to the node NG that is the output node of the pixel circuit 15. An anode of the light emitting element B3 is connected to the node NB that is the output node of the pixel circuit 15.

Each cathode of the light emitting elements R4, G4, and B4 provided in the pixel L22 is connected to a control power line S4. Further, an anode of the light-emitting element R4 is connected to the node NR that is the output node of the pixel circuit 15. An anode of the light emitting element G4 is connected to the node NG that is the output node of the pixel circuit 15. An anode of the light emitting element B4 is connected to the node NB that is the output node of the pixel circuit 15.

That is, each anode of the red light emitting elements R1 to R4 is connected in common to the node NR. Each anode of the green light emitting elements G1 to G4 is connected in common to the node NG. Each anode of the blue light emitting elements B1 to B4 is connected in common to the node NB.

A data driver 12 sequentially outputs image signals for the four pixels L forming each pixel unit U in units of sub-fields. For example, the data driver 12 sequentially outputs image signals for the four pixels L11, L12, L21, and L22 forming the pixel unit U1f in units of sub-fields. The pixel circuit 15 provided in the pixel unit Uf outputs a current according to the image signal, which is supplied from the data driver 12 to the pixel unit U1f, to the nodes NR, NG, and NB in units of subfields.

For example, as shown in FIG. 49, the scan driver 13 controls the control voltages S1, S3, and S4 S2 to be temporarily the low L level in sequence in sub-field units (times t1, t2, t3, and t4).

Accordingly, the four pixels L forming each pixel unit U emit light in the same light emission sequence as in the configuration of the other pixel units U. Particularly, the four pixels L forming each pixel unit U1f emit light as in the configuration of the pixel units U1e (refer to FIG. 50).

Further, in a configuration in which the scan driver 13 transmits a gate control signal to the pixel circuits 15a and 15b corresponding to the pixel unit U, and the voltage control circuit 14, which is described with respect to FIGS. 1 to 20, is provided between the plurality of light emitting elements included in the pixel unit and a power supply, the voltage control circuit 14 may sequentially transmit a reference voltage to each of the plurality of light emitting elements. For example, the voltage control circuit 14 sequentially transmits the reference voltage to each of the plurality of light emitting elements in units of subfields, and thus the light emitting elements sequentially emit light with luminance according to each image signal.

Particularly, the voltage control circuit 14 may be connected to the plurality of pixels L forming the pixel unit U through the control power lines S1 to S4, and the voltage control circuit 14 may sequentially transmit the reference voltage to the light-emitting element corresponding to each of the plurality of pixels L.

Next, a first modified example of the pixel unit U1f will be described.

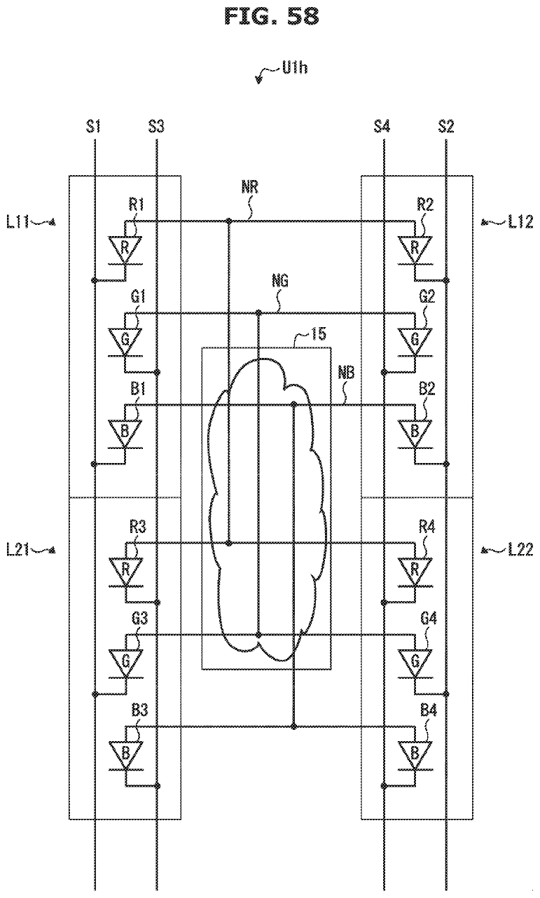

FIG. 58 is a diagram illustrating the modified example of the pixel unit U1f as a pixel unit U1h.

As shown in FIG. 58, the pixel unit U1h includes the same configuration as the pixel unit U1f. However, a connection relationship between the control power lines S1 to S4 in the pixel unit U1h is partially different from that of the pixel unit U1f.

Particularly, a cathode of the light emitting element G1 that is one of the light emitting elements R1, G1, and B1 provided in the pixel L11, is connected to, for example, the control power line S3, not the control power line S1. A cathode of the light emitting element G2 that is one of the light emitting elements R2, G2, and B2 provided in the pixel L12, is connected to, for example, the control power line S4, not the control power line S2. A cathode of the light emitting element G3 that is one of the light emitting elements R3, G3, and B3 provided in the pixel L21, is connected to, for example, the control power line S1, not the control power line S3. A cathode of the light emitting element G4 that is one of the light emitting elements R4, G4, and B4 provided in the pixel L22, is connected to, for example, the control power line S2, not the control power line S4.

Other configurations of the pixel unit U1h are the same as that of the pixel unit U1f, and thus a redundant description thereof is omitted.

The four pixels L forming the pixel unit U1h emit light as in the configuration of the pixel units U1g (refer to FIG. 52).

In response to the emission of the pixel L11 in the pixel unit U1h, the light emitting elements R1 and B1 emit light but the light emitting element G1 does not emit light among the light emitting elements R1, G1, and B1 (time t1). At this time, the light emitting element G3 emits light instead of the light emitting element G1. In response to the emission of the pixel L21, the light emitting elements R3 and B3 emit light but the light emitting element G3 does not emit light among the light emitting elements R3, G3, and B3 (time t2). At this time, the light emitting element G1 emits light instead of the light emitting element G3. In response to the emission of the pixel L22, the light emitting elements R4 and B4 emit light but the light emitting element G4 does not emit light among the light emitting elements R4, G4, and B4 (time t3). At this time, the light emitting element G2 emits light instead of the light emitting element G4. In response to the emission of the pixel L12, the light emitting elements R2 and B2 emit light but the light emitting element G2 does not emit light among the light emitting elements R2, G2, and B2 (time t4). At this time, the light emitting element G4 emits light instead of the light emitting element G2.

Accordingly, in each pixel unit U, some of the plurality of light emitting elements provided in each pixel L emit light at a light emission timing of the other pixels so as to disperse the light emitting elements, which emit light, thereby improving display quality. For example, the voltage control circuit 14 may transmit the reference voltage to each light emitting element to control some of light emitting elements in the plurality of pixels L to emit light at a light emission timing of the other pixels.

Next, a modified example of the pixel unit U1f will be described.

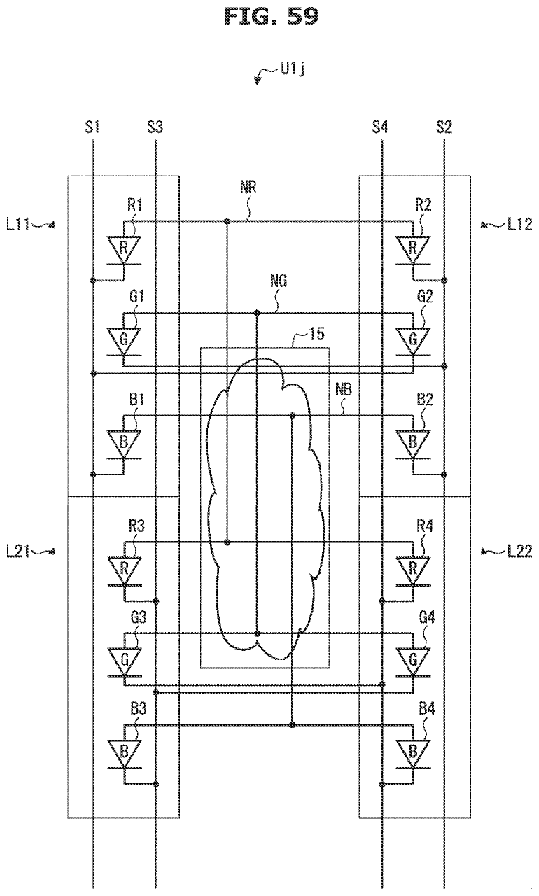

FIG. 59 is a diagram illustrating the modified example of the pixel unit U1f as a pixel unit U1j.

As shown in FIG. 59, the pixel unit U1j includes the same configuration as the pixel unit U1f. However, a connection relationship between the control power lines S1 to S4 in the pixel unit U1j is partially different from that of the pixel unit U1f.

Particularly, a cathode of the light emitting element G1 that is one of the light emitting elements R1, G1, and B1 provided in the pixel L11, is connected to, for example, the control power line S2, not the control power line S1. A cathode of the light emitting element G2 that is one of the light emitting elements R2, G2, and B2 provided in the pixel L12, is connected to, for example, the control power line S1, not the control power line S2. A cathode of the light emitting element G3 that is one of the light emitting elements R3, G3, and B3 provided in the pixel L21, is connected to, for example, the control power line S4, not the control power line S3. A cathode of the light emitting element G4 that is one of the light emitting elements R4, G4, and B4 provided in the pixel L22, is connected to, for example, the control power line S3, not the control power line S4.

Other configurations of the pixel unit U1j are the same as that of the pixel unit U1f, and thus a redundant description thereof is omitted.

The four pixels L forming the pixel unit U1j emit light as in the configuration of the pixel units U1i (refer to FIG. 54).

In response to the emission of the pixel L11 in the pixel unit U1j, the light emitting elements R1 and B1 emit light but the light emitting element G1 does not emit light among the light emitting elements R1, G1, and B1 (time t1). At this time, the light emitting element G2 emits light instead of the light emitting element G1. In response to the emission of the pixel L21, the light emitting elements R3 and B3 emit light but the light emitting element G3 does not emit light among the light emitting elements R3, G3, and B3 (time t2). At this time, the light emitting element G4 emits light instead of the light emitting element G3. In response to the emission of the pixel L22, the light emitting elements R4 and B4 emit light but the light emitting element G4 does not emit light among the light emitting elements R4, G4, and B4 (time t3). At this time, the light emitting element G3 emits light instead of the light emitting element G4. In response to the emission of the pixel L12, the light emitting elements R2 and B2 emit light but the light emitting element G2 does not emit light among the light emitting elements R2, G2, and B2 (time t4). At this time, the light emitting element G1 emits light instead of the light emitting element G2.

Accordingly, in each pixel unit U, some of the plurality of light emitting elements provided in each pixel L emit light at a light emission timing of the other pixels so as to disperse the light emitting elements, which emit light, thereby improving display quality. For example, the voltage control circuit 14 may transmit the reference voltage to each light emitting element to control some of light emitting elements in the plurality of pixels L to emit light at a light emission timing of the other pixels.

Next, a modified example of the pixel unit U1f will be described.

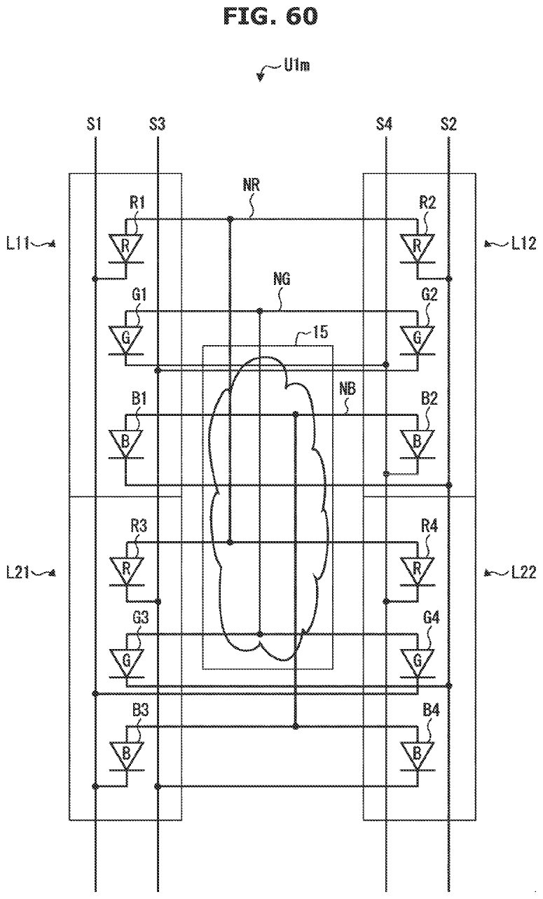

FIG. 60 is a diagram illustrating the third modified example of the pixel unit U1f as a pixel unit U1m.

As shown in FIG. 60, the pixel unit U1m includes the same configuration as the pixel unit U1f. However, a connection relationship between the control power lines S1 to S4 in the pixel unit U1m is partially different from that of the pixel unit U1f.

Particularly, a cathode of the light emitting element G1 that is one of the light emitting elements R1, G1, and B1 provided in the pixel L11, is connected to, for example, the control power line S4, not the control power line S1, and a cathode of the light emitting element B1 is connected to, for example, the control power line S2, not the control power line S1. A cathode of the light emitting element G2 that is one of the light emitting elements R2, G2, and B2 provided in the pixel L12, is connected to, for example, the control power line S3, not the control power line S2, and a cathode of the light emitting element B2 is connected to, for example, the control power line S4, not the control power line S2. A cathode of the light emitting element G3 that is one of the light emitting elements R3, G3, and B3 provided in the pixel L21, is connected to, for example, the control power line S2, not the control power line S3, and a cathode of the light emitting element B3 is connected to, for example, the control power line S1, not the control power line S3. A cathode of the light emitting element G4 that is one of the light emitting elements R4, G4, and B4 provided in the pixel L22, is connected to, for example, the control power line S1, not the control power line S4, and a cathode of the light emitting element B4 is connected to, for example, the control power line S3, not the control power line S4.

Other configurations of the pixel unit U1m is the same as that of the pixel unit U1f, and thus a redundant description thereof is omitted.

The four pixels L forming the pixel unit U1m emit light as in the configuration of the pixel units U1k (refer to FIG. 56).

In response to the emission of the pixel L11 in the pixel unit U1m, the light emitting element R1 emits light but the light emitting elements G1 and B1 do not emit light among the light emitting elements R1, G1, and B1 (time t1). At this time, the light emitting element G4 emits light instead of the light emitting element G1, and the light emitting element B3 emits light instead of the light emitting element B1. In response to the emission of the pixel L21, the light emitting element R3 emits light but the light emitting elements G3 and B3 do not emit light among the light emitting elements R3, G3, and B3 (time t2). At this time, the light emitting element G2 emits light instead of the light emitting element G3, and the light emitting element B4 emits light instead of the light emitting element B3. In response to the emission of the pixel L22, the light emitting element R4 emits light but the light emitting elements G4 and B4 do not emit light among the light emitting elements R4, G4, and B4 (time t3). At this time, the light emitting element G1 emits light instead of the light emitting element G4, and the light emitting element B2 emits light instead of the light emitting element B4. In response to the emission of the pixel L12, the light emitting element R2 emits light but the light emitting elements G2 and B2 do not emit light among the light emitting elements R2, G2, and B2 (time t4). At this time, the light emitting element G3 emits light instead of the light emitting element G2, and the light emitting element B1 emits light instead of the light emitting element B2.

Accordingly, in each pixel unit U, some of the plurality of light emitting elements provided in each pixel L emit light at a light emission timing of the other pixels so as to disperse the light emitting elements, which emit light, thereby improving display quality. For example, the voltage control circuit 14 may transmit the reference voltage to each light emitting element to control some of light emitting elements in the plurality of pixels L to emit light at a light emission timing of the other pixels.

In the embodiment, the configuration in which each pixel unit U is composed of the four pixels L, and each pixel L includes three RGB light emitting elements 155 has been described as an example, but the configuration is not limited thereto. Each pixel unit U may be composed of any number of pixels L in M rows×N columns and each pixel L may be provided with any number of light emitting elements 155.

As described above, the display apparatus according to the embodiments allows the plurality of pixels L forming each pixel unit U to regularly emit light in the same light emission sequence as in the configuration of the other pixel units U. Therefore, the display apparatus may not require the complicated wiring and suppresses visual recognition of an emission and non-emission boundary between pixels, or suppresses visual recognition of a luminance imbalance caused by luminance overlap. That is, the display apparatus according to the embodiments may improve display quality while avoiding wiring congestion.

In the embodiments, the configuration in which the display apparatus is an active matrix type has been described as an example, but the configuration it is not limited thereto. Therefore, the display apparatus may be a passive matrix type.

In the embodiments, the configuration in which the plurality of pixels L forming each pixel unit U is connected to the common data line and is connected to different control power lines (reference power line) has been described as an example, but the configuration is not limited thereto. Alternatively, the plurality of pixels L forming each pixel unit U may be connected to different data lines in a configuration in which the plurality of pixels L forming each pixel unit U sequentially emits light during one field period. Further, the plurality of pixels L forming each pixel unit U may be connected to the common control power line (reference power line) in a configuration in which the plurality of pixels L forming each pixel unit is connected to different data lines.

In the embodiments, the configuration in which the plurality of pixels L forming each pixel unit U emit light regularly in the same light emission sequence as in the configuration of other pixel units U for each one field period has been described as an example, but the configuration is not limited thereto. The plurality of pixels L forming each pixel unit U may not be limited to one field period, and may regularly emit light in the same light emission sequence as in the configuration of the other pixel units U for each predetermined period.

As is apparent from the above description, the display apparatus may reduce a quantity of pixel circuits without increasing the scale of the pixel circuit, by sequentially supplying the reference voltage to each of a plurality of light emitting elements forming the light emitting element group by timing control.

In addition, the display apparatus may improve the image quality by allowing the light emission sequence to be the same for each light emitting element group and by controlling a speed of light emission in a row direction or a column direction to be changed at least once within one field.

The operations of the embodiments may be embodied in the form of a recording medium storing instructions executable by a computer. The instructions may be stored in the form of program code and, when executed by a processor, may generate a program module to control the display apparatus to perform the operations of the disclosed embodiments. The recording medium may be embodied as a computer-readable recording medium.

The computer-readable recording medium includes all kinds of non-transitory recording media in which instructions which can be decoded by a computer are stored. For example, there may be a Read Only Memory (ROM), a Random Access Memory (RAM), a magnetic tape, a magnetic disk, a flash memory, and an optical data storage device.

Although a few embodiments of the disclosure have been shown and described, those skilled in the art will appreciate that changes may be made in these embodiments without departing from the principles and spirit of the disclosure, the scope of which is defined in the claims and their equivalents.

What is claimed is:

1. A display apparatus comprising:
a light emitting element group among a plurality of light emitting element groups of a panel of the display apparatus, the light emitting element group comprising a plurality of light emitting elements, the plurality of light emitting elements comprising a first light emitting element and a second light emitting element;
a pixel circuit among a plurality of pixel circuits of the display apparatus, the pixel circuit connected to the light emitting element group to supply an image signal to the plurality of light emitting elements; and
a voltage control circuit configured to sequentially supply a reference voltage to the first light emitting element at a first timing corresponding to a first subfield of time of a plurality of subfields of time of a field of time, during which the plurality of pixel circuits receive the image signal for each of the plurality of subfields of time and the voltage control circuit supplies the reference voltage to the plurality of light emitting element groups during each of the plurality of subfields of time, and to the second light emitting element at a second timing corresponding to a second subfield of time of the field of time,
wherein the first light emitting element is controlled to emit first light corresponding to the image signal at the first timing based on the reference voltage and the second light emitting element is controlled to emit second light corresponding to the image signal at the second timing based on the reference voltage.

2. The display apparatus of claim 1, wherein the voltage control circuit is configured to selectively supply the reference voltage to the plurality of light emitting elements based on the image signal.

3. The display apparatus of claim 2, wherein the voltage control circuit is configured to simultaneously transmit the reference voltage to the plurality of light emitting element groups.

4. The display apparatus of claim 3, wherein the light emitting element group comprises a first light emitting element group comprising a plurality of red light emitting elements, and
wherein the plurality of light emitting element groups comprises the first light emitting element group, a second light emitting element group comprising a plurality of green light emitting elements, and a third light emitting element group comprising a plurality of blue light emitting elements.

5. The display apparatus of claim 1, wherein the plurality of light emitting elements is connected in parallel between the pixel circuit and the voltage control circuit.

6. The display apparatus of claim 5, wherein each of the plurality of light emitting elements is a light emitting diode in which an anode is connected to the pixel circuit and a cathode is connected to the voltage control circuit, and
wherein the reference voltage is a ground voltage.

7. The display apparatus of claim 5, wherein each of the plurality of light emitting elements is a light emitting diode in which a cathode is connected to the pixel circuit and an anode is connected to the voltage control circuit, and
wherein the reference voltage is a power supply voltage.

8. The display apparatus of claim 1, wherein the plurality of light emitting elements comprises at least one of each of a red light emitting element, a green light emitting element, and a blue light emitting element.

9. The display apparatus of claim 1, further comprising:
the panel in which light emitting elements of the plurality of light emitting element groups are arranged in a plurality of rows and a plurality of columns,
wherein the plurality of light emitting elements of the light emitting element group is arranged in a same column among the plurality of columns.

10. The display apparatus of claim 1, further comprising:
the panel in which light emitting elements of the plurality of light emitting element groups are arranged in a plurality of rows and a plurality of columns,
wherein the plurality of light emitting elements of the light emitting element group is arranged in a same row among the plurality of rows.

11. The display apparatus of claim 1, further comprising:
the panel in which light emitting elements of the plurality of light emitting element groups are arranged in a plurality of rows and a plurality of columns,
wherein the plurality of light emitting elements of the light emitting element group is arranged in two or more rows among the plurality of rows and two or more columns among the plurality of columns.

12. The display apparatus of claim 1, further comprising:
the panel in which a plurality of pixels composed of light emitting elements of the plurality of light emitting element groups is arranged in a plurality of rows and a plurality of columns,
wherein each of the plurality of pixels comprises at least one light emitting element, and
wherein the light emitting element group comprises pixels arranged in two or more rows among the plurality of rows and two or more columns among the plurality of columns.

13. The display apparatus of claim 12,
wherein the voltage control circuit is configured to simultaneously control pixels of the light emitting element group to sequentially emit light and pixels of another light emitting element group among the plurality of light emitting element groups to sequentially emit light.

14. The display apparatus of claim 13, wherein the voltage control circuit is configured to supply the reference voltage to the plurality of light emitting element groups based on the image signal.

15. The display apparatus of claim 14, wherein the voltage control circuit is configured to control a speed of light emission of the plurality of pixels in a row direction of each column of the plurality of columns to be changed at least once within the field of time.

16. The display apparatus of claim 14, wherein the voltage control circuit is configured to control a speed of light emission of the plurality of pixels in a column direction of each row of the plurality of rows to be changed according to a subfield of time among the plurality of subfields of time.

17. The display apparatus of claim 13, wherein the voltage control circuit is configured to change sequential supply of the reference voltage in units of one field.

18. The display apparatus of claim 13, wherein the voltage control circuit is configured to control pixels in each light emitting element group among the plurality of light emitting element groups to emit light during a first light emission time of the field of time and another pixel in each light emitting element group among the plurality of light emitting element groups to emit light during a second light emission time of the field of time.

19. The display apparatus of claim 13, wherein each of the plurality of pixels comprises a red light emitting element, a green light emitting element, or a blue light emitting element.

20. The display apparatus of claim 13, wherein the voltage control circuit is configured to control some light emitting elements in the each of the plurality of pixels to emit light at a light emission timing of another pixel among the plurality of pixels.
